(19) United States
(12) Patent Application Publication
(10) Pub. No.: US 2017/0190619 A1
(43) Pub. Date: Jul. 6, 2017

(54) ADHESIVE COMPOSITIONS WITH TUNABLE RHEOLOGICAL PROPERTIES

(71) Applicant: Ingevity South Carolina, LLC, North Charleston, SC (US)

(72) Inventor: Everett Crews, Charleston, SC (US)

(21) Appl. No.: 15/389,336

(22) Filed: Dec. 22, 2016

Related U.S. Application Data
(60) Provisional application No. 62/270,884, filed on Dec. 22, 2015.

(51) Int. Cl. C04B 26/26; C04B 22/06; C08K 5/09; C09D 195/00; C09D 7/12; C08K 7/02; C04B 24/08; C04B 24/02

(52) U.S. Cl. CPC C04B 26/26; C04B 24/085; C04B 22/064; C04B 22/066; C04B 22/06; C04B 24/02; C09D 195/00; C09D 7/1216; C09D 7/1233; C08K 7/02; C08K 5/09; C04B 2111/0075

(57) ABSTRACT

The present description relates to method of initiating the curing of carboxylic acid-treated material compositions to enable an initial lowering of the viscosity and stiffness of the material for low temperature wetting and coating of solid surfaces, for paving, for waterproofing, for roofing, and for underlayment applications. The present description relates to ecologically sound, non-toxic technology that enables a practitioner to improve the low-temperature cracking properties of a material or material composition while also inducing a rapid increase in the high-temperature stiffness and viscosity of the material or material composition, and to rapid cure and strength development of finished product composition for application in paving, roofing, adhesive interlayer bonding, roll finishing, blow-molding, water-proofing, and underlayment.

### CROSS-REFERENCE TO RELATED APPLICATIONS

This application claims the benefit of U.S. Provisional Patent Application Ser. No. 62/270,884, titled, “ADHESIVE COMPOSITIONS WITH TRIGGERED CURE MECHANISM”, filed Dec. 22, 2015; the entire contents of the aforementioned application is hereby incorporated herein by reference.

### BACKGROUND

1. Field of the Art

The present description provides bituminous compositions, resinous compositions, and polymer compositions, and bituminous compositions, including, e.g., bitumen, polymer-modified bitumen, resin-modified bitumen, polymers, resins, or combinations thereof, in combination with an acidic viscosity modifier, a reactive agent, and an initiator, as well as associated methods of making and using the same. The compositions allow for tuning or tightly controlling the rheological properties of the composition.

2. Background Art

Bitumen, polymer-modified bitumen, and resin-modified bitumen are highly viscous liquids, which at ambient conditions are insufficiently fluid to allow easy use when pumping, spraying, mixing, or otherwise handling and transferring the material in mass transport operations. Because of the highly viscous nature of bitumen at ambient conditions, it is necessary to reduce the viscosity of bitumen to facilitate any process wherein the bitumen may be pumped, sprayed, stirred, mixed, or otherwise subjected to some mass transport operation. Because of the highly viscous nature of bitumen at ambient conditions, compositions comprising bitumen, polymer-modified bitumen, or resin-modified bitumen must be reduced in viscosity to facilitate mass transport operations.

Thermoplastic polymeric materials and formulations thereof are viscous materials that require heat to alter their rheology for mass transfer operations such as, but not limited to, pumping, pouring, casting, blowing, blending, mixing, and spraying, to name a few. Thermoplastic polymers common in injection molding, for example, have very high melting points: low density polyethylene has a melting point around 100° C.; high-density polyethylene melting point is around 120-130° C.; polypropylene polymers have melting points around 160° C.; nylon polymers have melting points ranging from 190° C. to over 300° C.; polyvinyl chloride has a melting point over 200° C. The mass transfer of many thermoplastic elastomers requires elevated temperatures or solvents because they have very high viscosities and do not flow at ambient temperatures. For example, many linear and radial styrene-based elastomers (also called rubbers) like styrene-butadiene-styrene (SBS) tri-block polymers, styrene-ethylene-butylene-stryene (SEBS) polymers, and styrene-isoprene-styrene (SIBS) polymers have very high melt-flow indices, and consequently require heating to lower viscosity and increase fluidity for mass transfer operations like pumping, spraying, blowing, and mixing, to name a few. Other thermoplastic elastomers, such as but not limited to, the aliphatic and aromatic thermoplastic polyurethanes (H12MDI and MDI, respectively) and thermoplastic polyester elastomers, like C23-PPDO or C23-PTMG, similarly require elevated temperatures for handling and mass transport in the aforementioned process operations such as but not limited to blow-molding, casting, rolling, blowing, etc.

Not only is viscosity reduction required to conduct mass transport operations involving materials and material compositions, e.g., bitumen, polymer-modified bitumen, resin-modified bitumen, polymers, and resins, and compositions thereof, it is known that the use of heat or dilution techniques are necessary for the preparation of polymer-modified bitumen and resin-modified bitumen prior to the use of those materials for the production of other compositions.

Three common and widely used methods exist for reducing the viscosity of thermoplastic materials like bitumen, polymer-modified bitumen, non-bituminous polymer compositions, and polymers themselves to facilitate translational movement of these materials. These widely used methods include heating the materials, diluting the materials, or converting the materials to an emulsion. These three methods are also employed to facilitate handling, transport, and processing of these materials and compositions made thereof, such as asphaltic paving mixtures, silica- and carbon black-reinforced elastomers (like tire tread rubber). These three methods are also used to produce impermeabilization products like roofing membranes in built-up roofing applications (BURA).

Materials, which are highly viscous at ambient temperatures, such as bitumen, polymer-modified bitumen, plastomeric polymers, and plastomeric elastomeric polymers, and their heterogenous or homogenous compositions, are heated in order to transfer sufficient energy to the molecular components of the materials that those reversible (non-covalent) forces, which bond the components of the materials together at ambient temperatures (electrostatic, hydrogen bonding, polar, dipolar, and Van der Waals and London dispersion forces, to name a few), are overcome, resulting in the bulk material displaying characteristics of a low-viscosity fluid. This same transfer of energy is needed to overcome the reversible (non-covalent) forces which bond polymer chains together because polymers are widely used to improve the rheological properties of such materials in end-use applications. Once heat input ceases and thermal energy dissipates through convection and conduction, the molecular components of the materials return to their most thermodynamically stable (most energetically favorable) configurations, restoring once again the ambient-temperature viscoelastic behavior of the bitumen and/or bituminous.

It is well known that there are many shortcomings of heating materials, such as bitumen, modified bitumen, polymers, and resins (and compositions thereof for the purpose of lowering viscosity to enable handling. Among these shortcomings are: 1) the cost of fuel required to produce the heat; 2) the carbon dioxide, carbon monoxide, and other green-house gases (for example, oxides of sulfur and nitrogen) which are produced by burning fuels; 3) the liberation of airborne, organic vapor components from the heated materials and material compositions, which are known to contribute to photochemical smog production; 4) the release of potentially toxic and carcinogenic vapors from the heated materials and material compositions, such as polyaromatic hydrocarbons like phenanthrene, benzo-α-pyrene, and others from bitumen, and potentially carcinogenic monomers such as styrene; and 5) the chemical alteration of the materials through oxidation, redox, cleavage, and diproportionation reactions, which may adversely affect the rheological properties of materials and material compositions. In regard to the latter, for example, it is known that with heating, the moduli of bitumen and modified bitumen increase, and bitumen and modified bitumen become less flexible and less resistant to thermal and fatigue cracking during in-place service. Similar properties may be adversely impacted by heating polymers and resins and polymeric and resinous compositions. These deteriorations in flexibility and cracking resistance lessen the durability of the materials and adversely affect their service life.

Loss of flexibility and loss of cracking resistance are deteriorations in material performance that occur also with the passage of time. Thus, heat-induced deteriorations in a material are similar to those observed with aging. Loss of durability in a material and material composition (due to such aforementioned deteriorations) directly affects the service life. Durability and service life are key components of sustainable performance in engineering materials. Thus, heating engineering materials and material compositions may adversely impact the sustainability of these materials by decreasing durability, increasing human exposure to potentially hazardous materials, and adversely impacting the environment.

Dilution methods are another well-known technique for lowering the viscosity of the above-mentioned resinous materials and material compositions. Dilution methods commonly involve adding a liquid, historically a miscible petroleum distillate like white spirits, naphtha, kerosene, or diesel, to name a few, to these materials to create a low-viscosity fluid. Generally the distillates and other solvent materials have been volatile materials at ambient conditions (standard temperatures and pressures). It is well known that such distillates and solvents are referred to as “cutters” because they “cut” or lower the viscosity of the materials. Such distillate-treated materials are referred to commonly as “cut-back” materials or merely “cut-backs.” Again the term, cut-back, implies that the high viscosity of the starting material has been “cut-back” by treatment with the distillate. If the distillate or solvent is allowed to evaporate, then the material or material composition returns to its original high-viscosity state or hardens. It is well known in the art of bitumen applications that paving compositions, roofing formulations, water-proofing coatings, and underlayments rely on the use of volatile “cutters” to first reduce the viscosity of the bitumen or bituminous composition and then, secondly, allow the bitumen or bituminous composition harden or stiffen as the cutter evaporates into the atmosphere.

There are obvious shortcomings associated with the use of distillates and solvents to lower the viscosity of material compositions. Chief among these shortcomings are 1) the flammability risks associated with the use of distillates and solvents, and 2) evaporation of these “cutters” into the atmosphere. Organic vapors in the atmosphere contribute to photochemical smog, an environmental and human health hazard. Additionally, bituminous compositions made with distillates cannot be used if atmospheric conditions impede the evaporation of the “cutter” because the composition will not attain sufficient hardness for durability in the desired end-use application. As an example in the area of asphaltic paving compositions made with cut-back bitumen, it is known that they will remain undesirably “soft” and deformable, rendering the asphalt pavement subject to rutting and shoving under traffic. Similarly, cut-back bituminous water-proofing films for pipe coating and roofing applications may “sag” and run if the cutter does not evaporate.

Polymer and resin compositions formulated with volatile cutters to first reduce their viscosity during application may suffer from poor performance in service if the volatile cutter does not fully evaporate. Bond layers may be low in shear or tear strength. Polymeric and resinous films may have insufficient indentation resistance.

In the specific case of bitumen applications, alternatives to volatile “cutters” have been tried and reported in the literature, including fatty acids. Importantly, fatty acids are able to soften the bitumen but are not volatile enough so it takes much longer to cure if they fully cure at all. For example, Delfosse, et. al. (U.S. Pat. No. 8,697,182) offers the use of oxidation catalysts common to oil-based paints and alkyd resins to accelerate curing. For example, VOC-free, cold-patch mixtures based on PC-1843 (so-called “bio-fluxed”) do not “harden” as diesel-laden cold-patch mixtures do (as a result of diesel volatilization).

Emulsification is also a commonly employed technique to solve the challenges of handling and processing high-viscosity materials such as bitumen, polymer-modified bitumen, resin-modified bitumen, resins, and polymers. Emulsification methods abound for these materials as does equipment for emulsion production. Methods are well-established and written standards exist for formulating emulsions for quality and for performance in the specific end-use application demands of a number of paving, roofing, other water-proofing, and adhesive operations. Surfactant systems are commercially available to produce high-quality emulsions (those having appropriate particle size distributions and which, during storage, display stability toward flocculation, coalescence, ripening, settlement, and creaming). Emulsifying these materials yields a product which displays good flow properties, which can be handled and transported easily, and which can be used in many different types of ambient-condition engineering processes for varied end-use production and construction applications.

However, it is well known that there are shortcomings to emulsion use in engineering applications. For example, to achieve targeted, desirable end-use application properties in areas such as paving, roofing, and interlayer substrate bonding, the water in the emulsion must evaporate and the discrete phase particles of the emulsion must coalesce in order to restore in the finished, coalesced product a set of rheological properties (including viscosity), which are more characteristic or superior to those of the rheological properties of the pre-emulsified material. It is known that emulsions and material compositions based on emulsions do not “cure” until all the water evaporates. As such, ambient conditions, which impede the evaporation of water (e.g., high relative humidity, low air temperatures, low solar flux, and low wind speed), are undesirable to end users of emulsions.

Emulsification may render rubber polymers and polymer compositions in a fluid form, which does not require high temperatures for mass transport (pumping, spreading, spraying, mixing, etc.). However, like the examples of bituminous emulsions, rubber emulsions must also be rendered essentially free of water before targeted performance properties are achieved. Until the emulsified material coating or material composition cures, it cannot be put into service. If, for example, rubber polymer latex is or latex composition is put into service as an interbonding material for the adhesion of two substrates (as in production of a laminate) prior to full curing, its service life will be shortened. In roofing applications, such a laminate would blister undesirably due to the evaporation of the entrained water in the substrate laminate interlayer at elevated temperatures. Similarly, in paving applications, the cohesive, shear, tensile, and/or bond strength of any application based on bitumen emulsions is compromised if water is entrained in paving composition. Emulsion-derived bituminous compositions like paving materials may show raveling, stripping, and other deteriorations as a result of damage arising from entrained water.

Numerous factors can retard the removal of water from emulsions. That retardation can cause challenges during production and construction operations and lessen the long-term durability of the finished emulsion-based product. As a common-place example, water-based latex paints are applied to surfaces only during appropriate weather conditions for these reasons.

Another shortcoming in engineering applications using emulsion products is that delays in construction and end-use of the finished product may result from slow water evaporation, and these delays may be costly. Lastly, emulsified materials may not be used in freezing conditions as the formation of ice within the emulsified composition will damage the finished product, be it a pavement, roofing layer, adhesive interlayer, or water-proofing membrane. Thus, a shortcoming of engineering operations and production/construction processes involving water-based emulsions is that they are limited in use to conditions wherein the evaporation of the water can occur.

Consequently, a need exists in the art for improved material compositions (such as but not limited to bituminous compositions, resinous compositions, and polymer compositions) that include viscosity-modifying agents, which allow the material and/or material composition to be workable (for wetting, mixing, pumping, blading, rolling, blowing, transport, or other mass transport operation) at low temperatures (where vapor emissions are not detectable) but which are also economical, non-toxic, and environmentally safe. Moreover, there exists a need for viscosity modifiers that can be chemically altered in a way that the finished material or material composition exhibits improved rheological properties across a wide variety of temperature and/or environmental conditions.

### SUMMARY

The present description relates to the surprising and unexpected discovery that modifying a material (such as bitumen, polymer-modified bitumen, resin-modified bitumen, resins, and/or polymers and compositions derived thereof) with an acidic viscosity modifier, e.g., an organic acid viscosity modifier, such as, a carboxylic acid or carboxylic acid derivative, an organic phosphoric acid or derivative or the like; and treating that modified material and/or material composition with an acid-reactive metal salt and water, an alcohol or heat leads to an alteration in the rheological properties of the material and/or material composition.

Significantly, the compositions and methods described herein surprisingly result in a simultaneous increase in both the resistance of the material and/or material composition to cracking due to temperature-induced thermal stresses, and resistance of the material and/or material composition to permanent deformation due to application of external load stresses over a range of frequencies and elevated temperatures. The compositions as described herein allow for the tight control (or “tunability”) of the rheological properties of the material, including, for example, the rate of development or change in viscosity, degree of hardening, and temperature sensitivity of the material.

These rheological property improvements, which are needed in many applications involving materials such as but not limited to bitumen, polymer-modified bitumen, resin-modified bitumen, resins, and polymers (and compositions comprising these materials), include superior low temperature resistance to thermal cracking, higher elastic recovery for fatigue cracking resistance, and higher modulus for durability under applied stress. There is also a need in applications involving the aforementioned materials for a method which ensures the rapid develop of the rheological properties related to cracking resistance and durability. Bituminous, resinous, and polymeric material compositions, which meet one or more of the aforementioned needs, would be advantageous for a gamut of coating, rolling, wetting, mixing, pumping, blowing, and mass transport operations in manufacturing, production, and construction applications such as in the asphalt paving, built-up roofing, water-proofing and underlayment, and continuous or intermittent blow molding industries. Thus, the description provides viscosity or rheological modifying compositions of bitumen, polymer-modified bitumen, resin-modified bitumen, resins, and polymers and one or more viscosity-modifying organic acids, e.g., carboxylic acids, carboxylic acid derivatives and/or combination thereof, an effective amount of an acid-reactive metal salt, and water and/or heat; and methods of making and using the same.

In one aspect, the description provides a composition comprising at least one of a bituminous material, resinous material, polymeric material or a combination thereof, an acidic viscosity modifier; and an acid-reactive metal salt to yield a composition having an initial viscosity, wherein upon the exposure to at least one of water, an alcohol, or heat, the viscosity of the composition increases as compared to the initial viscosity.

Upon initiation of a reaction between the acidic viscosity modifier (or “viscosity-modifying acid”), e.g., a viscosity-modifying organic acid, and the reactive metal salt, the acid-reactive metal salt decreases the temperature at which the thermal stress and/or relaxation properties of the material composition are exceeded (and thermal cracking occurs) and increases at least one of the viscosity, stiffness, rigidity, hardness or combination thereof. In a preferred embodiment, the initiation of the reaction between the viscosity-modifying acid and the acid-reactive salt is initiated by introduction of water and/or other hydroxyl group source (such as but not limited to alcohols glycerol, trimethylol propane, pentaerythritol, diethylene glycol, and polyalkylene polyols,), or by the application of heat without addition of water or a hydroxyl group source.

In any of the aspects or embodiments described herein, the starting material may comprise at least one of bitumen, a thermoplastic polymer, alkyd resin, petroleum distillate, C5 cyclopentadiene resins, C10 dicyclopentadiene resins, cumen resins, rosin ester derivatives, phenolic resin hybrid with C5 or rosin ester, acrylate ester polymer, styrene polymer, polyarylene-polyalkylene block polymer, styrene-butadiene-styrene block polymer (SBS), styrene ethylene butylene styrene block copolymer (SEBS), styrene-butadiene rubber (SBR), styrene-block-isobutylene-block-styrene) (SIBS), latex polymer or a combination thereof.

In any of the aspects or embodiments described herein, the acidic viscosity modifier is a viscosity-modifying organic acid. In certain embodiments, the viscosity-modifying organic acid comprises at least one of e.g., carboxylic acid, carboxylic acid derivative, organic phosphoric acid, and/or combination thereof.

In another aspect, the description provides compositions comprising a combination of a viscosity-modifying organic acid, and a slurry comprising an acid-reactive metal salt and water. In certain embodiments, the composition includes at least one of a bitumen-, resin-, and/or polymer-based material. In certain embodiments, the reaction of the acid and metal salt is induced by heat energy (in the absence of an added hydroxyl catalyst).

In any of the aspects or embodiments described herein, the composition can comprises at least one of a petroleum pitch (also known as bitumen, asphalt, vacuum tower bottoms), an aggregate or aggregate-containing material, e.g., reclaimed asphalt pavement (RAP), recycled asphalt roofing shingles (RAS), reclaimed Portland cement concrete or a combination thereof. Compositions including hydrocarbons like petroleum pitch address one or more of the shortcomings of the art as discussed above. For example, in certain embodiments, the description provides a composition comprising bitumen or a bitumen emulsion, an organic acid, e.g., carboxylic acid, carboxylic acid derivative or combination thereof, water, and an effective amount of an acid-reactive metal salt to thereby modify the viscosity or rheological properties or both of the combination.

In any of the aspects or embodiments described herein, the compositions may comprise at least one of bitumen, modified bitumen, resins, and polymers and other performance adjuvants such as but not limited to coarse and fine mineral aggregate, reclaimed asphalt pavement, reclaimed asphalt roofing shingles, mineral fillers (such as but not limited to silicate and calcareous aggregate dust, silica, fumed silica, alumina, kaolin clay, smectite clay, and talc), fibers of natural (e.g., paper or wood fiber) or synthetic origin, solid synthetic or natural organic pigments, solid synthetic or natural mineral colorants (e.g., TIO2 and iron oxide), solid or liquid organic dyes and colorants, carbon black and graphite, and other additives such as anti-oxidants, UV-stabilizers, plasticizers, and preservatives, or combinations thereof. These performance adjuvants may be fully or partially coated with the viscosity-adjusted compositions as described herein.

In any of the aspects or embodiments described herein, the acidic viscosity modifier comprises an organic viscosity-modifying acid. In certain embodiments, the acidic viscosity modifier comprises at least one of a mono-, di-, tri- or poly-carboxylic acid, a fatty acid, rosin acid, dimer fatty acid, trimer fatty acid, fortified fatty acid, an organophosphoric acid, organophosphonic acid, ester or polyester of carboxylic acids, phosphoric acid, phosphonic acid, an unsaturated fatty acid, an unsaturated fatty acid modified by ene or Diels-Alder reaction with eneophiles and dieneophiles, or a combination thereof. In certain embodiments, the fatty acid comprises a C10-C30 fatty acid. In certain additional embodiments, the fatty acid comprises a tall oil fatty acid. In certain embodiments, the rosin acid is a tall oil rosin acid. In certain embodiments, the rosin acid is modified by ene or Diels-Alder reaction with ene-ophiles and diene-ophiles, such as acrylic acid, alkyl acrylic acid, esters or amides of acrylic acid, esters of alkylated acrylic acid, maleic acid, maleic acid esters, maleic anhydride, alkylated maleic anhydride, fumaric acid and alkylated fumaric acid and ester and amide derivatives thereof.

In certain embodiments, the viscosity-modifying carboxylic acids and carboxylic acid derivatives, acidic organo phosphates and acidic organo phosphate derivatives, and combinations thereof may be saturated and unsaturated, branched, cyclic aliphatic, alkenylaryl, alkylaryl, and heterocyclic carboxylic acids and carboxylic acid derivatives. Such substances include, but are not limited to, C12-C30 carboxylic acid and derivatives obtained from tall oil, vegetable oils, petroleum oils of natural and synthetic sources and combinations thereof. Acidic organo phosphates and phosphonates include, but are not limited to, mono-, bis-, and tris-alkyl phosphates and phosphonates and derivatives thereof; mono-, bis-, and tris-alkanol phosphates; mono-, bis-, and tris-alkyl aryl phosphonates and phosphonates and derivatives thereof; and combinations thereof.

In another embodiment, the viscosity-modifying acids and acid derivatives comprise dimer, trimer, and higher order poly acids such as, but not limited to oxalic, adipic, succinic, sebacic acids, α,ω-dicarboxylic acids such as but not limited to C-8 suberic acid, C-16 hexadecanoic diacid, and C-23 dicarboxylic acids, tall oil dimer and trimer acid, dimerized oleic acid and linoleic acids, trimerized oleic and linoleic acids, and polymeric carboxylic acids, such as, but not limited to, synthetic products such as styrene acrylic resins, polyalkylacrylates, styrene maleic resins, which may be partially condensed with polyols and polyamines.

In still another embodiment, the carboxylic acids, polycarboxylic acids, and derivatives comprise derivatives of rosin acids, tannic acids, vinsol resins, and derivatives and combinations thereof.

In still other embodiment, the carboxylic acid-containing derivatives are modified with polyalkylenepolyamines, alkyl alcohols, alkylthiols.

In additional embodiments, the carboxylic acid-containing derivatives comprise combinations of the aforementioned branched and straight-chain aliphatic and cycloaliphatic, alkenyl, aryl, alkenylaryl, and alkylaryl, monomeri, dimeric, fortified (i.e., adducted with acrylic acid, maleic anhydride, or fumaric acid) esters of fatty acids and rosin acids and polymeric natural and synthetic fatty acids and fatty acid derivatives, rosin acids, tannic acids, vinsol resins, fortified (maleated and fumarated) fatty acids and rosin acids, fortified (i.e., adducted with acrylic acid, maleic anhydride, or fumaric acid) esters of fatty acids and rosin acids,polymeric carboxylic acids such as, but not limited to, styrene acrylic resins, polyacrylates, and styrene maleic polymers.

In certain embodiments, the polymeric carboxylic acids may be partially condensed with polyols and polyamines.

In still additional embodiments, the acidic viscosity modifier fatty acid comprises at least one of an acrylic acid, alkyl acrylic acid, ester or amide of acrylic acid, ester of alkylated acrylic acid, maleic acid, maleic acid ester, maleic anhydride, alkylated maleic anhydride, fumaric acid, alkylated fumaric acid, adipic acid, succinic acid, citric acid, 2,6-naphthenic carboxylic acid, terephthalic acid, an ester or amide derivatives thereof or a combination thereof. In still further embodiments, acidic viscosity modifier fatty acid is a partial ester of the fatty acid.

In certain embodiments, the acidic viscosity modifier comprises at least one of a mono-, di-, tri- or polycarboxylic acid, a dimerized, trimerized, or polymerized fatty acid or a combination thereof. In certain embodiments, the mono- or poly-carboxylic acid is a long-chain mono- or polycarboxylic acid. In yet additional embodiments, the long-chain mono- or polycarboxylic acid is natural or synthetic. In further embodiments, the long-chain, mono- or poly-carboxylic acid has a low volatility at temperatures in the range of 25° C. to 150° C.

In certain embodiments, the viscosity-modifying acid comprises at least one of the following:
1) linear and branched, saturated and unsaturated aliphatic and alicyclic dicarboxylic acids, also called α,ω-diarboxylic acids (like succinic acid to C23 α,ω-carboxylic acids);
2) linear and branched, heteroatom-substituted aliphatic and alicyclic dicarboxylic acids and tricarboxylic acids (e.g., aspartic acid, glutamic acid, tartaric acid, and citric acid);
3) aromatic dicarboxylic acids like o-, m-, and p-terephthalic acid and 2,6-naphthalenedicarboxylic acid; including combinations thereof.

In certain embodiments, the viscosity-modifying acids comprises organophosphate mono- and di-esters (also called alkyl phosphate esters) and ethoxylated and propoxylated derivatives thereof as well as organophosphonate, and organophosphinate derivatives, heteroatom substituted phosphoric acid derivatives such as glyphosphate and Michael addition reaction products of acrylic acid esters and phosphonic acid, 2-aminoalkylphosphonic acid, neridronic acid, ibandronic acid, organosulfate and organosulfonate derivatives, or combinations thereof.

In any of the aspects or embodiments described herein, the compositions comprising the aforementioned viscosity-modifying organic acid and the aforementioned performance adjuvants may be treated in situ with the acid reactive metal salt followed by initiation of the reaction between the organic acid and metal salt by introduction of water, alcohol, and/or heat. Thus, the composition comprising the aforementioned viscosity-modifying organic acid and performance adjuvants, when properly formulated, is suitable for mass transport operations at ambient conditions. Addition of the acid-reactive metal salt and initiation, leads to an alteration in the rheological properties of the entire composition. The alteration is typically characterized as a stiffening or hardening of the material composition.

In any of the aspects or embodiments described herein, the viscosity-modifying carboxylic acid can be a carboxylic acid- or carboxylic acid derivative-(or both)-containing composition, wherein the CCI comprise a sufficient amount of a carboxylic acid or carboxylic acid derivative to effectuate the desired alteration in rheological properties, curing rate, stiffness, Useful Temperature Interval or combination thereof, when combined with an acid-reactive metal salt in the presence of water as described herein.

In any of the compositions or methods described herein, the compositions may comprise an effective amount of an acid-reactive metal salt to thereby alter the viscosity or rheological properties or both of the composition upon exposure to at least one of water, alcohol or heat.

In any of the aspects or embodiments described herein, the acid-reactive metal salt is reactive with the carboxylic acid viscosity-modifier in the composition. In certain embodiments, the acid-reactive metal salt comprises at least one of an alkali metal oxide, alkali earth metal oxide, transition metal oxide or post-transition metalloid oxide or hydroxide. In certain embodiments, the acid-reactive metal salt comprises at least one of magnesium oxide (MgO), calcium hydroxide (CaOH), calcium oxide (CaO), or quicklime. In certain embodiments, the acid-reactive metal salt comprises a member from the family of transition metal oxides, or zinc oxide (ZnO). In certain embodiments, the acid-reactive metal salt comprises a member from the family of post-transition metal oxides, or aluminum oxide (Al₂O₃).

In an additional aspect, the description provides a material composition comprising: a) a bituminous material, a resinous material, and/or a polymeric material, b) a carboxylic acid or carboxylic acid derivative or a combination thereof; and c) an acid-reactive metal salt and water, or and acid-reactive metal salt and heat, wherein when (b) and (c) are combined a viscous or rigid composition is produced. In certain embodiments, part (a) or part (a) combined with part (b) includes performance adjuvants like mineral aggregate, pigments, fillers, etc

In an additional aspect, the description provides a bituminous composition comprising: a) a bituminous mixture including bitumen or bitumen emulsion and a carboxylic acid or carboxylic acid derivative or a combination thereof; and b) an acid-reactive metal salt and water, wherein when (a) and (b) are combined a viscous or rigid bituminous composition is produced. In certain embodiments, part (a) includes aggregate.

For example, in an additional embodiment, the description provides a bituminous composition comprising: a) a fluxed bituminous mixture including bitumen and a carboxylic acid or carboxylic acid derivative or carboxylic acid containing substance or a combination thereof; and b) an acid reactive metal salt, wherein when (a) and (b) are combined with water, wherein the rheological properties of the bituminous composition, such as but not limited to viscosity, complex modulus, and top temperature PG grade, are increased.

In an further aspect, the description provides a bituminous composition comprising: a) a bituminous mixture including bitumen and a reactive metal oxide salt; and b) an aqueous solution or dispersion or emulsion of a carboxylic acid or carboxylic acid derivative or carboxylic acid containing substance or a combination thereof, wherein when (a) and (b) are combined, the resulting bituminous composition shows an increase in rheological properties such as, but not limited to, viscosity, stiffness, complex modulus, and top temperature PG grade. a viscous or rigid bituminous composition is produced.

In an additional aspect, the description provides a system or a kit comprising: a) a carboxylic acid or carboxylic acid derivative or a combination thereof; b) a slurry including water and an acid-reactive metal salt, wherein when (a)-(b) are combined a viscous or rigid composition is produced. In certain embodiments, part (a) includes at least one of bitumen, aggregate, RAP, RAS, Portland cement or a combination thereof. In certain embodiments, the aggregate RAP, RAS, Portland cement or a combination thereof is at least partially coated with the carboxylic acid or carboxylic acid derivative composition. In certain embodiments, the aggregate RAP, RAS, Portland cement or a combination thereof is at least partially coated with a bitumen-carboxylic acid or carboxylic acid derivative composition.

In an additional aspect, the description provides a system or a kit comprising: a) a carboxylic acid or carboxylic acid derivative or a combination thereof; b) an acid-reactive metal salt; and, c) a reaction initiator such as water or heat, wherein when (a)-(c) are combined a viscous or rigid composition is produced. In certain embodiments, part (a) includes at least one of bitumen, aggregate, RAP, RAS, Portland cement or a combination thereof. In certain embodiments, the aggregate RAP, RAS, Portland cement or a combination thereof is at least partially coated with the carboxylic acid or carboxylic acid derivative composition. In certain embodiments, the aggregate RAP, RAS, Portland cement or a combination thereof is at least partially coated with a bitumen-carboxylic acid or carboxylic acid derivative composition. It should be noted that the components can be mixed in any order, all of which are expressly contemplated. In certain embodiments, part (a) includes resinous materials, polymeric materials, and emulsions derived thereof, as well as pigments, fillers, UV stabilizers, and other performance adjuvants.

In an additional aspect, the description provides a composition produced according to the steps of: in the presence of bituminous materials, resinous materials, and/or polymeric materials and combinations thereof, admixing a carboxylic acid or carboxylic acid derivative or a combination thereof to lower the resistance of the bituminous, resinous, or polymeric material to flow and mass transport operations and effectuates an improvement in the low temperature properties of the composition, the thermal crack resistance of the composition, and the low PG failure temperature in the case of bituminous compositions; this is accompanied by admixing, water, and an effective amount of an acid-reactive metal salt and initiating a reaction between the metal salt and the acid thereby forming a carboxylate or organophosphate metal salt that effectuates an increase in at least one of viscosity, softening point, complex modulus, top-temperature PG grade or a combination thereof. With regard to bitumen applications, this simultaneous improvement in the low temperature properties such as the low PG failure temperature and increase in the high PG failure temperature is known as increasing the PG spread or increasing the Useful Temperature Interval of the bituminous composition.

In certain embodiments, the process includes the addition of at least one of bitumen (which may be modified with resin and/or polymer), aggregate, RAP, RAS, Portland cement or a combination thereof. In certain embodiments, the process includes the step of at least partially coating the aggregate, RAP, RAS, Portland cement or a combination thereof with the carboxylic acid or carboxylic acid derivative or a combination thereof. In certain embodiments, the process includes the step of at least partially coating the aggregate, RAP, RAS, Portland cement or a combination thereof with a composition comprising bitumen or a bitumen emulsion or modified bitumen emulsion and a carboxylic acid or carboxylic acid derivative or a combination thereof.

In an additional aspect, the description provides a bituminous composition produced according to the steps of: a) admixing bitumen, modified bitumen, or a bitumen emulsion, or modified bitumen emulsion, and a carboxylic acid or carboxylic acid derivative or an acidic organophosphate or an acidic organo phosphate derivative or a combination thereof to form a homogenous mixture; adding to the mixture (a) a composition, (b), which includes an effective amount of an acid-reactive metal salt and water, thereby forming a carboxylate metal salt that effectuates an increase in bitumen rheological properties such as, but not limited to, viscosity, softening point, complex modulus, and top-temperature PG grade.

In certain embodiments, the mixture further comprises mineral aggregate-containing materials such as, but not limited to, reclaimed asphalt pavement (RAP), recycled asphalt roofing shingles (RAS), or reclaimed Portland cement concrete materials and combinations thereof, wherein the mineral aggregate material is treated with an effective level of a reactive mineral oxide and water (provided the mineral aggregate material does not contain an effective level of absorbed or adsorbed water) followed by coating with a) the carboxylic acid containing material or b) bitumen comprising a carboxylic acid material or (b) followed by (a) or (a) and (b) simultaneously.

In an additional aspect, the description provides a method of initiating curing of a bituminous composition comprising the steps of: a) providing a bituminous mixture including bitumen or bitumen emulsion and an effective amount of a carboxylic acid or carboxylic acid derivative or a combination thereof; b) providing a mixture of an acid-reactive metal salt and water; and c) combining (a) and (b) thereby effectuating an alteration in the rheological properties of the bituminous composition such that the difference between the top-temperature PG grade (also known as the high-temperature PG grade) and the low-temperature PG grade is increased relative to the difference in top- and low-temperature PG grade of the starting bitumen. In certain embodiments, the method comprises initiating the curing of a bituminous composition or resinous compostions or polymeric composition as described herein for paving, roofing water-proofing, adhesive bonding layers, blow-molding applications, and underlayment applications or combinations thereof comprising the steps of: a) providing a bituminous mixture including bitumen and a viscosity-modifying acid derivative; b) providing a mixture of an acid-reactive metal salt and water; and/or c) providing a mixture of acid-reactive metal salt and heat; and d) combining (a) and (b) thereby promoting the alteration in the low temperature and high temperature properties of the bituminous mixture. In certain embodiments the sequence of mixing (a) and (b) can be interchanged.

In certain embodiments, the mixture further comprises mineral aggregate-containing materials such as, but not limited to, reclaimed asphalt pavement (RAP), recycled asphalt roofing shingles (RAS), or reclaimed Portland cement concrete materials and combinations thereof, wherein the mineral aggregate material is treated with an effective level of a reactive mineral oxide and water (provided the mineral aggregate material does not contain an effective level of absorbed or adsorbed water) followed by coating with a) the carboxylic acid containing material or b) bitumen comprising a carboxylic acid material or (b) followed by (a) or (a) and (b) simultaneously.

In an additional aspect, the description provides a CCI composition produced according to the methods described herein.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages, objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1 is an illustration of an exemplary embodiment of a composition and method as described herein. For example, aggregate is pre-coated with a combination of bitumen and viscosity-modifying carboxylic acid containing material. The coated aggregate can be stored until use. When desired, the coated bitumen is mixed with water and CaO is added to induce a stiffening of the mixture.

FIG. 2 illustrates rheological master curves showing the unexpected effect of treating a bituminous composition with a viscosity-modifying acid derivative and metal oxide. The PG 67-22 was treated with a carboxylic acid derivative (labeled carboxylic acid) in a ratio of 70 parts PG 67-22 to 30 parts organic acid. The complex modulus master curve is labeled PG 67-22+30% organic acid. The PG 67-22+30% organic acid was then treated with an acid-reactive metal salt and water. The reactive metal salt in this case was CaO. 1.2% of the CaO additive (w/w carboxylic acid-treated bitumen) was used with 2.4% water (w/w carboxylic acid-treated bitumen) in one case and 4.8% in the second. The increase in the modulus curve of bitumen-free, carboxylic acid-containing materials may also be increased by treatment with a reactive metal salt, like CaO, and water (not shown).

FIG. 3 illustrates rheological master curves showing the unexpected triggering effect. The PG 52-34 was treated with a carboxylic acid derivative (labeled carboxylic acid) in a ratio of 90 parts PG 52-34 to 10 parts viscosity-reducing, reactive carboxylic acid. The complex modulus master curve is labeled PG 52-34+10% organic acid. The PG 52-34+10% organic acid was then treated with an acid reactive metal salt and water.

FIG. 4 illustrates rheological master curves showing the unexpected triggering effect. The PG 52-34 was treated with a carboxylic acid derivative (labeled carboxylic acid) in a ratio of 85 parts PG 52-34 to 15 parts viscosity-modifying carboxylic acid. The complex modulus master curve is labeled PG 52-34+15% organic acid. The PG 52-34+15% organic acid was then treated with an acid-reactive metal salt and water.

FIG. 5 illustrates rheological master curves showing the unexpected rheology altering effects. The PG 52-34 was treated with a carboxylic acid derivative (labeled carboxylic acid) in a ratio of 80 parts PG 52-34 to 20 parts carboxylic acid viscosity modifier. The complex modulus master curve is labeled PG 52-34+20% organic acid. The PG 52-34+20% organic acid was then treated with an acid-reactive metal salt and water.

FIG. 6 illustrates one of the unexpected effect of the invention disclosed herein and represented by the results of Experiment 3 (PG 52-34 bitumen treated with distilled tall oil and reacted with CaO and water, the latter added with stirring to the carboxylic acid-treated PG 52-34 either simultaneously or sequentially). The addition of the reactive metal-oxide to the CCI composition results in a return of the modulus to levels observed with the PG 52-34 bitumen control (i.e., “uncut”). As such, the compositions described herein, allow for the modification of bitumen to facilitate mass transport, and then return the viscosity, stiffness, hardness and/or Useful Temperature Interval to desired service levels.

FIGS. 7A and 7B. PG 67-22 bitumen was cut-back with a blend of carboxylic acids derived from distilled tall oil, and in a manner similar to the treatment discussed in Example 4. A) shows the results of strength development in this experiment. B) the Marshall stability was then measured as a function of time. This shows that the order of addition of the trigger and water does not materially affect the stability of the compacted asphalt mixtures.

FIG. 8 illustrates that that addition of either CaO by itself or water by itself has very little impact on the complex modulus master curve of the distilled tall oil (DTO)-treated bitumen. PG 52-34 bitumen was used at a bitumen:organic acid ratio of 90:10.

FIG. 9 illustrates that that addition of either CaO by itself or water by itself has very little impact on the complex modulus master curve of the DTO-treated bitumen. PG 52-34 bitumen was used at a bitumen:organic acid ratio of 85:15.

FIG. 10 illustrates that that addition of either CaO by itself or water by itself has very little impact on the complex modulus master curve of the DTO-treated bitumen. PG 52-34 bitumen was used at a bitumen:organic acid ratio of 80:20.

FIG. 11 illustrates that following the experiment described in Example 3, a similar analysis was conducted using a PG 67-22 bitumen rather than the PG 52-34, and a similar result is obtained. PG 67-22 bitumen was used at a bitumen:organic acid ratio of 70:30.

FIG. 12 illustrates that the order of addition of the acid-reactive metal salt and water is not of material import to “trigger” the alteration in rheological properties of the carboxylic acid-treated bitumen and restore the original rheological properties of the carboxylic acid-free bitumen.

FIG. 13 illustrates that the order of addition of the acid-reactive metal salt and water is not of material import to alter the rheological properties of the carboxylic acid-treated bitumen and restore the original rheological properties of the carboxylic acid-free bitumen.

FIG. 14 illustrates that the disclosed bitumen technology can be used as a cost-effective alternative to conventional bitumen grade modification techniques (such as PPA treatment or polymer modification). PG 67-22 was treated with viscosity-modifying carboxylic acid at a ratio of bitumen to organic acid of 80:20. The acid-treated bitumen was heated to between about 70 and 90° C. followed by treatment, with 0, 1.7, 2.8, and 4.3 wt % metal oxide (CaO) trigger.

FIG. 15 illustrates a plot of the change in the high temperature continuous grade of the original bitumen samples with the dosage of hydrolene H90T (heavy paraffinic distillate).

FIG. 16 illustrates a plot of the change in the high temperature continuous grade of the original PG 58-28 w/2% Stylink and 3% H90T.

FIG. 17 illustrates that from analysis of the linear fit for the curve in FIG. 3, one can estimate that 13.5% PC-1862 must be added to the 3% H90T polymer modified PG 58-28 to reduce the high continuous temperature to 46.5° C.

FIG. 18 illustrates three different compacted mixtures evaluated according to standard practice on the Hamburg Loaded Wheel Tracking (HWT) device, following AASHTO T 324, “Hamburg Wheel-Track Testing of Compacted Hot Mix Asphalt.”

FIG. 19 illustrates the stripping and rutting for samples prepared in Example 13.

FIG. 20 illustrates the stripping and rutting for samples prepared in Example 13.

FIG. 21 illustrates the stripping and rutting for samples prepared in Example 13.

FIG. 22 illustrates the mixture preparation procedure used to manufacture the lab-made, lab-molded specimens discussed in Example 14.

FIG. 23 illustrates the Superpave gyratory compaction curves for the specimens in Example 14.

FIG. 24 illustrate how the master curves (graphs of the complex modulus, G*, versus frequency at a fixed temperature) reveal that the viscosity-lowering carboxylic acid derivative substantially softens the bitumen and the CCI reaction “triggers” hardening and restores the bitumen to its original moduli.

FIG. 25 illustrate how the master curves (graphs of the complex modulus, G*, versus frequency at a fixed temperature) reveal that the viscosity-lowering carboxylic acid derivative substantially softens the bitumen and the CCI reaction restores the bitumen to its original moduli.

FIG. 26 illustrate how the master curves (graphs of the complex modulus, G*, versus frequency at a fixed temperature) reveal that the viscosity-lowering carboxylic acid derivative substantially softens the bitumen and the CCI reaction restores the bitumen to its original moduli.

FIG. 27 illustrates a black space plot of three bitumen samples wherein the change in complex moduli, G*, over the range of 1 to 107 Pa, is plotted as a function of the phase angle, 6. The black space plot shows the degree of elastic behavior in a sample for a fixed complex modulus, G*.

FIG. 28 illustrates how a mineral aggregate material, in this case reclaimed asphalt pavement (RAP), is coated with an aqueous emulsion comprising 60% of a complex mixture of saturated and unsaturated carboxylic acids as the dispersed phase. The RAP thusly coated was treated with mixing to an effective amount of CaO and water, followed by compaction using 30 gyrations on a Superpave Gyratory Compactor. The compacted specimen was allowed to stand at room temperature for two days followed by conditioning in a 40° C. forced draft oven for 2.0 hours and then tested for compressive strength (also known as Marshall stability). The compressive strength of the compacted, cured, and conditioned specimen was 4600 lb-f (or 292 psi based on 4600 lb divided by the surface area (15.75 square inches) of the specimen).

FIG. 29 illustrates that the combination of carboxylic acid containing species can allow the end user to tailor the spread of hardness characteristics after triggering (as determined by softening points; units are ° C.). For example, the PG 58-28 bitumen treated with 30 wt % stearic acid had a softening point of 62.6° C., which is not low enough for pumping, mixing, handling, compaction, etc. at low temperatures, but upon triggering the stearic acid modified bitumen increased in softening point to 129.1° C. The same PG 58-28 bitumen treated with a 1:1 blend of oleic acid and linoleic acid was fluid at room temperature and its softening point was too low to be measured using an automated softening point instrument from Herzog (model HRB 745). Upon triggering with the same formulation as used for the triggering of the stearic acid modified PG 58-28, the softening point of the oleic:linoleic blend increased to 78° C. This example shows the effect of combining carboxylic acids and carboxylic acid derivatives that substantially fluidize bitumen (like the 1:1 blend of oleic acid and linoleic acid) with carboxylic acids and carboxylic acid derivatives that substantially stiffen the bitumen upon triggering (like stearic acid). The 1:1 blend of the oleic/linoleic acids (themselves 1:1) with stearic acid had a softening point of 33.0° C. prior to triggering, but a softening point of 90.3 after triggering. The use of blends of carboxylic acids to “tune” the stiffening decrease followed by a triggered stiffening increase is shown in Example 19.

FIG. 30 illustrates graphically the results of Example 19.

FIG. 31 illustrates the use of the compositions as described herein to produce a colored chip seal adhesive preservation/impermeabilization treatments as described in Example 20, 21, 22, and 23.

FIG. 32 illustrates the high chip retention enabled by compositions as described herein to produce chip seal adhesive preservation/impermeabilization treatments as described in Example 20, 21, 22, and 23.

FIG. 33 illustrates the use of compositions as described herein to produce and retain aggregate in a chip seal adhesive preservation/impermeabilization treatments using a bitumen, treated according to the invention, as described in Example 20, 21, and 23.

FIG. 34 illustrates the use of compositions as described to produce chip seal adhesive preservation/impermeabilization treatments wherein the bitumen-free binder contains a styrene-butadiene-styrene block terpolymer.

FIG. 35 illustrates the use of compositions as described to produce chip seal adhesive preservation/impermeabilization treatments wherein the carboxylic acid treated bitumen binder contains a styrene-butadiene-styrene block terpolymer.

FIG. 36 illustrates how a colored, high-stability, open-graded, compacted bituminous mixture may be made at room temperature.

FIG. 37 illustrates how a binder comprising titanium dioxide, acrylic polymer, silicone, and a distilled tall oil species may be used to produce a high-stability, open-graded, compacted bituminous mixture may be made at room temperature.

FIG. 38 illustrates how dense-graded RAP may be “marinated” with a carboxylic acid-based bitumen rejuvenator followed storage for prolonged periods prior to initiate the increase in stiffness by treatment of the “marinated” RAP with reactive metal salt (in this case CaO) and water as described in Example 26.

### DETAILED DESCRIPTION

The present description relates to the surprising and unexpected discovery that modifying a material (such as bitumen, polymer-modified bitumen, resin-modified bitumen, resins, and/or polymers and compositions derived thereof) with an acidic viscosity modifier, e.g., an organic acid viscosity modifier, such as, a carboxylic acid or carboxylic acid derivative, an organic phosphoric acid or derivative or the like; and treating that modified material and/or material composition with an acid-reactive metal salt and water, an alcohol or heat leads to an alteration in the rheological properties of the material and/or material composition. The process is referred to generally herein as “the Cutter-Coupler-Initiator reaction” or “CCI reaction,” and the corresponding compositions as “CCI compositions” or “compositions.”

Significantly, the compositions and methods described herein surprisingly result in a simultaneous increase in both the resistance of the CCI compositions to cracking due to temperature-induced thermal stresses, and resistance to permanent deformation due to application of external load stresses over a range of frequencies and elevated temperatures. The compositions as described herein advantageously allow for the tight control (or “tunability”) of the rheological properties of the material, including, for example, the rate of development or change in viscosity, degree of hardening, stiffness, and/or temperature sensitivity of the material.

The following is a detailed description provided to aid those skilled in the art in practicing the present invention. Those of ordinary skill in the art may make modifications and variations in the embodiments described herein without departing from the spirit or scope of the present disclosure. All publications, patent applications, patents, figures and other references mentioned herein are expressly incorporated by reference in their entirety.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

The following terms are used to describe the present invention. Unless otherwise defined, all technical and scientific terms used herein have the same meaning as commonly understood by one of ordinary skill in the art to which this invention belongs. The terminology used in the description is for describing particular embodiments only and is not intended to be limiting of the invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “effective,” “effective amount,” “sufficient amount” or the like is used to describe an amount of a compound, composition or component which, when used within the context of its intended use, is sufficient to effectuate an intended result. For example, in the present context, an effective amount of an organic acid or acid-reactive metal salt in the described mixtures, compositions or CCI compositions is the amount required to effectuate the desired rate and degree of viscosity modification, hardening and/or temperature sensitivity of the binder material as compared to the starting material. For example, in certain embodiments, the description provides compositions comprising an effective amount of a viscosity-modifying acid and/or an effective amount of a reactive metal salt, e.g., metal oxide, sufficient to effectuate the desired change in viscosity, hardness (i.e., cured hardness), stiffness, temperature sensitivity, low temperature failure (cracking), high temperature failure (deformation or softening), and/or the Useful Temperature Interval (UTI) of a binder, e.g., bitumen, resin or polymeric material. As one of skill in the art will appreciate based on the instant description, the relative amounts of these agents can be varied in any number of ways in order to optimize the final product for any desired application or use. Thus, in any of the aspects or embodiments described herein, the amount of the acid-reactive salt in the composition is an effective amount of the acid-reactive salt. In certain embodiments, the effective amount is the minimum amount sufficient to effectuate the desired curing rate and/or increase in viscosity or rheological properties or both.

As used herein, the term “Useful Temperature Interval” (UTI) refers to the useful range of temperatures in Celsius for a material expressed as the high temperature deformation point and the low temperature crack resistance point. For example, PG 54-32 refers to a bitumen that displays a useful range between the temperatures of 54° C. and −32° C. Surprisingly and unexpectedly, the compositions and methods as described herein result in materials that have an expanded range of UTI, especially with regard to reducing the low temperature crack resistance of a material even in the presence of modifiers that enhance the high temperature deformation resistance.

As used herein, “Bitumen” is sometimes used interchangeably with asphalt to describe a hydrocarbon rich binder material such as petroleum pitch, including refined petroleum residues. Asphalt is commonly qualified for paving applications. Examples of asphalt grades used in paving applications include stone mastic asphalt, soft asphalt, hot rolled asphalt, dense-graded asphalt, gap-graded asphalt, porous asphalt, mastic asphalt, and other asphalt types. Typically, the total amount of bituminous binder in bituminous compositions is from 1 to 99 wt % based on the total weight of the composition.

### Compositions

Presently described are compositions comprising at least one of a bitumen, a polymer-modified bitumen, a resin-modified bitumen, a resin, a polymer or a combination thereof, an acidic viscosity modifier, and an acid-reactive metal salt (herein also a reactive metal salt), wherein upon exposure to water, an alcohol, an agent that liberates water or creates a hydroxyl source, or heat or a combination thereof, modification of the rheological properties, e.g., an increase in the viscosity of the material is initiated or “triggered.” In other words, the viscosity of the triggered composition is increased relative to the starting material or the “uninitiated” mixture. The reaction may be referred to generally herein as the “Cutter-Coupler-Initiator reaction” or “CCI reaction,” and the corresponding compositions as “CCI compositions” or “compositions.”

It was discovered that a raw materials of natural, renewable origin can be used to alter the rheology of binder materials, including bitumen, both in terms of decreasing the low-temperature properties of bitumen (critical to properties such as thermal crack resistance) and increasing the high-temperature properties (critical to deformation resistance and other stiffness-related performance characteristics).

The CCI compositions described herein, include, e.g., bitumen, polymer-modified bitumen, polymers, and resins that display “equivalent or superior” properties than those displayed by the starting bitumen, polymer-modified bitumen, polymer, or resin. And those superior properties are achieved by application of the total CCI reaction. One advantage imparted by the CCI reaction is to enhance the spread of rheological properties typically unachievable through currently known methods. As an example, the UTI in bitumen and polymer-modified bitumen achieved via the CCI reaction is far greater than the UTI typically achievable by today's methods of using a solvent to impart the low temperature (thermal cracking resistance) properties and then adding a polymer (to impart the high stiffness for deformation resistance under load).

It was also observed that compositions as described herein, including polymers and resins, are easier to process. For example, as described herein SBS polymers blended with a reactive tall-oil based cutter immediately dissolved when added to bitumen. Then the CCI reaction was applied to yield a polymer-modified bitumen with an uniquely wide UTI.

In addition, the compositions described herein are superior because they are better from an environmental impact and human health perspective. When materials (such as polymers, polymer-modified bitumen, or bitumen) are treated with reactive cutters described herein, they can be handled without heating. Then, when subjected to the CCI reaction, the treated materials are converted to materials having the targeted rheological properties for their intended end use.

As described above, by applying the teachings herein, the rate and degree of modification of the viscosity or rheological properties, both the low-temperature and the high-temperature properties, can be “tuned” as desired. Of additional significance is the observation that, by applying the teachings herein, the formulation of organic acid and acid-reactive metal salt in the material compositions of the invention can be altered in predictable ways to reliably and target in a simultaneous manner both a range of low-temperature and high-temperature performance characteristics.

Without being bound by any particular theory, it is hypothesized that the surprising and unexpected discovery that treating a binder material, e.g., a bituminous material or polymer material, with an acidic viscosity modifier, e.g., an organic viscosity-modifying acid, such as a carboxylic acid, and an acid-reactive metal salt in the presence of an aqueous or hydroxyl source, e.g., water or an alcohol, e.g., glycerol, and/or heat leads to the in-situ generation of a carboxylate metal salt, which at low dosages initiates an alteration in the rheological properties (notably stiffness, rigidity, hardness, viscosity, etc) of the composition. In the case of bitumen, the two-fold purpose of adding the carboxylic acid derivative, e.g., fatty acids or derivatives, is 1) to alter the rheological properties of the bitumen (most notably to lower the viscosity of the bitumen), and 2) to provide a reactive substrate for subsequent reaction with acid-reactive metal salts. Thus, the description provides compositions and methods for tuning or tightly controlling the viscosity and rheological properties of the materials.

In one aspect, the description provides a composition comprising at least one binder material, e.g., a bituminous material, resinous material, polymeric material or a combination thereof, an acidic viscosity modifier; and an acid-reactive metal salt to yield a composition having an initial viscosity, wherein upon the exposure to at least one of water, an alcohol, or heat, the viscosity of the composition increases as compared to the initial viscosity (i.e., the viscosity of the mixture prior to initiation of the CCI reaction).

Upon initiation of a reaction between the acidic viscosity modifier (or “viscosity-modifying acid”), e.g., a viscosity-modifying organic acid, and the reactive metal salt, the acid-reactive metal salt decreases the temperature at which the thermal stress and/or relaxation properties of the material composition are exceeded (and thermal cracking occurs) and increases at least one of the viscosity, stiffness, rigidity, hardness or combination thereof. In a preferred embodiment, the initiation of the reaction between the viscosity-modifying acid and the acid-reactive salt is initiated by introduction of water and/or other hydroxyl group source (such as but not limited to alcohols glycerol, trimethylol propane, pentaerythritol, diethylene glycol, and polyalkylene polyols,), or by the application of heat without addition of water or a hydroxyl group source.

In any of the aspects or embodiments described herein, the starting material is a binder comprising at least one of bitumen, a thermoplastic polymer, alkyd resin, petroleum distillate, C5 cyclopentadiene resins, C10 dicyclopentadiene resins, cumen resins, rosin ester derivatives, phenolic resin hybrid with C5 or rosin ester, acrylate ester polymer, styrene polymer, polyarylene-polyalkylene block polymer, styrene-butadiene-styrene block polymer (SBS), styrene ethylene butylene styrene block copolymer (SEBS), styrene-butadiene rubber (SBR), styrene-block-isobutylene-block-styrene) (SIBS), latex polymer or a combination thereof.

In another aspect, the description provides compositions comprising a combination of a viscosity-modifying organic acid, and a slurry comprising an acid-reactive metal salt and water. In certain embodiments, the composition includes at least one of a bitumen-, resin-, and/or polymer-based material. In certain embodiments, the reaction of the acid and metal salt is induced by heat energy (in the absence of an added hydroxyl catalyst).

The described compositions are useful, for example, as adhesives or additives to “trigger” the curing of adhesive compositions. In any of the aspects or embodiments, the binder material can be, e.g., bitumen, bitumen emulsions, bitumen dispersions, polymer-modified bitumen, cement, waxes, fatty esters like, e.g., mono-, di-, and/or triglycerides, petroleum distillates, C5 cyclopentadiene resins, C10 dicyclopentadiene resins, cumen resins, rosin esters, phenolic resin hybrids with C5 or rosin esters, polymers, acrylate ester polymers, styrene polymers, polyarylene-polyalkylene block polymers, resins, tall oil pitch, beeswax, natural fatty acids, synthetic fatty acids, aromatic oils, asphalt flux, latex polymers or combinations thereof.

In any of the aspects or embodiments described herein, the composition can comprises at least one of a petroleum pitch (also known as bitumen, asphalt, vacuum tower bottoms), an aggregate or aggregate-containing material, e.g., reclaimed asphalt pavement (RAP), recycled asphalt roofing shingles (RAS), reclaimed Portland cement concrete or a combination thereof. Compositions including hydrocarbons like petroleum pitch address one or more of the shortcomings of the art as discussed above. For example, in certain embodiments, the description provides a composition comprising bitumen or a bitumen emulsion, an organic acid, e.g., carboxylic acid, carboxylic acid derivative or combination thereof, water, and an effective amount of an acid-reactive metal salt to thereby modify the viscosity or rheological properties or both of the combination.

In any of the aspects or embodiments described herein, the compositions may comprise at least one of bitumen, modified bitumen, resins, and polymers and other performance adjuvants such as but not limited to coarse and fine mineral aggregate, reclaimed asphalt pavement, reclaimed asphalt roofing shingles, mineral fillers (such as but not limited to silicate and calcareous aggregate dust, silica, fumed silica, alumina, kaolin clay, smectite clay, and talc), fibers of natural (e.g., paper or wood fiber) or synthetic origin, solid synthetic or natural organic pigments, solid synthetic or natural mineral colorants (e.g., TIO2 and iron oxide), solid or liquid organic dyes and colorants, carbon black and graphite, and other additives such as anti-oxidants, UV-stabilizers, plasticizers, and preservatives, or combinations thereof. These performance adjuvants may be fully or partially coated with the viscosity-adjusted compositions as described herein.

In other aspects, the description provides a system comprising a combination of homogenous dispersions of a bitumen, polymer-modified bitumen, resin-modified bitumen, resins, and polymers with a miscible carboxylic acid or carboxylic acid derivative or a combination thereof to yield a stable, approximately homogenous composition, wherein the mixture demonstrates a decrease in properties such as viscosity, melt index, pour point, complex modulus, low-temperature properties (as in the case of bitumen, the low PG failure grade), and softening point as compared to the starting, untreated, carboxylic acid material composition alone. Thus, in certain embodiments, rheological properties of the material composition such as, but not limited to, the viscosity, the softening point, the complex modulus, the melt-flow index, and the top continuous temperature grade and lower continuous temperature grade are decreased by addition of the carboxylic acid or carboxylic acid derivative or combination thereof as compared to the starting material without the organic acid, carboxylic acid, carboxylic acid derivative, phosphoric acid and/or combinations thereof. The system further comprises an effective amount of an acid-reactive metal salt to thereby effectuate an increase in properties of the composition such as viscosity, complex modulus, top continuous PG grade, and softening point as compared to the starting material alone when the reaction between the acid and acid-reactive metal salt is initiated either by the introduction of water or other hydroxyl group source (such as but not limited to alcohols) or by the introduction of heat.

In certain embodiments, the bitumen is modified with at least one of polyphosphoric acid, polymeric plastomers and elastomers, ground tire rubber, and cellulosic fibers. In certain additional embodiments, the bitumen emulsion is a water-based emulsion. In still additional embodiments, the bitumen emulsion comprises long-chain mono- or poly-carboxylic acid.

The bitumen used in the inventive composition may be modified or unmodified, derived from petroleum refining, e.g., straight-run bitumen, vacuum tower bottoms, air rectified bitumen, and air-blown or oxidized bitumen. Furthermore, the bitumens may conform to specifications of viscosity-graded and/or penetration-graded bitumens. Bitumen used in the inventive composition may be natural origins, e.g., lake asphalt, lake asphalt derivatives, Trinidad Lake bitumen, gilsonite, and gilsonite derivatives; bitumens derived from crude oil; petroleum pitches obtained from a cracking process; coal tar; and combinations thereof.

Additionally, bitumens or bitumen emulsions suitable for use in the compositions and methods described herein may be modified with polymeric materials, for example, natural rubbers, synthetic rubbers, plastomers, thermoplastic resins, thermosetting resins, elastomers, recycled crumb rubber from recycled tires, styrene-butadiene-styrene (SBS) linear, branched, and radial block polymers, such as Kraton D1101, D1118, and D1184; styrene-butadiene rubber polymers, such as BASF NX1138; styrene-acrylate polymers such as Rovene 6118 and 6066; acrylic polymers such as Rovene 6014; polyalkylene polymers; polyesters; and combinations thereof. The bitumen of the composition of the disclosure can be modified or unmodified at least one of polyphosphoric acid, polymeric plastomers and elastomers, ground tire rubber, and cellulosic fibers. Examples of these additives include, but are not limited to, styrene-butadiene-styrene (SBS), styrene-butadiene-rubber (SBR), polyisoprene, polybutylene, butadiene-styrene rubber, vinyl polymer, ethylene vinyl acetate, ethylene vinyl acetate derivative and the like. In one embodiment of the present invention, the modified bitumen comprises at least one additive selected from the group consisting of styrene-butadiene-styrene; styrene-butadiene-rubber; sulfur-containing crosslinker; acid modifier such as tall oil acid, tall oil pitch and phosphoric acid derivative; and combinations thereof.

Where desired, the modified bitumen may comprise additional additives traditionally employed in the production of bitumen emulsions to adjust the characteristics of the finished bituminous paving compositions. Such additional additives include, but are not limited to, styrene-butadiene-rubber latex; polyisoprene latex; neoprene; associative thickener; starch; salt; acid modifier such as polyphosphoric acid, crude tall oil, distilled tall oil acids, tall oil pitch and derivative thereof; wax modifier such as Montan wax, beeswax and Fisher-Tropsch waxes; and combinations thereof.

In any of the aspects or embodiments described herein, the bitumen composition can comprise about 0.01, 0.05, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70% wt or more of bitumen (modified or unmodified) or bitumen emulsion with respect to the weight of the bitumen composition.

In any of the aspects or embodiments described herein, the acidic viscosity modifier is a viscosity-modifying organic acid. In certain embodiments, the viscosity-modifying organic acid comprises at least one of e.g., carboxylic acid, carboxylic acid derivative, organic phosphoric acid, and/or combination thereof.

In any of the aspects or embodiments described herein, the acidic viscosity modifier comprises an organic viscosity-modifying acid. In certain embodiments, the acidic viscosity modifier comprises at least one of a mono-, di-, tri- or poly-carboxylic acid, a fatty acid, rosin acid, dimer fatty acid, trimer fatty acid, fortified fatty acid, an organophosphoric acid, organophosphonic acid, ester or polyester of carboxylic acids, phosphoric acid, phosphonic acid, an unsaturated fatty acid, an unsaturated fatty acid modified by ene or Diels-Alder reaction with eneophiles and dieneophiles, or a combination thereof. In certain embodiments, the fatty acid comprises a C10-C30 fatty acid. In certain additional embodiments, the fatty acid comprises a tall oil fatty acid. In certain embodiments, the rosin acid is a tall oil rosin acid. In certain embodiments, the rosin acid is modified by ene or Diels-Alder reaction with ene-ophiles and diene-ophiles, such as acrylic acid, alkyl acrylic acid, esters or amides of acrylic acid, esters of alkylated acrylic acid, maleic acid, maleic acid esters, maleic anhydride, alkylated maleic anhydride, fumaric acid and alkylated fumaric acid and ester and amide derivatives thereof.

In certain embodiments, the viscosity-modifying carboxylic acids and carboxylic acid derivatives, acidic organo phosphates and acidic organo phosphate derivatives, and combinations thereof may be saturated and unsaturated, branched, cyclic aliphatic, alkenylaryl, alkylaryl, and heterocyclic carboxylic acids and carboxylic acid derivatives. Such substances include, but are not limited to, C12-C30 carboxylic acid and derivatives obtained from tall oil, vegetable oils, petroleum oils of natural and synthetic sources and combinations thereof. In certain embodiments, the carboxylic acid is a C12, C13, C14, C15, C16, C17, C18, C19, C20, C21, C22, C23, C24, C25, C26, C27, C28, C29, or C30.

Acidic organo phosphates and phosphonates include, but are not limited to, mono-, bis-, and tris-alkyl phosphates and phosphonates and derivatives thereof; mono-, bis-, and tris-alkanol phosphates; mono-, bis-, and tris-alkyl aryl phosphonates and phosphonates and derivatives thereof; and combinations thereof.

In another embodiment, the viscosity-modifying acids and acid derivatives comprise dimer, trimer, and higher order poly acids such as, but not limited to oxalic, adipic, succinic, sebacic acids, α,ω-dicarboxylic acids such as but not limited to C-8 suberic acid, C-16 hexadecanoic diacid, and C-23 dicarboxylic acids, tall oil dimer and trimer acid, dimerized oleic acid and linoleic acids, trimerized oleic and linoleic acids, and polymeric carboxylic acids, such as, but not limited to, synthetic products such as styrene acrylic resins, polyalkylacrylates, styrene maleic resins, which may be partially condensed with polyols and polyamines.

In still another embodiment, the carboxylic acids, polycarboxylic acids, and derivatives comprise derivatives of rosin acids, tannic acids, vinsol resins, and derivatives and combinations thereof.

In still other embodiment, the carboxylic acid-containing derivatives are modified with polyalkylenepolyamines, alkyl alcohols, alkylthiols.

In additional embodiments, the carboxylic acid-containing derivatives comprise combinations of the aforementioned branched and straight-chain aliphatic and cycloaliphatic, alkenyl, aryl, alkenylaryl, and alkylaryl, monomeri, dimeric, fortified (i.e., adducted with acrylic acid, maleic anhydride, or fumaric acid) esters of fatty acids and rosin acids and polymeric natural and synthetic fatty acids and fatty acid derivatives, rosin acids, tannic acids, vinsol resins, fortified (maleated and fumarated) fatty acids and rosin acids, fortified (i.e., adducted with acrylic acid, maleic anhydride, or fumaric acid) esters of fatty acids and rosin acids,polymeric carboxylic acids such as, but not limited to, styrene acrylic resins, polyacrylates, and styrene maleic polymers.

In certain embodiments, the polymeric carboxylic acids may be partially condensed with polyols and polyamines.

In still additional embodiments, the acidic viscosity modifier fatty acid comprises at least one of an acrylic acid, alkyl acrylic acid, ester or amide of acrylic acid, ester of alkylated acrylic acid, maleic acid, maleic acid ester, maleic anhydride, alkylated maleic anhydride, fumaric acid, alkylated fumaric acid, adipic acid, succinic acid, citric acid, 2,6-naphthenic carboxylic acid, terephthalic acid, an ester or amide derivatives thereof or a combination thereof. In still further embodiments, acidic viscosity modifier fatty acid is a partial ester of the fatty acid.

In certain embodiments, the acidic viscosity modifier comprises at least one of a mono-, di-, tri- or polycarboxylic acid, a dimerized, trimerized, or polymerized fatty acid or a combination thereof. In certain embodiments, the mono- or poly-carboxylic acid is a long-chain mono- or polycarboxylic acid. In yet additional embodiments, the long-chain mono- or polycarboxylic acid is natural or synthetic. In further embodiments, the long-chain, mono- or poly-carboxylic acid has a low volatility at temperatures in the range of 25° C. to 150° C.

In an embodiment, the bitumen-soluble, long-chain, mono- or poly-carboxylic acid has low volatility at temperatures in a range of about 25° C. to about 140° C., about 25° C. to about 130° C., about 25° C. to about 120° C., about 25° C. to about 110° C., about 25° C. to about 100° C., about 25° C. to about 90° C., about 25° C. to about 80° C., about 25° C. to about 70° C., about 25° C. to about 60° C., about 25° C. to about 50° C., about 25° C. to about 40° C., about 35° C. to about 150° C., about 35° C. to about 140° C., about 35° C. to about 130° C., about 35° C. to about 120° C., about 35° C. to about 110° C., about 35° C. to about 100° C., about 35° C. to about 90° C., about 35° C. to about 80° C., about 35° C. to about 70° C., about 35° C. to about 60° C., about 35° C. to about 50° C., about 45° C. to about 150° C., about 45° C. to about 140° C., about 45° C. to about 130° C., about 45° C. to about 120° C., about 45° C. to about 110° C., about 45° C. to about 100° C., about 45° C. to about 90° C., about 45° C. to about 80° C., about 45° C. to about 70° C., about 45° C. to about 60° C., about 55° C. to about 150° C., about 55° C. to about 140° C., about 55° C. to about 130° C., about 55° C. to about 120° C., about 55° C. to about 110° C., about 55° C. to about 100° C., about 55° C. to about 90° C., about 55° C. to about 80° C., about 55° C. to about 70° C., about 65° C. to about 150° C., about 65° C. to about 140° C., about 65° C. to about 130° C., about 65° C. to about 120° C., about 65° C. to about 110° C., about 65° C. to about 100° C., about 65° C. to about 90° C., about 65° C. to about 80° C., about 75° C. to about 150° C., about 75° C. to about 140° C., about 75° C. to about 130° C., about 75° C. to about 120° C., about 75° C. to about 110° C., about 75° C. to about 100° C., about 75° C. to about 90° C., about 85° C. to about 150° C., about 85° C. to about 140° C., about 85° C. to about 130° C., about 85° C. to about 120° C., about 85° C. to about 110° C., about 85° C. to about 100° C., about 95° C. to about 150° C., about 95° C. to about 140° C., about 95° C. to about 130° C., about 95° C. to about 120° C., about 95° C. to about 110° C., about 105° C. to about 150° C., about 105° C. to about 140° C., about 105° C. to about 130° C., about 105° C. to about 120° C., about 115° C. to about 150° C., about 115° C. to about 140° C., about 115° C. to about 130° C., about 125° C. to about 150° C., about 125° C. to about 140° C., or about 135° C. to about 150° C. The bitumen-soluble, long-chain, mono- or poly-carboxylic acid can have a low volatility at 25° C., 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., or 150° C.

In certain embodiments, the viscosity-modifying acid comprises at least one of the following:
1) linear and branched, saturated and unsaturated aliphatic and alicyclic dicarboxylic acids, also called α,ω-dicarboxylic acids (like succinic acid to C23 α,ω-carboxylic acids);
2) linear and branched, heteroatom-substituted aliphatic and alicyclic dicarboxylic acids and tricarboxylic acids (e.g., aspartic acid, glutamic acid, tartaric acid, and citric acid);
3) aromatic dicarboxylic acids like o-, m-, and p-terephthalic acid and 2,6-naphthalenedicarboxylic acid; including combinations thereof.

In general, it is preferred that the viscosity-modifying aliphatic and alicyclic dicarboxylic and tricarboxylic acids and aromatic dicarboxylic acids not be a nitrogen-containing, heteroatom-substituted acid, which may be zwitterionic and have a pKa above 6.0. It is generally preferred that, the viscosity-modifying acid have a pKa less than about 6.0.

In certain embodiments, the viscosity-modifying acids comprises organophosphate mono- and di-esters (also called alkyl phosphate esters) and ethoxylated and propoxylated derivatives thereof as well as organophosphonate, and organophosphinate derivatives, heteroatom substituted phosphoric acid derivatives such as glyphosphate and Michael addition reaction products of acrylic acid esters and phosphonic acid, 2-aminoalkylphosphonic acid, neridronic acid, ibandronic acid, organosulfate and organosulfonate derivatives, or combinations thereof.

In general, it is preferred that the viscosity-modifying organophosphate, organophosphinate, and phosphoric acid derivative acids not be a nitrogen-containing, heteroatom-substituted acid (which may be zwitterionic and have a pKa above 4.0). It is generally preferred that, the viscosity-modifying acid have a pKa less than about 4.0.

In any of the aspects or embodiments described herein, the compositions comprising the aforementioned viscosity-modifying organic acid and the aforementioned performance adjuvants may be treated in situ with the acid reactive metal salt followed by initiation of the reaction between the organic acid and metal salt by introduction of water, alcohol, and/or heat. Thus, the composition comprising the aforementioned viscosity-modifying organic acid and performance adjuvants, when properly formulated, is suitable for mass transport operations at ambient conditions. Addition of the acid-reactive metal salt and initiation, leads to an alteration in the rheological properties of the entire composition. The alteration is typically characterized as a stiffening or hardening of the material composition.

In any of the aspects or embodiments described herein, the viscosity-modifying carboxylic acid can be a carboxylic acid- or carboxylic acid derivative-(or both)-containing composition, wherein the CCI comprise a sufficient amount of a carboxylic acid or carboxylic acid derivative to effectuate the desired alteration in rheological properties, curing rate, stiffness, Useful Temperature Interval or combination thereof, when combined with an acid-reactive metal salt in the presence of water as described herein.

In any of the compositions or methods described herein, the compositions may comprise an effective amount of an acid-reactive metal salt to thereby alter the viscosity or rheological properties or both of the composition upon exposure to at least one of water, alcohol or heat. In a preferred aspect, upon exposure to at least one of water, an alcohol, or heat, the amount of an acid-reactive metal salt is sufficient to decrease the low temperature failure or increase the high temperature failure or both as compared to the at least one of bituminous material, resinous material, polymeric material or a combination thereof, alone (i.e., the starting material).

In any of the aspects or embodiments described herein, upon the exposure to at least one of water, an alcohol, or heat, the Useful Temperature Interval (UTI) of the composition as described herein is expanded by at least 3° C. as compared to the UTI of the at least one of bituminous material, resinous material, polymeric material or a combination thereof, alone (i.e., the initial or starting material prior to the CCI reaction). In certain embodiments, the UTI of the composition is expanded by at least 6° C. as compared to the UTI of the at least one of bituminous material, resinous material, polymeric material or a combination thereof, alone. In certain embodiments, the UTI of the composition is expanded by at least 12° C. as compared to the UTI of the at least one of bituminous material, resinous material, polymeric material or a combination thereof, alone. In certain embodiments, the UTI of the composition is expanded by at least 18° C. as compared to the UTI of the at least one of bituminous material, resinous material, polymeric material or a combination thereof, alone.

In certain embodiments, upon exposure to at least one of water, an alcohol or heat, at least one of viscosity, stiffness or hardness is increased in the CCI composition as compared to the at least one of bituminous material, resinous material, polymeric material or a combination thereof, alone (i.e., the initial or starting material prior to the CCI reaction).

In any of the aspects or embodiments described herein, the acid-reactive metal salt is reactive with the carboxylic acid viscosity-modifier in the composition. In certain embodiments, the acid-reactive metal salt comprises at least one of an alkali metal oxide, alkali earth metal oxide, transition metal oxide or post-transition metalloid oxide or hydroxide. In certain embodiments, the acid-reactive metal salt comprises at least one of magnesium oxide (MgO), calcium hydroxide (CaOH), calcium oxide (CaO), or quicklime. In certain embodiments, the acid-reactive metal salt comprises a member from the family of transition metal oxides, or zinc oxide (ZnO). In certain embodiments, the acid-reactive metal salt comprises a member from the family of post-transition metal oxides, or aluminum oxide (Al₂O₃).

In any of the aspects or embodiments described herein, an alcohol or water is added to the binder, acidic viscosity modifier, reactive metal salt mixture to initiate the CCI reaction and prepare the CCI composition. In certain embodiments, the alcohol is a polyol. In additional embodiments, the alcohol is a sugar alcohol. In further embodiments, the alcohol is glycerol. In certain embodiments, the alcohol is combined with the mixture at a temperature of ≧about 100° C., ≧about 110° C., ≧about 120° C., ≧about 130° C., ≧about 140° C., ≧about 150° C. In certain embodiments, the alcohol is combined with the mixture at a temperature of from about 100° C. to about 150° C.

In any of the aspects or embodiments described herein, the ratio of binder material, e.g., bitumen, resin, polymer or material comprising the same, to viscosity-modifying organic acid (e.g., carboxylic acids) is within the range of about 1:99 to about 99:1. In certain embodiments described herein, the ratio of binder, e.g., bitumen, to organic acid (e.g., carboxylic acids) is about 95:5. In certain embodiments described herein, the ratio is about 90:10, about 85:15, about 80:20, 75:25, 70:30, 65:35, 60:40, 55:45, 50:50, 45:55 or lower.

Stoichiometrically, the effective amount of the reactive metal salt may be molar ratios of the reactive metal oxide or metal salt in ratios with the viscosity-modifying acid or the carboxylic acid functionality, ranging from 0.1:1 to 10:1, but more preferably, 0.5:5.0, and even more preferably, 1:1 and 2:1, reactive metal oxide to viscosity-modifying acid or carboxylic acid functionality.

In an additional aspect, the description provides a material composition comprising: a) a bituminous material, a resinous material, and/or a polymeric material, b) a carboxylic acid or carboxylic acid derivative or a combination thereof; and c) an acid-reactive metal salt and water, or and acid-reactive metal salt and heat, wherein when (b) and (c) are combined a viscous or rigid composition is produced. In certain embodiments, part (a) or part (a) combined with part (b) includes performance adjuvants like mineral aggregate, pigments, fillers, etc.

In an additional aspect, the description provides a bituminous composition comprising: a) a bituminous mixture including bitumen or bitumen emulsion and a carboxylic acid or carboxylic acid derivative or a combination thereof; and b) an acid-reactive metal salt and water, wherein when (a) and (b) are combined a viscous or rigid bituminous composition is produced. In certain embodiments, part (a) includes aggregate.

For example, in an additional embodiment, the description provides a bituminous composition comprising: a) a fluxed bituminous mixture including bitumen and a carboxylic acid or carboxylic acid derivative or carboxylic acid containing substance or a combination thereof; and b) an acid reactive metal salt, wherein when (a) and (b) are combined with water, wherein the rheological properties of the bituminous composition, such as but not limited to viscosity, complex modulus, and top temperature PG grade, are increased.

In an further aspect, the description provides a bituminous composition comprising: a) a bituminous mixture including bitumen and a reactive metal oxide salt; and b) an aqueous solution or dispersion or emulsion of a carboxylic acid or carboxylic acid derivative or carboxylic acid containing substance or a combination thereof, wherein when (a) and (b) are combined, the resulting bituminous composition shows an increase in rheological properties such as, but not limited to, viscosity, stiffness, complex modulus, and top temperature PG grade, a viscous or rigid bituminous composition is produced.

In an additional aspect, the description provides a composition comprising: a) a carboxylic acid or carboxylic acid derivative or a combination thereof; and b) an effective amount of an acid-reactive metal salt and water, wherein when (a) and (b) are combined a viscous or rigid composition is produced. In certain embodiments, part (a) includes at least one of aggregate, bitumen, a bitumen emulsion or a combination thereof.

As described above, it is a well-known challenge in the art to make bitumen workable (i.e., to impart desired rheological properties). Currently, one must heat it to very high temperatures, “cut” it with solvent, or convert it to an oil-in-water emulsion or a combination of the preceding. Many pavement engineering applications have relied on these means of increasing the fluidity and ease-of-handling of bitumen and bituminous materials in new construction, maintenance, preservation, restoration and rehabilitation. Similarly, as described above, it is well known that roofing and water-proofing applications, such as built up roofing applications for very low-slope roofing systems, have likewise used these methods (heat, cutters, and emulsions) or variants thereof to impart the rheological properties needed in the bitumen and bituminous material for the demands of the engineering application.

There are a number of shortcomings associated with using heated bitumen, cut-back bitumen, and emulsified bitumen. For example, with cut-back bitumen, as the solvent evaporates the bitumen hardens as desired. However, current solvents used as “cutters,” e.g., naphtha, kerosene, diesel fuel, etc. are bad for the environment and for the workers who have to inhale the vapors. Alternatives have been tried, including fatty acids. Fatty acids are able to soften the bitumen (to lower viscosity sufficiently that it may be moved easily in operations like pumping and mixing) but are not volatile enough so it takes much longer to cure if they fully cure at all. Use of these three methods (heat, cutters, and emulsions) in building structure impermeabilization applications like foundation water-proofing and built-up roofing applications involves the same sets of shortcomings outlined above for bitumen applications in paving.

Thus, in one aspect, the description provides a bitumen composition comprising a dispersion or emulsion of bitumen with a miscible carboxylic acid derivative to yield a stable, approximately homogenous bitumen composition, wherein the mixture demonstrates a reduction in viscosity as compared to the bitumen alone. The reduction in viscosity is achieved by the addition of non-volatile carboxylic acids and carboxylic acid derivatives. It is contemplated herein that the general technique of treating bitumen or other hydrocarbon with a carboxylic acid or derivative to alter the rheology of the bitumen or other hydrocarbon (i.e., lower stiffness, lower viscosity, lower softening point, increase penetration, etc.) as described herein is envisioned to be applicable to the ambient temperature or low-temperature production of asphaltic or other hydrocarbon mixtures for paving, roofing, water-proofing, and underlayment. For example, the compositions as described herein can be utilized in a number of applications including trackless tack coats for paving, chip seals, virgin aggregate paving mixtures, pavement recycling and stabilization, and warm mix paving applications.

As described herein, the reduction in viscosity of the bitumen facilitates in certain embodiments the coating (at least partially) of aggregate and/or other solid materials and surfaces, e.g., at ambient temperatures or higher. It is further envisioned that the technique disclosed herein is practically applicable in unit operations and equipment configurations common to modern production and construction processes in the paving, roofing, water-proofing, and underlayment industries. According to the description, the original (i.e., prior to addition of the non-volatile carboxylic acid viscosity “cutter”) viscosity or rheological properties (e.g., rigidity) of the bitumen is subsequently restored by addition of an acid-reactive metal salt and water.

In any of the embodiments described herein, the compositions may comprise aggregate-containing materials, e.g., reclaimed asphalt pavement (RAP), recycled asphalt roofing shingles (RAS), or reclaimed Portland cement concrete materials and combinations thereof. In certain embodiments, the aggregate, RAP, RAS, cement material or combination is at least partially coated with a bitumen or bitumen-carboxylic acid mixture or with the carboxylic acid material alone as described herein. This coated aggregate material is combined with a reactive metal oxide salt and water (if the aggregate material did not initially contain a native quantity of adsorbed and absorbed moisture) to create a bituminous composition suitable for such applications as pavement construction.

In any of the aspects or embodiments described herein, the carboxylic acid can be a carboxylic acid- or carboxylic acid derivative-(or both)-containing composition, wherein the carboxylic acid-containing composition comprises a sufficient amount of a carboxylic acid or carboxylic acid derivative to achieve an increase in the viscosity or rheological properties when combined with an acid-reactive metal salt in the presence of water as described herein.

The “triggered” bituminous compositions of the description can be formed by alternative routes using the same basic components. For example, in certain embodiments, the triggered bitumen is formed by simultaneous addition of the organic acid (e.g., carboxylic acid), and the acid-reactive salt into the bitumen. The bitumen thus formed may be used for traditional applications such as in paving, roofing, and other water-proofing applications. Thus, in certain embodiments, the description also provides a composition comprising: a) a bitumen or bitumen emulsion; and b) a composition comprising an organic acid, e.g., carboxylic acid or derivative or combination thereof, an acid-reactive metal salt, and water; wherein the combination of (a) and (b) forms a carboxylate metal salt that effectuates an increase in bitumen viscosity and/or increase in bitumen hardening.

In certain embodiments, the amount of organic acid is from about 0.01 pounds to about 200 pounds per ton of aggregate. In certain embodiments, the amount of organic carboxylic acid is from 5 to about 95 pounds per ton of aggregate. In certain embodiments, the amount of organic acid is from about 10 to about 85 pounds per ton of aggregate. In certain embodiments, the amount of organic acid is from about 15 to about 75 pounds per ton of aggregate. In certain embodiments, the amount of organic acid is from about 20 to about 65 pounds per ton of aggregate. In certain embodiments, the amount of organic acid is from about 25 to about 55 pounds per ton of aggregate.

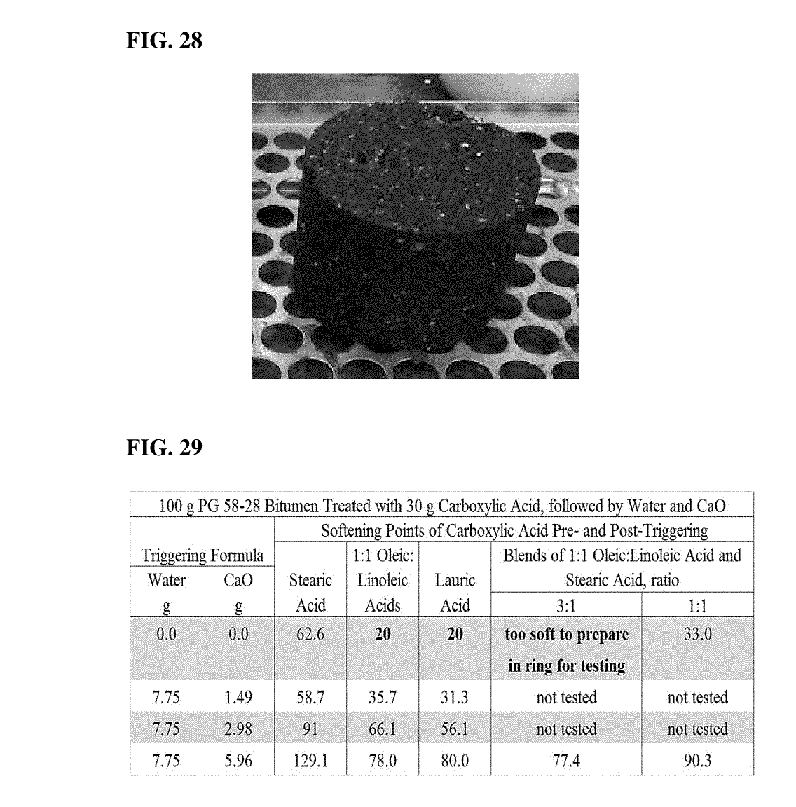

Surprisingly, it was discovered that relatively small levels of acid-reactive metal salt, e.g., CaO, actually drive the stiffening of the carboxylic acid coated aggregate or carboxylic acid treated bitumen coating aggregate. In certain embodiments, the amount of organic acid is from about 0.01% wt to about 5% wt by weight of the aggregate or RAP or RAS. In certain embodiments, the amount of organic acid, e.g., carboxylic acid derivative, is from greater than 0.01% wt to about 30% wt of the total bituminous paving composition (bitumen and aggregate) depending on the levels of binder to mineral aggregate (virgin aggregate or RAP). See the image at the end of FIG. 28. In certain embodiment, the amount of organic acid is from about 1% wt to about 8% wt of the total composition. In certain embodiment, the amount of organic acid is from 1% wt to about 6% wt of the total composition. In certain embodiment, the amount of organic acid is from about 1% wt to about 4% wt of the total composition.

In certain embodiments, the amount of organic acid, e.g., carboxylic acid, carboxylic acid derivative or combination thereof, is from about 2% wt to about 50% wt of the bitumen or bitumen emulsion. In certain embodiments, the amount of organic acid is from about 4% wt to about 45% wt of the bitumen or bitumen emulsion. In certain embodiments, the amount of organic acid is from about 6% wt to about 40% wt of the bitumen or bitumen emulsion. In certain embodiments, the amount of organic acid is from about 8% wt to about 35% wt of the bitumen or bitumen emulsion. In certain embodiments, the amount of organic acid is from about 10% wt to about 30% wt of the bitumen or bitumen emulsion. In certain embodiments, the amount of organic acid is from about 12% wt to about 25% wt of the bitumen or bitumen emulsion. In certain embodiments, the amount of organic acid is from about 15% wt to about 20% wt of the bitumen or bitumen emulsion.

In any of the aspects or embodiments described herein, the bitumen or bitumen emulsion further comprises aggregate in an amount of from about 1% wt to about 99% wt, wherein at least a portion of the surface of the aggregate is coated with the bitumen dispersion or emulsion-carboxylic acid mixture. In certain embodiments, the bitumen or bitumen emulsion/organic acid mixture comprises about 1, 2, 3, 4, 5, 6, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% wt of aggregate. In certain embodiments, the fluxed bitumen comprises about 5.0% w/w aggregate.

The mineral aggregate material used in the compositions and methods described herein can be of any type known in the art. For example, the aggregate may be dense-graded or aggregate common in production of asphalt concrete for road paving applications. Gradations may be very fine, as in the case of production of a bitumen mastic, e.g., Gussasphalt for paving, or a fillerized mastic of roofing and underlayment applications. Gradations may be open-graded as in the production patch mixes and pot-hole filler mixes.

In any of the aspects or embodiments described herein, the amount of acid-reactive metal salt (e.g., CaO) is present in an amount of from about 0.1% wt or more with respect to the amount by weight of the organic acid, e.g., carboxylic acid-treated bitumen. In any of the aspects or embodiments described herein, the amount of acid-reactive metal salt (e.g., CaO) is present in an amount of from about less than 99% wt with respect to the weight of the organic acid, e.g., carboxylic acid or carboxylic acid derivative. In certain embodiments, the amount of acid-reactive metal salt (e.g., CaO) is present in an amount of 0.1% wt to about 30% wt with respect to the amount by weight of the organic acid.

In certain embodiments, the amount of acid-reactive metal salt (e.g., CaO) is present in an amount of at least about 0.5% wt with respect to the amount by weight of the organic acid-treated bitumen. In certain embodiments, the amount of acid-reactive metal salt (e.g., CaO) is present in an amount of 1% wt to about 70% wt with respect to the amount by weight of the organic acid-treated bitumen. In certain embodiments, the amount of acid-reactive metal salt (e.g., CaO) is present in an amount of 1.1% wt to about 60% wt with respect to the amount by weight of the organic acid-treated bitumen. In certain embodiments, the amount of acid-reactive metal salt (e.g., CaO) is present in an amount of 1.2% wt to about 50% wt with respect to the amount by weight of the organic acid-treated bitumen. In certain embodiments, the amount of acid-reactive metal salt (e.g., CaO) is present in an amount of 1.3% wt to about 40% wt with respect to the amount by weight of the organic acid-treated bitumen. In certain embodiments, the amount of acid-reactive metal salt (e.g., CaO) is present in an amount of 1.4% wt to about 20 wt % with respect to the amount by weight of the organic acid-treated bitumen.

In certain embodiments, the amount of acid-reactive metal salt (e.g., CaO) is present in an amount of about 0.05% wt to about 20% wt with respect to the amount by weight of the organic acid-treated bitumen. In certain embodiments, the amount of acid-reactive metal salt (e.g., CaO) is present in an amount of about 0.1% wt to about 10% wt with respect to the amount by weight of the organic acid-treated bitumen. In certain embodiments, the amount of acid-reactive metal salt (e.g., CaO) is present in an amount of about 0.5% wt to about 5% wt with respect to the amount by weight of the organic acid-treated bitumen. In certain embodiments, the amount of acid-reactive metal salt (e.g., CaO) is present in an amount of about 1.0% wt to about 4% wt with respect to the amount by weight of the organic acid-treated bitumen. In certain embodiments, the amount of acid-reactive metal salt (e.g., CaO) is present in an amount of about 1.0% wt to about 3% wt with respect to the amount by weight of the organic acid-treated bitumen. In certain embodiments, the amount of acid-reactive metal salt (e.g., CaO) is present in an amount of about 2% wt to about 3% wt with respect to the amount by weight of the organic acid-treated bitumen. In a preferred embodiment, the amount of acid-reactive metal salt (e.g., CaO) is present in an amount of about 1.2% wt of the amount by weight of the organic acid-treated bitumen, e.g., carboxylic acid-treated bitumen. In a preferred embodiment, the amount of acid-reactive metal salt (e.g., CaO) is present in an amount of about 0.46% wt of the amount by weight of the organic acid-treated bitumen, e.g., carboxylic acid-treated bitumen.

In certain embodiments, the acid-reactive metal salt is added as-is and then followed by water. In certain additional embodiments, the acid-reactive metal salt is added all at once in “slurry” form.

In any of the aspects or embodiments described herein, the amount of water in the composition is about 0.01, 0.05, 0.1, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, or 10% wt with respect to the amount of the organic acid-treated bitumen, e.g., carboxylic acid-treated bitumen. In certain embodiments, the amount of water in the composition is about 2.4% wt with respect to the amount of the organic acid-treated bitumen, e.g., carboxylic acid-treated bitumen. In certain embodiments, the amount of water in the composition is about 4.8% wt with respect to the amount of the organic acid-treated bitumen, e.g., carboxylic acid-treated bitumen.

In certain embodiments, the bitumen compositions comprise an additive, for example, a surfactant or emulsifier, rheology modifier or combination thereof in amounts effective for the production of bitumen emulsions. In certain embodiments, the bitumen composition comprises a bitumen emulsion and a carboxylic acid derivative to lower viscosity. Emulsions comprising such carboxylic-acid treated bitumen could be used to create an oil-in-water emulsion or a water-in-oil (i.e., an invert) emulsion. Said emulsion could then be used to coat, at least partially, aggregate or other material. As described herein, the coated matter could then be “hardened” by addition of an acid-reactive metal salt and water (as disclosed herein) to restore the rheological properties of the bitumen prior to addition of the carboxylic acid “cutter.”

In an additional aspect, the description provides a bituminous composition comprising a combination of: a) a fluxed bitumen or bitumen emulsion including an organic acid, e.g., carboxylic acid, carboxylic acid derivative or combination thereof; and b) an acid-reactive metal salt and water, wherein (a) and (b) are combined thereby increasing the viscosity and/or increasing the hardness of the bituminous composition. In certain embodiments, part (a) includes aggregate. In certain embodiments, part (a) of the composition comprises an effective amount of the organic acid, e.g., carboxylic acid, derivative or combination thereof. In certain additional embodiments, part (b) of the composition comprises an effective amount of an acid-reactive metal salt. In certain additional embodiments, part (b) comprises an effective amount of water.

In an additional embodiment, the description provides a bituminous composition comprising: a) a fluxed bituminous mixture including bitumen and a carboxylic acid or carboxylic acid derivative or carboxylic acid containing substance or a combination thereof; and b) an acid reactive metal salt, wherein when (a) and (b) are combined with water, wherein the rheological properties of the bituminous composition, such as but not limited to viscosity, complex modulus, and top temperature PG grade, are increased.

In an additional aspect, the description provides a two-part bituminous composition comprising: a) a mixture including bitumen or bitumen emulsion and an effective amount of at least one of a carboxylic acid, carboxylic acid derivative or combination thereof; and b) a mixture including an effective amount of an acid-reactive metal salt and water, wherein the combination of (a) and (b) forms a carboxylate metal salt that effectuates an increase in bitumen viscosity and/or an increase in bitumen hardening. In certain embodiments, part (a) of the bituminous composition further includes an aggregate or other material, wherein the aggregate or other material is at least partially coated by the mixture.

In an additional aspect, the description provides a system or a kit comprising: a) at least one of a carboxylic acid, carboxylic acid derivative, composition comprising a carboxylic acid or a combination thereof; b) water; and c) an acid-reactive metal salt, wherein when (a)-(c) are combined a viscous or rigid composition is produced. In certain embodiments, part (a) includes at least one of bitumen, aggregate, RAP, RAS, Portland cement or a combination thereof. In certain embodiments, the aggregate RAP, RAS, Portland cement or a combination thereof is at least partially coated with the carboxylic acid or carboxylic acid derivative composition. In certain embodiments, the aggregate RAP, RAS, Portland cement or a combination thereof is at least partially coated with a bitumen-carboxylic acid or carboxylic acid derivative composition. It should be noted that the components can be mixed in any order, all of which are expressly contemplated.

In other aspects, the description provides a system comprising a combination of a at least one of a bitumen, bitumen dispersion or bitumen emulsion with a miscible carboxylic acid or carboxylic acid derivative or a combination thereof to yield a stable, approximately homogenous bitumen composition, wherein the mixture demonstrates a decrease in properties such as viscosity, complex modulus, low-temperature PG grade, and softening point as compared to the starting, untreated, carboxylic acid free bitumen or bitumen emulsion residue alone. Thus, in certain embodiments, rheological properties of the bituminous composition such as, but not limited to, the viscosity, the softening point, the complex modulus, and the top continuous temperature grade and lower continuous temperature grade are decreased by addition of the carboxylic acid or carboxylic acid derivative or combination thereof as compared to the starting bitumen without the carboxylic acid or carboxylic acid derivative. The system further comprises a composition comprising water, and an effective amount of an acid-reactive metal salt to thereby effectuate an increase in properties of the bituminous composition such as viscosity, complex modulus, top continuous PG grade, and softening point as compared to the starting bitumen alone. In certain embodiments, the mixture further comprises aggregate, wherein the aggregate is at least partially coated with the bitumen-carboxylic acid mixture.

In an additional aspect, the description provides a bituminous composition produced according to the steps of: a) admixing bitumen or a bitumen emulsion and an effective amount of at least one of a carboxylic acid, carboxylic acid derivative or combination thereof to form a homogenous mixture; b) admixing an effective amount of an acid-reactive metal salt and water; and optionally (c) combining (a) and (b) thereby forming a carboxylate metal salt that effectuates an in bitumen viscosity and/or increase in bitumen hardening.

Emulsifiers or surfactants used in compositions as described herein may be cationic types, amphoteric types, nonionic types, and combinations thereof.

Bitumen emulsions are of the oil-in-water type; they consist of a suspension of bitumen particles dispersed in the water phase. These particles have, in the case of cationic emulsions, a positive charge. The pH of cationic emulsions is below pH 7.0. Anionic bitumen emulsions are analogous to cationic bitumen emulsions, differing only in the charge of the dispersed phase particulates, which is negative. The pH of anionic emulsions is above pH 7.0. As the term implies, amphoteric emulsifiers are characterized by the capacity to lower interfacial tensions between dissimilar materials (e.g., bitumen and water) at pH values both above and below 7.0. The charge of the disperse-phase oil droplets in amphoteric emulsions may be either positive or negative. It is well within the ability of those skilled in the art to combine the bitumen and the emulsifiers taught herein to prepare the solvent-free bitumen emulsions of the present invention.

Suitable anionic emulsifiers include, but are not limited to, saturated C-12 to C-24 fatty acid; unsaturated C-12 to C-24 fatty acid; unsaturated C-12 to C-24 fatty acid modified with acrylic acid, maleic anhydride, fumaric acid, diene, or dieneophile; rosin acid; rosin acid modified with acrylic acid, maleic anhydride, fumaric acid, diene or dieneophile; natural resinous polymer such as VINSOL® a natural resin extracted from pinewood stumps commercially available from Hercules Inc.; quebracho resin; tannin; lignous polymer such as tall oil lignin and the like; polyacrylic acid; polyacrylate derivative; alkyl sulfonate; alkyl benzyl sulfonate; alkyl sulfate; alkyl phosphonate; alkyl phosphate; phenolic resin; and combinations thereof.

As used herein, the term “anionic emulsifiers” includes the above-noted compounds and their derivatives. These include, but are not limited to, complex, addition product, and condensation product formed by a reaction of (i) at least one member selected from the group consisting of natural resinous polymer such as VINSOL® a natural resin extracted from pinewood stumps commercially available from Hercules Inc., quebracho resin, tannins and lignin; and (ii) at least one member selected from the group consisting of saturated C10-C24 fatty acid, unsaturated C10-C24 fatty acid, and unsaturated C10-C24 fatty acid modified with at least one member selected from the group consisting of acrylic acid, maleic anhydride, fumaric acid, dienes and dienophile.

In certain embodiments, the organic acid, i.e., carboxylic acid or carboxylic acid derivative comprises an anionic surfactant or emulsifier. For example, in certain embodiments, the organic acid includes an anionic bitumen emulsion having a high dosage of C10-C24 fatty acids, C20-C48 dimerized fatty acids, tall oil fatty acids or resins that can be suitable for coating aggregate. To the anionic emulsifier composition, an effective amount of trigger, e.g., CaO, is added to effectuate an increase in the viscosity or rheological properties as described herein.

Sulfate, sulfonate, phosphate, or phosphonate derivatives of the aforementioned compounds are suitable for use in the present invention including, but are not limited to, those of lignin, natural resinous polymer such as VINSOL® a natural resin extracted from pinewood stumps commercially available from Hercules Inc., quebracho resin, and tannin. Sulfate, sulfonate, phosphate, or phosphonate derivatives of the complex, addition product, or condensation product formed by a reaction of (i) at least one member selected from the group consisting of natural resinous polymer, Vinsol resin, quebracho resin, tannins and lignin; and (ii) at least one member selected from the group consisting of saturated C10-C24 fatty acid, unsaturated C10-C24 fatty acid, and unsaturated C10-C24 fatty acid modified with at least one member selected from the group consisting of acrylic acid, maleic anhydride, fumaric acid, diene and dienophile may also be used in the present invention.

As used herein the term “amphoteric emulsifiers” includes both mono-amphoteric and polyamphoteric emulsifiers. Amphoteric emulsifiers suitable for use in the present invention may be products obtained by (i) modifying at least one member selected from the group consisting of C-12 to C-24 fatty acids and rosin acid with at least one member selected from the group consisting of acrylic acid, maleic anhydride, fumaric acid, diene and dieneophile; and then (ii) reacting the resulting modified products with at least one member selected from the group consisting of polyethylene polyamine, lithium C-12 to C-24 alkyl amidopropyl halide methyl carboxylate betaine, sodium C-12 to C-24 alkyl amidopropyl halide methyl carboxylate betaines, potassium C-12 to C-24 alkyl amidopropyl halide methyl carboxylate betaines, lithium C-12 to C-24 alkyl amidopropyl halide phosphate betaines, sodium C-12 to C-24 alkyl amidopropyl halide phosphate betaines, potassium C-12 to C-24 alkyl amidopropyl halide phosphate betaines, lithium C-12 to C-24 alkyl amidopropyl halide sulphate betaines, sodium C-12 to C-24 alkyl amidopropyl halide sulphate betaines, and potassium C-12 to C-24 alkyl amidopropyl halide sulphate betaines.

Emulsifiers suitable for use in compositions as described ehrein may include, but are not limited to, fatty imidazolines derived from C-12 to C-24 fatty acids; fatty imidoamines derived from (i) modifying at least one member selected from the group consisting of C-12 to C-24 fatty acids and rosin acid with at least one member selected from the group consisting of acrylic acid, maleic anhydride, fumaric acid, diene and dieneophile, and then (ii) reacting the resulting modified products with polyalkylenepolyamines; fatty amidoamines derived from (i) modifying at least one member selected from the group consisting of C-12 to C-24 fatty acids and rosin acid with at least one member selected from the group consisting of acrylic acid, maleic anhydride, fumaric acid, diene and dieneophile, and then (ii) reacting the resulting modified products with at least one member selected from the group consisting of polyalkylenepolyamines, saturated C-12 to C-24 alkyl monoamines, unsaturated C-12 to C-24 alkyl monoamines, saturated C-12 to C-24 alkyl polypropylenepolyamines, unsaturated C-12 to C-24 alkyl polypropylenepolyamines; polyoxyethylene derivatives made by modifying saturated C-12 to C-24 alkyl monoamines with at least one member selected from the group consisting of ethylene oxide and propylene oxide; polyoxyethylene derivatives made by modifying unsaturated C-12 to C-24 alkyl monoamines with at least one member selected from the group consisting of ethylene oxide and propylene oxide; polyoxyethylene derivatives made by modifying saturated C-12 to C-24 alkyl polypropylenepolyamines with at least one member selected from the group consisting of ethylene oxide and propylene oxide; polyoxyethylene derivatives made by modifying unsaturated C-12 to C-24 alkyl polypropylenepolyamines with at least one member selected from the group consisting of ethylene oxide and propylene oxide; saturated C-12 to C-24 alkyl aryl monoamines; unsaturated C-12 to C-24 alkyl aryl monoamines; saturated C-12 to C-24 alkyl aryl polypropylenepolyamines; unsaturated C-12 to C-24 alkyl aryl polypropylenepolyamines; saturated C-12 to C-24 quaternary amines; unsaturated C-12 to C-24 quaternary amines; C-12 to C-24 alkyl ether amines; C-12 to C-24 alkylether polyamines; C-12 to C-24 alkyl polypropylene polyamine N-oxide; amine derivatives of tannins; amine derivatives of phenolic resins; amine derivatives of lignins; amine-modified polyacrylates; and combinations thereof.

In certain embodiments, the cationic emulsifier may comprise a member selected from the group consisting of saturated C-12 to C-24 alkyl monoamines, unsaturated C-12 to C-24 alkyl monoamines, saturated C-12 to C-24 alkyl polypropylenepolyamines, unsaturated C-12 to C-24 alkyl polypropylenepolyamines, and combinations thereof.

In certain embodiments, the cationic emulsifier may be a blend of at least one member selected from the group consisting of saturated and unsaturated C-12 to C-24 alkyl monoamines, and at least one member selected from the group consisting of saturated and unsaturated C-12 to C-24 alkyl polypropylenepolyamines.

As used herein, the term “cationic emulsifiers” includes the above-noted compounds and their derivatives.

Nonionic emulsifiers which are suitable for use include, but are not limited, to the following: alkylaryl polyethylene oxide and polypropylene oxide derivatives; polyethylene oxide derivatives of branched, linear, and cyclic alkanols, sorbitan esters, mono- and polysaccharide derivatives; polypropylene oxide derivatives of branched alkanols, linear alkanols, cyclic alkanols, sorbitan esters, monosaccharide derivatives and polysaccharide derivatives; protein stabilizers such as casein and albumin; polyethoxylated derivatives of the anionic, amphoteric, and cationic emulsifiers mentioned above; polypropoxylated derivatives of the anionic, amphoteric, and cationic emulsifiers mentioned above; and mechanical stabilizers such as the phyllosilicate bentonite and montmorillonite clays.

In one embodiment, the emulsifier may be nonionic emulsifiers including, but are not limited to, alkyl polysaccharides; alkylphenol alkoxylates such as alkylphenol ethoxylates, alkylphenol propoxylates, dialkylphenol ethoxylates, and dialkylphenol propoxylates; fatty alcohol ethoxylates such as saturated or unsaturated fatty acid ethoxylate having linear, branched, or cyclic structure; saturated or unsaturated fatty acid propoxylate having linear, branched, or cyclic structure; ethoxylates of escinoleic acid or castor oil; and propoxylates of escinoleic acid or castor oil.

In certain embodiments, the emulsifier may comprise a nonionic emulsifiers including, but are not limited to, polyethylene-polypropylene block copolymers; hydroxypoly(oxyethylene)poly(oxypropylene)poly(oxyethylene) block copolymers; 1,2-propyleneglycol ethoxylated and propoxylated; and synthetic block copolymers of ethylene oxide and propylene oxide having molecular weights exceeding 300 g/mole.

In additional embodiments, the emulsifier may be non-tallow or non-tall oil based emulsifier including, but are not limited to, decyl alcohol ethoxylates; castor oil ethoxylate; ceto-oleyl alcohol ethoxylate; ethoxylated alkanolamide; fatty alcohol alkoxylates; dinonyl phenol ethoxylate; nonyl phenol ethoxylate; sorbitan ester ethoxylate; alkyl ether sulphate; monoalkyl sulphosuccinamate; alkyl phenol ether sulphate; fatty alcohol sulphate; di-alkyl sulphosuccinate; alkyl ether phosphate; alkyl phenol ether phosphate; alkyl naphthalene sulphonate; .alpha.-olefin sulphonate; alkyl benzene sulphonic acids and salt; alkyl ampho(di)acetate; alkyl betaine; alkyl polysaccharide; alkylamine ethoxylate; amine oxide; combinations thereof.

Oligomers, co-oligomers, ter-oligomers, tetra-oligomers, polymers, copolymers, terpolymers, or tetrapolymers of acrylic acid, alkylacrylic acid, or alkyl esters of acrylic acid, alkyl esters of alkylacrylic acid, hydroxyalkyl esters of acrylic acid, hydroxyalkyl esters of alkylacrylic acids, acrylamide, alkylacrylamide, N-alkyl acrylamide, N,N-dialkyl acrylamdide, N-hydroxyalkylacrylamide, N,N-dihydroxyalkylacrylamide, styrene, alkylstyrene, ethene, propene, higher order alkenes, dienes, allyl alcohol, polyhyrdoxylated polyalkenes, halogenated ethylene, halogenated propylene, and/or halogenated alkylidenes are suitable for use as surfactants in the present invention. Furthermore, the lithium, sodium, potassium, magnesium, calcium, ammonium, or alkylammonium salts of the aforementioned polymers may be used as emulsifiers in the present invention. Examples of suitable dienes for use in the present invention include, but are not limited to, butadiene, cyclopentadiene, and isoprene.

In certain embodiments, the emulsifier may comprise salt obtained by the reaction of (i) at least one member selected from the group consisting of hydrogen halides such as hydrochloric acid; carboxylic acids such as acetic acid, propionic acid, butyric acid, oxalic acid, maleic acid, fumaric acid, and citric acid; and phosphoric acid; and (ii) at least one member selected from the group consisting of oligomers, co-oligomers, ter-oligomers, tetra-oligomers, homopolymers, copolymers, terpolymers, and tetrapolymers of acrylic acid, alkylacrylic acid, alkyl esters of acrylic acid, alkyl ester of alkylacrylic acid, hydroxyalkyl ester of acrylic acid, hydroxyalkyl ester of alkylacrylic acid, acrylamide, alkylacrylamide, N-alkyl acrylamide, N,N-dialkyl acrylamdide, N-hydroxyalkylacrylamide, N,N-dihydroxyalkylacrylamide, styrene, alkylstyrene, ethane, propene, higher order alkene, diene, hydroxylated propene, polyhyrdoxylated polyalkenes, halogenated ethylene, halogenated propylene, and/or halogenated alkylidene. Examples of suitable dienes for use in the present invention include, but are not limited to, butadiene, cyclopentadiene, and isoprene.

In one embodiment of the present invention, the emulsifier may comprise a member selected from the group consisting of oligomeric ethyleneamines, oligomeric polypropyleneamines, hexamethylene diamine, bis-hexamethylene diamine, polyethylene polyamines, polypropylene polyamines, polyethylene/polypropylene polyamines, and higher order polyalkylene polyamines such as the distillation residues from polyalkylene polyamine manufacture.

In certain additional embodiments, the bituminous composition comprises an acid reactive metal salt, and water, wherein the acid-reactive metal salt and water form a carboxylate metal salt that effectuates a reduction in bitumen viscosity, and/or hardening of the bitumen composition.

In any of the aspects or embodiments described herein, the acid-reactive metal salt is an alkali metal oxide, alkali earth metal oxide, transition metal oxide, or post-transition metalloid oxide or metal salt. In any of the aspects or embodiments described herein, the acid reactive metal salt is at least one of an alkali earth metal oxide, magnesium oxide (MgO), calcium oxide (CaO or quicklime), calcium hydroxide or combination thereof. In any of the aspects or embodiments described herein, wherein the acid reactive metal salt is in the family of transition metal oxides, such zinc oxide (ZnO). In any of the aspects or embodiments described herein, the acid reactive metal salt is from the family of post-transition metal oxides, aluminum oxide (Al₂O₃). Other alkali, alkali earth, transition metal, and post-transition metal oxides, hydroxides, and salts, which are reactive with the carboxylic acid in the bitumen, may be used.

In any of the aspects or embodiments described herein, the ratio of acid-reactive metal salt to water is within the range of about 10:0.1 to about 0.1:10. In certain embodiments described herein, the ratio of acid-reactive metal salt to water is about 0.1:10. In certain embodiments described herein, the ratio of acid-reactive metal salt to water is about 0.5:5. In certain embodiments described herein, the ratio of acid-reactive metal salt to water is about 1:1. In certain embodiments described herein, the ratio of acid-reactive metal salt to water is about 5:0.5. In certain embodiments described herein, the ratio of acid-reactive metal salt to water is about 10:0.1.

Formation of calcium or other polyvalent metal salts of the carboxylic acids, e.g., calcium tallates and rosinates, leads to stiffening and hardening of the carboxylic acid or carboxylic acid derivative-containing composition. In certain embodiments, e.g., where a bitumen material is included, the calcium or other polyvalent metal salts promote the hardening of the bitumen. For example, the stiffening effect of the acid-reactive metal salt in viscosity-modified, carboxylic acid-treated bitumen alone was compared to results obtained with metal salt and water. The results showed that the combination of the appropriate metal salt and water was effective at stiffening the viscosity-modified bitumen. In the absence of the organic acid, no stiffening is observed. For example, metal salt additive alone or water alone did not have any stiffening effect.

As such, the acid-reactive metal salt/water component acts as to initiate and promote a coupling reaction with a concurrent increase viscosity increase of the organic acid; e.g., VOC-free (i.e., carboxylic acid-treated) bitumen mixtures, e.g., cold-patch mixtures. For example, as described herein, the CaO could be added to a stockpiled mix comprising aggregate and the bitumen composition as described herein at some time point shortly before the mixture is applied in the field, e.g., to a road, roof, or other structure.

In an additional aspect, the description provides a composition produced according to the steps of: admixing a carboxylic acid or carboxylic acid derivative or a combination thereof, water, and an effective amount of an acid-reactive metal salt thereby forming a carboxylate metal salt that effectuates an increase in at least one of viscosity, softening point, complex modulus, top-temperature PG grade or a combination thereof. Those skilled in the art would refer in the industry vernacular as increasing the bitumen hardness or stiffness. In certain embodiments, the process includes the addition of at least one of bitumen, aggregate, RAP, RAS, Portland cement or a combination thereof. In certain embodiments, the process includes the step of at least partially coating the aggregate, RAP, RAS, Portland cement or a combination thereof with the carboxylic acid or carboxylic acid derivative or a combination thereof. In certain embodiments, the process includes the step of at least partially coating the aggregate, RAP, RAS, Portland cement or a combination thereof with a composition comprising bitumen or a bitumen emulsion and a carboxylic acid or carboxylic acid derivative or a combination thereof.

In an additional aspect, the description provides a bituminous composition produced according to the steps of: a) admixing bitumen or a bitumen emulsion and an effective amount of a carboxylic acid to form a homogenous mixture; b) admixing an effective amount of an acid-reactive metal salt and water; and c) combining parts (a) and (b), thereby forming a carboxylate metal salt that effectuates a reduction in bitumen viscosity and/or increase in bitumen hardening. In certain embodiments, the process includes a step of coating at least partially an aggregate with the mixture of any of parts (a), (b).

In an additional aspect, the description provides a bituminous composition produced according to the steps of: a) admixing bitumen or a bitumen emulsion, and a carboxylic acid or carboxylic acid derivative or a combination thereof to form a homogenous mixture; adding to the mixture (a) a composition, (b), which includes an effective amount of an acid-reactive metal salt and water, thereby forming a carboxylate metal salt that effectuates an increase in bitumen rheological properties such as, but not limited to, viscosity, softening point, complex modulus, and top-temperature PG grade. In certain embodiments the sequence of mixing can be interchanged.

In certain embodiments, the mixture further comprises mineral aggregate-containing materials such as, but not limited to, reclaimed asphalt pavement (RAP), recycled asphalt roofing shingles (RAS), or reclaimed Portland cement concrete materials and combinations thereof, wherein the mineral aggregate material is treated with an effective level of a reactive mineral oxide and water (provided the mineral aggregate material does not contain an effective level of absorbed or adsorbed water) followed by coating with a) the carboxylic acid containing material or b) bitumen comprising a carboxylic acid material or (b) followed by (a) or (a) and (b) simultaneously, or (c). In certain embodiments the sequence of mixing (a), (b), and (c) can be interchanged.

In an additional aspect, the description provides a bituminous composition produced according to the steps of: a) providing a first composition comprising bitumen or a bitumen emulsion; b) providing an effective amount of a carboxylic acid; c) providing an effective amount of an acid-reactive metal salt and water; and d) combining parts (a)-(c), thereby forming a carboxylate metal salt that effectuates a reduction in bitumen viscosity and/or increase in bitumen hardening. In certain embodiments, the process includes a step of coating at least partially an aggregate with the mixture of any of parts (a), (b), (c) or (d)). In certain embodiments the sequence of mixing (a), (b), and (c) can be interchanged.

In an additional aspect, the description provides a composition, e.g., a CCI composition comprising at least one of a resin or a polymeric material, an acidic viscosity modifier, and an acid-reactive metal salt to yield a mixture having an initial viscosity, wherein upon the exposure to at least one of water, an alcohol, or heat, the viscosity of the composition increases as compared to the initial viscosity. In certain embodiments, the polymeric material is at least one of acrylate ester polymer, styrene polymer, polyarylene-polyalkylene block polymer, styrene-butadiene-styrene block polymer (SBS), styrene ethylene butylene styrene block copolymer (SEBS), styrene-butadiene rubber (SBR), styrene-block-isobutylene-block-styrene) (SIBS), latex polymer or a combination thereof.

In an additional aspect, the description provides a method of preparing a polymeric composition comprising preparing an admixture comprising: a polymeric material; an acidic viscosity modifier; and an acid-reactive metal salt; and adding to the admixture in (a) at least one of water, an alcohol, or heat, wherein the process results in an increase in viscosity of the polymeric composition as compared to the initial admixture. In certain embodiments, the polymeric material is at least one of acrylate ester polymer, styrene polymer, polyarylene-polyalkylene block polymer, styrene-butadiene-styrene block polymer (SBS), styrene ethylene butylene styrene block copolymer (SEBS), styrene-butadiene rubber (SBR), styrene-block-isobutylene-block-styrene) (SIBS), latex polymer or a combination thereof.

In an additional aspect, the description provides a kit comprising: a) a first container comprising a mixture including bitumen or bitumen emulsion and an effective amount of an organic acid, e.g., carboxylic acid, carboxylic acid derivative or combination thereof (with certain acids; and b) a container comprising a mixture including an effective amount of an acid-reactive metal salt and water, wherein the combination of (a) and (b) forms a carboxylate metal salt that effectuates an increase in bitumen viscosity and/or increase in bitumen hardening. In certain embodiments, (a) further includes an aggregate or other material, wherein the aggregate or other material is at least partially coated by the mixture.

In an additional aspect, the description provides a kit comprising: a) a first container comprising bitumen or bitumen emulsion; b) a second container comprising an effective amount of an organic acid, e.g., carboxylic acid, carboxylic acid derivative or combination thereof; and c) a third container comprising an effective amount of an acid-reactive metal salt and water, wherein the combination of (a)-(c) forms a carboxylate metal salt that effectuates a reduction in bitumen viscosity and/or increase in bitumen hardening. In certain embodiments, the kit includes an aggregate or other material, wherein the aggregate or other material is at least partially coated by the mixture.

Methods

In another aspect, the description provides methods of making and using the compositions as described herein. In certain embodiments, the description provides a method of reducing the viscosity of a hydrocarbon, such as but not limited to bitumen or petroleum pitch, by addition of an effective amount of an organic acid, e.g., at least one of a carboxylic acid, carboxylic acid derivative or combination thereof, e.g., fatty acid or rosin acid. By reducing viscosity in this way, the carboxylic acid-treated hydrocarbon can be handled, transported, sprayed, etc., with little or no heating. In certain additional embodiments, the method includes a step of increasing the viscosity and/or increasing the hardness of the organic acid-treated (e.g., carboxylic acid-treated) hydrocarbon by reaction with an acid-reactive metal salt and water. Surprisingly, the acid-reactive metal salts of this invention did not work without the addition of water.

In an additional aspect, the description provides a method of triggering curing of a composition comprising an organic acid, e.g., carboxylic acid, carboxylic acid derivative or composition comprising the same, including the steps of: a) providing at least one of a carboxylic acid, carboxylic acid derivative, composition comprising the same, or a combination thereof; b) providing a mixture of an effective amount of an acid-reactive metal salt and water; and c) combining (a) and (b) thereby effectuating an increase in viscosity and/or increase in the hardening of the bituminous composition. In certain embodiments the sequence of mixing (a) and (b) can be interchanged.

In an additional aspect, the description provides a method of triggering curing of a bituminous composition comprising the steps of: a) providing a fluxed bituminous mixture including bitumen or bitumen emulsion and an effective amount of a carboxylic acid or carboxylic acid derivative or a combination thereof; b) providing a mixture of an acid-reactive metal salt and water; and c) combining (a) and (b) thereby effectuating an alteration in the rheological properties of the bituminous composition such that the difference between the top-temperature PG grade (also known as the high-temperature PG grade) and the low-temperature PG grade is increased relative to the difference in top- and low-temperature PG grade of the starting bitumen. In certain embodiments, the method comprises triggering curing of a bituminous composition as described herein for paving, roofing water-proofing, underlayment applications or combinations thereof comprising the steps of: a) providing a fluxed bituminous mixture including bitumen and a carboxylic acid derivative; b) providing a mixture of an acid-reactive metal salt and water; and c) combining (a) and (b) thereby promoting the hardening of the bituminous mixture. In certain embodiments the sequence of mixing (a) and (b) can be interchanged.

The bituminous/organic acid mixture, e.g., (a), in a preferred aspect is a fluxed mixture; i.e., it has a reduced viscosity as compared to the bitumen in the absence of the organic acid. As such, the bitumen mixture is more readily applied and spread using conventional equipment, e.g., sprayers.

In certain embodiments, the method comprises triggering curing of a bituminous composition as described herein for paving, roofing water-proofing, underlayment applications or combinations thereof comprising the steps of: a) providing a fluxed bituminous mixture including bitumen or a bitumen emulsion and an organic acid, e.g., a carboxylic acid, carboxylic acid derivative or combination thereof; b) providing a mixture of an acid-reactive metal salt and water; and c) combining (a) and (b) thereby increasing the viscosity and/or the hardening of the bituminous mixture, wherein the bituminous composition is applied to a structure, e.g., a roof or roofing structure or component, a building, a concrete form or foundation, a road, a pavement structure, a pavement block or combination thereof.

In any of the aspects or embodiments described herein, the carboxylic acids and carboxylic acid derivatives and combinations thereof may be saturated and unsaturated, branched, cyclic aliphatic, alkenylaryl, alkylaryl, and heterocyclic carboxylic acids and carboxylic acid derivatives. Such substances include, but are not limited to, C12-C30 carboxylic acid and derivatives obtained from tall oil, vegetable oils, petroleum oils of natural and synthetic sources and combinations thereof.

In any of the aspects or embodiments described herein, the carboxylic acids and carboxylic acid derivatives comprise dimer, trimer, and higher order polycarboxylic acids such as, but not limited to oxalic, adipic, succinic, sebacic acids, tall oil dimer and trimer acid, dimerized oleic acid and linoleic acids, trimerized oleic and linoleic acids, and polymeric carboxylic acids, such as, but not limited to, synthetic products such as styrene acrylic resins, polyalkylacrylates, styrene maleic resins, which may be partially condensed with polyols and polyamines.

In any of the aspects or embodiments described herein, the carboxylic acids, polycarboxylic acids, and derivatives comprise derivatives of rosin acids, tannic acids, vinsol resins, and derivatives and combinations thereof.

In any of the aspects or embodiments described herein, the carboxylic acid-containing derivatives are modified with polyalkylenepolyamines, alkyl alcohols, alkylthiols.

In any of the aspects or embodiments described herein, the carboxylic acid-containing derivatives comprise combinations of the aforementioned branched and straight-chain aliphatic and cycloaliphatic, alkenyl, aryl, alkenylaryl, and alkylaryl, monomeri, dimeric, and polymeric natural and synthetic fatty acids and fatty acid derivatives, rosin acids, tannic acids, vinsol resins, fortified (maleated and fumarated) fatty acids and rosin acids, polymeric carboxylic acids such as, but not limited to, styrene acrylic resins, polyacrylates, and styrene maleic polymers.

In any of the aspects or embodiments described herein, the polymeric carboxylic acids may be partially condensed with polyols and polyamines.

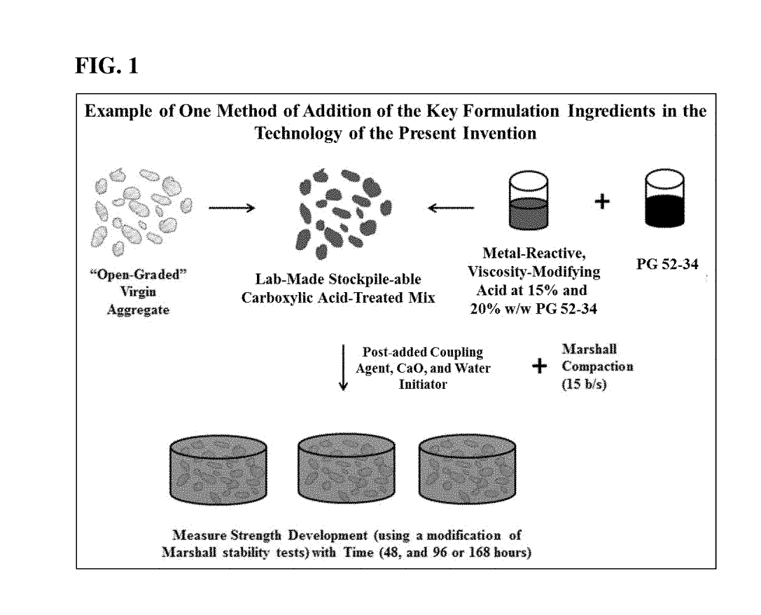

An illustration of exemplary embodiments of a compositions and method as described herein with reference to the figures and examples below. In the example of FIG. 1, for example, aggregate is pre-coated with a combination of bitumen and viscosity-modifying carboxylic acid containing material, such as but not limited to at least one of tall oil fatty acids, vegetable-derived fatty acids, resin acids, rosin acids, dimerized acids, trimerized acids, polymers containing carboxylic acids, hydrocarbon resins containing fatty acids, acid-modified waxes or combinations thereof. (The use of the bitumen co-binder along with the reactive, viscosity-modifying acid is optional as shown in Examples 18, 20, 23, 24, and 25). The coated aggregate can be stored until use as shown in Example 25. When desired, the coated bitumen is mixed with water and CaO is added to induce a stiffening of the mixture. The bitumen may be modified with polymers and other additives, as shown in Examples 15, 16, and 17 (which involved sulfur-crosslinked styrene-butadiene polymer).

As would be understood by the skilled artisan in view of the present description, the aggregate can be pre-coated, or coated just prior to application, e.g., use in a paving application.

In any of the aspects or embodiments as described herein, the acid-reactive metal salt, e.g., CaO, may be added to the bitumen/organic acid mixture first followed by water or vice a versa. Alternatively, in any of the aspects or embodiments described herein, the acid-reactive metal salt, e.g., CaO, and water may be combined into a slurry prior to addition to the bitumen/organic acid mixture.

The following examples are provided to illustrate and aid the skilled artisan as to certain aspects and features provided by the present description. Accordingly, the examples are meant to illustrate, but in no way limit, the claimed invention.

### EXAMPLES

The techniques disclosed herein address one or more of the aforementioned shortcomings in the art of paving, roofing, water-proofing, and underlayment applications involving hot bitumen, bitumen treated with volatile organic distillates and solvents, and bitumen emulsions. For example, the description provides methods for using organic acid-treated (e.g., carboxylic acid-treated) bitumen to coat solid aggregate surfaces (and the surfaces of other solid materials) at reduced temperatures to yield a fully-coated composition of bitumen and aggregate. In a simultaneous or sequential mixing step, the fully-coated bitumen-aggregate composition may be treated with an acid-reactive metal salt and water to trigger the hardening of the bitumen-aggregate composition by formation of carboxylate metal salts.

The unexpected alteration in the rheology of the bitumen (and/or bituminous composition) made possible through implementation of the teachings of this invention can be measured in an number of ways common to one skilled in the art: 1) an increase in the complex modulus of the bituminous at a given frequency and/or temperature, 2) an increase in the dynamic viscosity of the bituminous material, 3) an increase in Brookfield viscosity of the bituminous material, 4) an increase in softening point of the bituminous material, and 5) a decrease in the penetration value of the bituminous material, and many other physical properties, which are all commonly recognized physical properties that reflect the hardness and stiffness of a bituminous material. The resulting bituminous composition may be used in adhesive applications wherein a stiffer bonding layer is required, such as paving, roofing, water-proofing, and underlayment applications.

### Example 1

Table I illustrates an embodiment as described herein using softening points as a measure of the alterations in rheology of the bitumen. The Ring & Ball softening point (ASTM D36M) of a PG 67-22 paving-grade bitumen was 50.4° C. By treatment of this PG 67-22 bitumen with a carboxylic acid derivative (in this case a distilled tall oil fraction containing mono-, di-, and trimer fatty acids and rosin acids), the Ring & Ball softening point dropped to 32.1° C. (The distilled tall oil fraction is abbreviated “DTO” in Table I.). Upon addition with stirring by hand of a reactive metal salt (CaO in this case) and water, the softening point of the DTO-treated bitumen rose to 60.9° C.

Similar results were observed when starting with a PG 52-34 bitumen. To the PG 52-34 bitumen 15 wt % DTO. (carboxylic acid compositions, undistilled or refined, from other sources (besides tall oil derivatives) would be suitable for use as described in this disclosure.) was added with thorough stirring. The resulting softening point of the DTO-treaated PG 52-34 was too low to measure. However, after addition with thorough stirring of 1.2 wt % CaO and 1.2 wt % water to the 15 wt % DTO-treated PG 52-34, the Ring & Ball softening point rose to 50.1° C.

TABLE I

| Starting Bitumen | PG 67-22 | PG 52-34 |
|---|---|---|
| Starting Bitumen Ring & Ball (R&B) | 50.4 +/− 0.0 | 37.7 +/− 0.2 |
| Softening Point, ° C. | | |
| Wt % DTO Added to Starting Bitumen | 35 | 15 |
| DTO-Treated Bitumen R&B Softening | 32.1 +/− 0.7 | Too soft |
| Point, ° C. | | to measure |
| Wt % CaO/Wt % Water Added to | 2.8/2.8 | 1.2/1.2 |
| DTO-Bitumen | | |
| Triggered, DTO-Treated Bitumen | 60.9 +/− 0.5 | 50.1 +/− 0.1 |
| Softening Point, ° C. | | |

As described herein, the bitumen as exemplified in Table I can be substituted with a bituminous composition (such as unmodified and polymer-modified emulsions and coatings) and compositions of bitumen and aggregate and methods of making and using said compositions as described above.

### Example 2. Results of Strength Development Testing

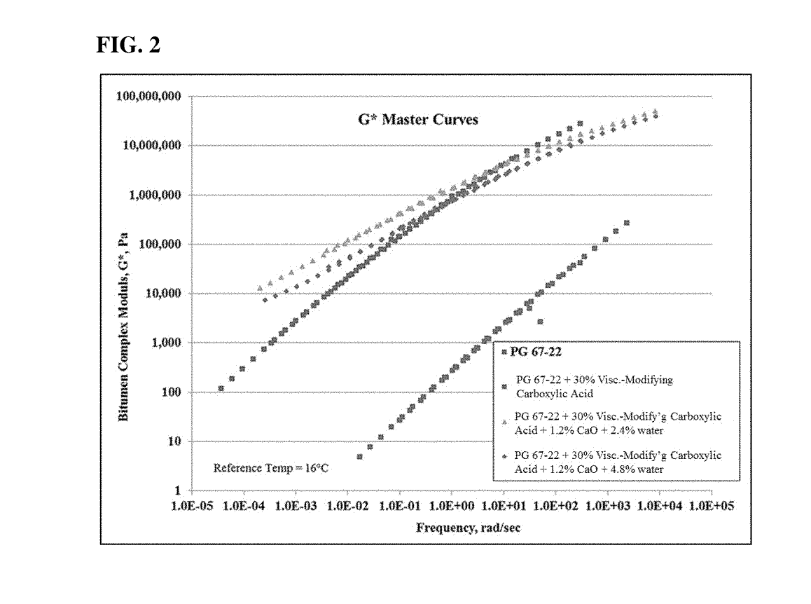

FIG. 2 illustrates rheological master curves showing the unexpected effect of treating a bituminous composition with a viscosity-modifying acid derivative and metal oxide. The PG 67-22 was treated with a carboxylic acid derivative (carboxylic acids derived from a distilled tall oil mixture of tall oil fatty acids and resin and rosin acids; labeled carboxylic acid) in a ratio of 70 parts PG 67-22 to 30 parts organic acid. The complex modulus master curve is labeled PG 67-22+30% organic acid. The PG 67-22+30% organic acid was then treated with an acid-reactive metal salt and water. The reactive metal salt in this case was CaO. 1.2% of the CaO additive (w/w carboxylic acid-treated bitumen) was used with 2.4% water (w/w carboxylic acid-treated bitumen) in one case and 4.8% in the second. As noted in the description above of FIG. 1, the increase in the modulus curve of bitumen-free, carboxylic acid-containing materials may also be increased by treatment with a reactive metal salt, like CaO, and water.

The carboxylic acid-treated bitumen was heated to 90° C. While stirring the 90° C. carboxylic acid-treated bitumen with a spatula, the “triggers” described in the table below were added. After stirring approximately one minute, the samples were returned to a 90° C. oven for 5 minutes. Then samples were removed from the oven until they were tested on an Anton Paar Dynamic Shear Rheometer. Table II shows the results of the analyses.

Table II demonstrates the unexpected effect of the formulation and method disclosed herein on the stiffness of a PG 67-22 bitumen treated with a distilled tall oil (labeled C2B). PG67-22 is paving grade bitumen. “Slurry” is a mixture of 1 g CaO with 2 g H₂O. Table II demonstrates that there is a substantial effect on stiffness of the bitumen after treatment.

### Example 3. Rheological Master Curves were Also Developed to Show the Unexpected Triggering Effect

The complex modulus master curve of a PG 67-22 paving grade bitumen was developed. It is labeled PG 67-22 in FIG. 2. The PG 67-22 was treated with a viscosity-modifying carboxylic acid derivative in a ratio of 70 parts PG 67-22 to 30 parts acid. The master curve of this carboxylic acid-treated PG 67-22 was also measured. The complex modulus master curve is labeled PG 67-22+30% carboxylic acid in FIG. 2. The PG 67-22+30% carboxylic acid was then treated with a “trigger” chemical and water. The reactive metal salt trigger chemical in this case was CaO. 1.2% of the CaO (w/w carboxylic acid-treated bitumen) was used with 2.4% water (w/w carboxylic acid-treated bitumen) in one case and 4.8% in the second. The decrease in the complex modulus master curve upon addition of 30 wt % viscosity-modifying acid was not surprising. However, the increase of the complex modulus master curve of the CaO/water 30% acid-treated bitumen to the level of the original, untreated PG 67-22 bitumen was very surprising.

### Example 4

Following the method described in Example 3, a similar experiment was conducted with a PG 52-34 rather than a PG 67-22. Three ratios of carboxylic acid and bitumen were used in this example. They were ratios of 10:90, 15:85, and 20:80, carboxylic acid to bitumen. The carboxylic acid again in this case is distilled tall oil. The master curves (change in complex moduli with respect to frequency) were defined by Equation 1.

ln(Complex Modulus, Pa)=−0.2472*(% Viscosity Modifier)+0.89025*(ln(Frequency)+11.4559 Eq. 1

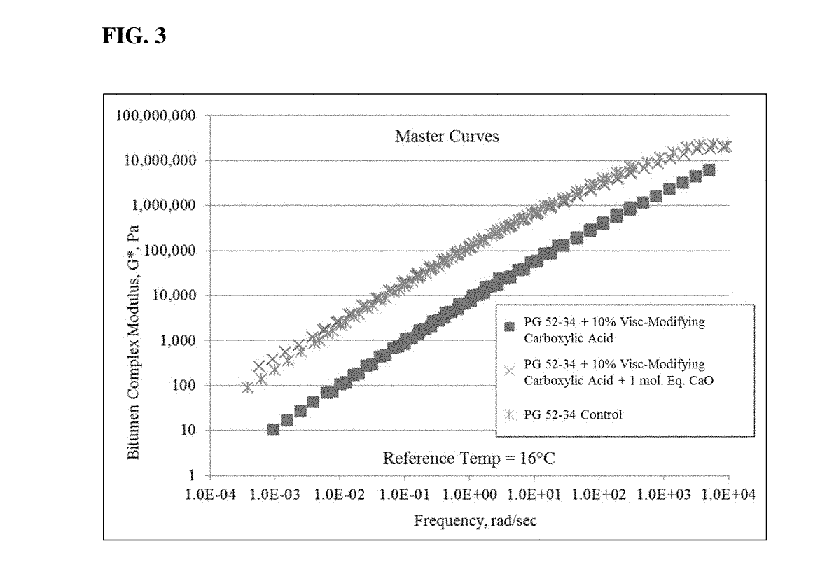

FIG. 3 illustrates rheological master curves showing the unexpected triggering effect. The PG 52-34 was treated with a carboxylic acid derivative (labeled carboxylic acid) in a ratio of 90 parts PG 52-34 to 10 parts viscosity-reducing, reactive carboxylic acid. The complex modulus master curve is labeled PG 52-34+10% organic acid. The PG 52-34+10% organic acid was then treated with an acid reactive metal salt and water. As noted above elsewhere in this disclosure, the hydrocarbon medium may be materials other than bitumen such as, but not limited to, waxes, fatty esters like triglycerides, petroleum distillates, C5 cyclopentadiene resins, C10 dicyclopentadiene resins, cumen resins, rosin esters, phenolic resin hybrids with C5 or rosin esters, acrylate ester polymers, styrene polymers, polyarylene-polyalkylene block polymers, and latex polymers.

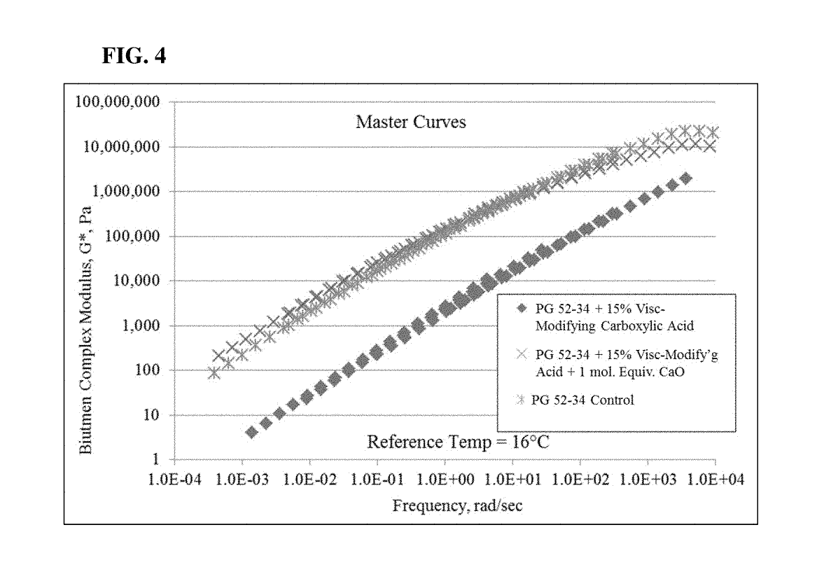

FIG. 4 illustrates rheological master curves showing the unexpected triggering effect. The PG 52-34 was treated with a carboxylic acid derivative (labeled carboxylic acid) in a ratio of 85 parts PG 52-34 to 15 parts viscosity-modifying carboxylic acid. The complex modulus master curve is labeled PG 52-34+15% organic acid. The PG 52-34+15% organic acid was then treated with an acid-reactive metal salt and water. Similar master curves comparing the moduli of carboxylic acid-treated bitumen not treated according to the teachings of this disclosure to the moduli of carboxylic-acid treated bitumen, treated according to the technique of this invention, have been demonstrated for systems comprising carboxylic acids such as lauric acid, stearic acid, C-36 dimer fatty acids, acrylic polymers.

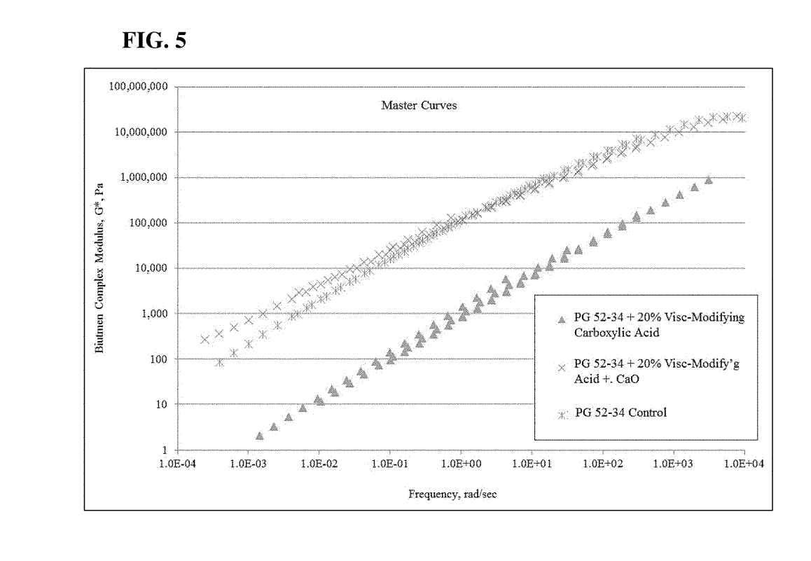

FIG. 5 illustrates rheological master curves showing the unexpected rheology altering effects. The PG 52-34 was treated with a carboxylic acid derivative (labeled carboxylic acid) in a ratio of 80 parts PG 52-34 to 20 parts carboxylic acid viscosity modifier. The complex modulus master curve is labeled PG 52-34+20% organic acid. The PG 52-34+20% organic acid was then treated with an acid-reactive metal salt and water.

The results of this experiment showed again that the modulus (master curve) of the PG 52-34 was lowered by about one to two orders of magnitude by treatment of the PG 52-34 with a carboxylic acid derivative (in this case distilled tall oil). Then, upon addition with stirring of the triggering agent (a sequential addition of CaO followed by water), the modulus of the triggered, carboxylic acid-treated PG 52-34 bitumen was restored to nearly the same moduli (master curve) of the unreacted carboxylic acid-free, starting PG 52-34 bitumen. FIGS. 3, 4, and 5 show these results.

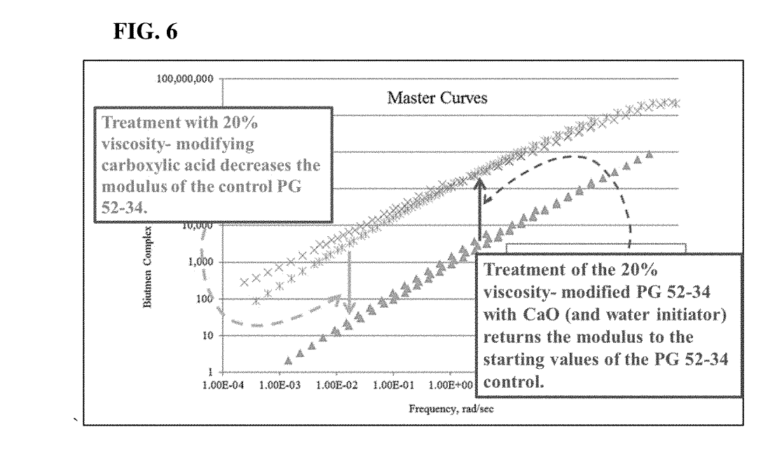

FIG. 6 illustrates one of the unexpected effect of the invention disclosed herein and represented by the results of Experiment 3 (PG 52-34 bitumen treated with distilled tall oil and reacted with CaO and water, the latter added with stirring to the carboxylic acid-treated PG 52-34 either simultaneously or sequentially). In the example, the addition of an organic acid results in a viscosity-lowered bitumen, and the addition of an acid-reactive metal salt restores the viscosity and hardens the bitumen. In other words, the addition of the reactive metal-oxide to the CCI composition results in a return of the modulus to levels observed with the PG 52-34 bitumen control (i.e., “uncut”). As such, the compositions described herein, allow for the modification of bitumen to facilitate mass transport, and then return the viscosity, stiffness, hardness and/or Useful Temperature Interval to desired service levels.

### Example 5

In the laboratory, we made a viscosity-adjusted, carboxylic-acid treated PG 52-34 patch mix using a 10:90, a 15:85 and a 20:80 ratio of carboxylic acid viscosity modifier and PG 52-34 bitumen. The carboxylic acid derivative, in this case, distilled tall oil. An open-graded aggregate was used. The content of the carboxylic acid, viscosity-modified bitumen was 5.0% w/w aggregate. Patch mixtures were stored overnight. After overnight storage, the patch mixtures were treated in a bucket mixer with effectively 0.46 to 1.22% of trigger additive and 1.86 to 4.60% water (w/w bitumen), either as-is and then followed by water or all at once in “slurry” form. These treated mixtures were then placed in 4-inch Marshall molds and compacted with 15 blows per side using a Marshall hammer at room temperature. The specimens were then allowed to stand at room temperature for various periods of time: 48, 96, and 168 hours. After standing at room temperature, the compacted mixtures were extracted from the Marshall molds and measured for indirect tensile strength using a Lottman breaking head, well-known to those skilled in the art. The results of these analyses are shown in the table below. In experiments 1-3, the “cutter” was diesel fuel. The Marshall stability was only 89-90 kPa, and after 168 h of curing, the specimens did not increase in strength. The patch mix specimens prepared in experiments 4-9 were made with distilled tall oil and PG 52-34 bitumen in a 15:85 (experiments 4-6) and 20:80 (experiments 7-9) ratios. No acid-reactive metal salt was used in these experiments 4-9. The compacted specimens in experiments 4-9 exhibited very low Marshall strengths, ranging from 4 to 44 kPa. In contrast, in experiments 10-21, the carboxylic acid-treated patch mixtures were reacted with CaO in amounts ranging from 0.46 10 1.22% CaO w/w mixture. The stability in the majority of the tests was an order of magnitude higher than the compacted, control specimens of experiments 4-9. Table III shows these mixture results.

### Example 6

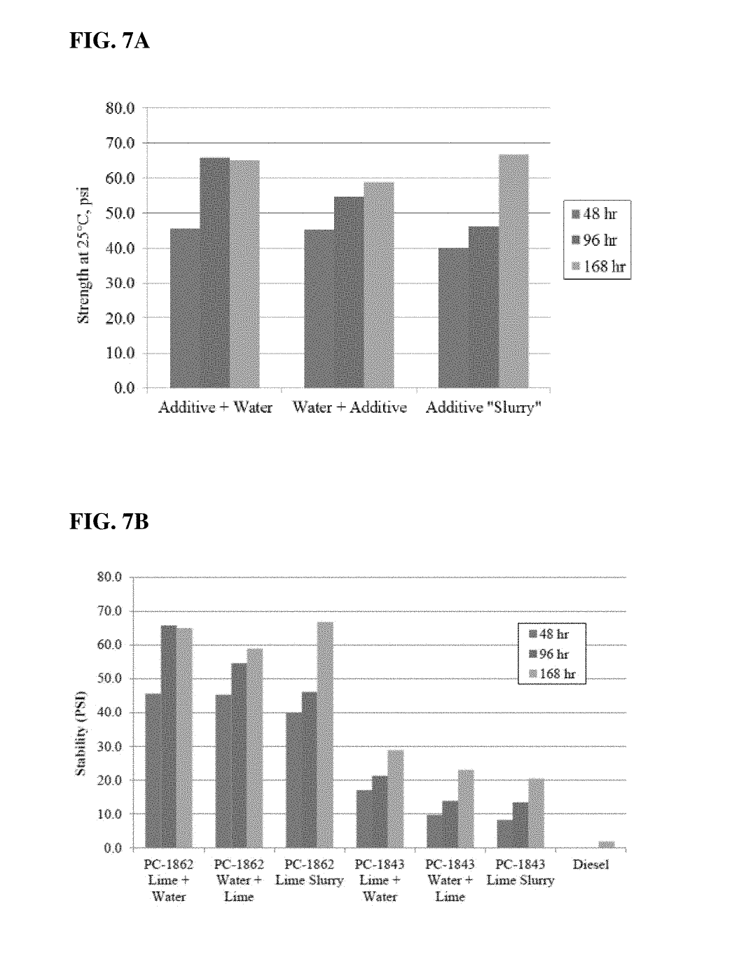

PG 67-22 bitumen was cut-back with the viscosity-reducing acid (a blend of carboxylic acids derived from distilled tall oil), and in a manner similar to the treatment discussed above in Example 4. FIG. 7A shows the results of strength development in this experiment. The Marshall stability was then measured as a function of time (FIG. 7B). FIG. 7B shows that the order of addition of the trigger and water does not materially affect the stability of the compacted asphalt mixtures.

Exemplary formulation of asphalt mix treated according to the present invention:

| | | Percent w/w |
|---|---|---|
| Material | Pounds | Aggregate |
| Aggregate | 1000 | 100 |
| PG 52-34 bitumen (est'd. softening pt. 39° C.) | 22.5-47.5 | 2.25-4.75 |
| Viscosity-modifying carboxylic acids or | 10-27.5 | 1.0-2.75 |
| derivatives | | |
| Quicklime | 0.46-10.5 | 0.046-1.05 |
| Water | 0.5-42 | 0.05-4.2 |

In experiments using our formulation we see increases in stability with time. This increase in stability is due to the reaction of the quicklime, water, and PC-1862 (a product name for a distilled tall oil fraction). PC-1843 is a blend of distilled tall oil and a tall oil ester. Some small increase after the initial tests at 48 hours also is due to water evaporation.

### Example 7

Since the softening point of a bitumen is a measure of its hardness, both PG 52-34 and PG 67-22 bitumen were lowered in viscosity by addition of varying levels of three types of carboxylic acid cutter followed by treatment with various types of acid-reactive metal salts. The three cutters were distilled tall oil fraction (DTO), a dimerized fatty acid (dimer), and a fumarated fatty acid (TKO). The table shows the results of modifying bitumen according to the disclosures of this invention. The experiments show that the technique disclosed herein can raise the softening point of the oxide-treated, viscosity-modified bitumen above the softening point of the starting bitumen (free of both acidic viscosity modifier and the reactive oxide. For example, experiment 1 shows the softening point of the PG 67-22 bitumen is 50.4° C. Upon treating the PG 67-22 with 30 or 35 wt % distilled tall oil, the softening point of the bitumen cannot be measured because it is too low. Upon reaction of the acid-treated PG 67-22 with CaO and water, the softening point of the resulting bituminous composition reaches from 60.9 to 61.4° C., over 10° C. above the neat bitumen. Table IV below shows the results.

### Example 8

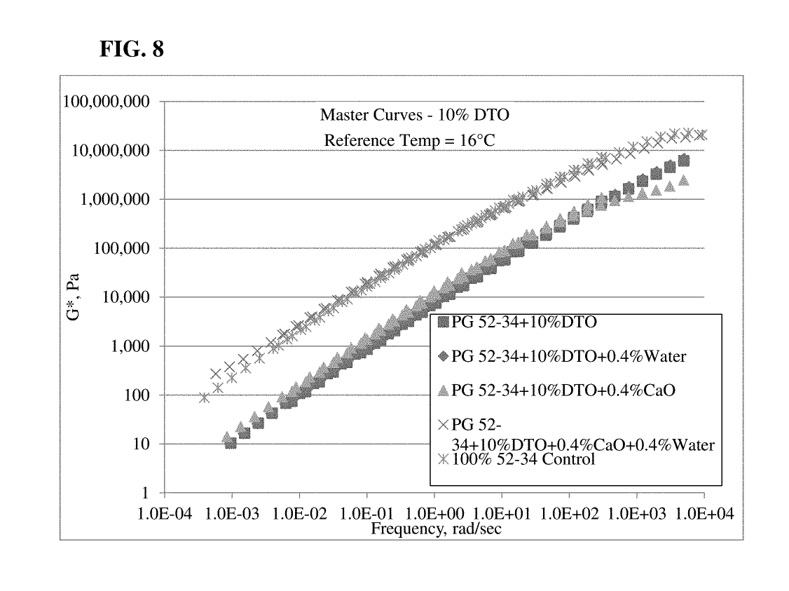

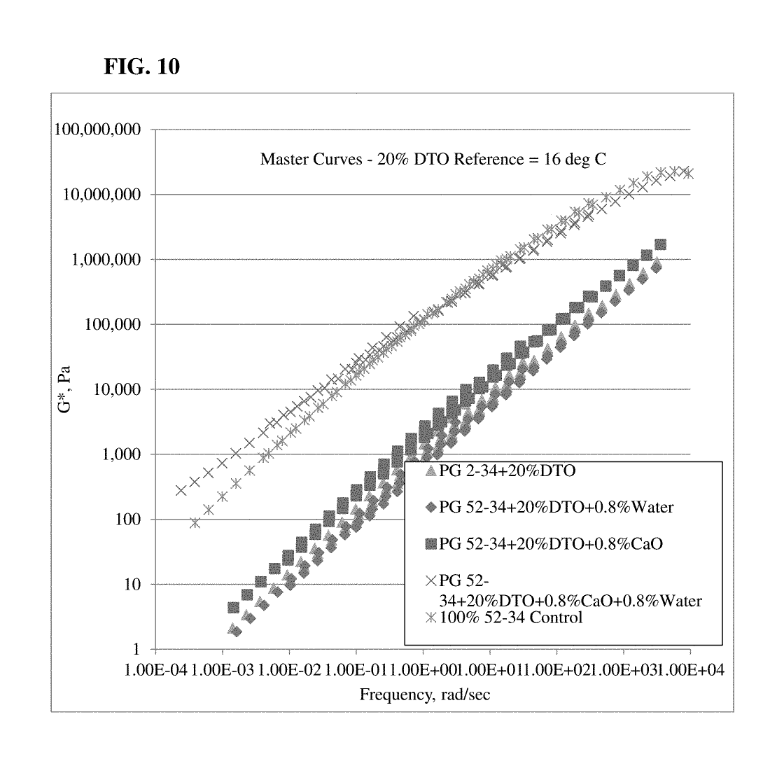

The complex modulus master curves were developed for samples of PG 52-34 bitumen treated with 10, 15, and 20% distilled tall oil fraction (DTO) followed by treatment with varying levels of CaO and water individually, and CaO and water together. The figures show clearly that addition of the DTO results in a reduction in the complex modulus master curve. FIGS. 8, 9, and 10 show that addition of either CaO by itself or water by itself has very little impact on the complex modulus master curve of the DTO-treated bitumen. However, surprisingly, the addition of both CaO and water increased the complex modulus master curves back to the same level as the starting bitumen (prior to addition of DTO).

### Example 9

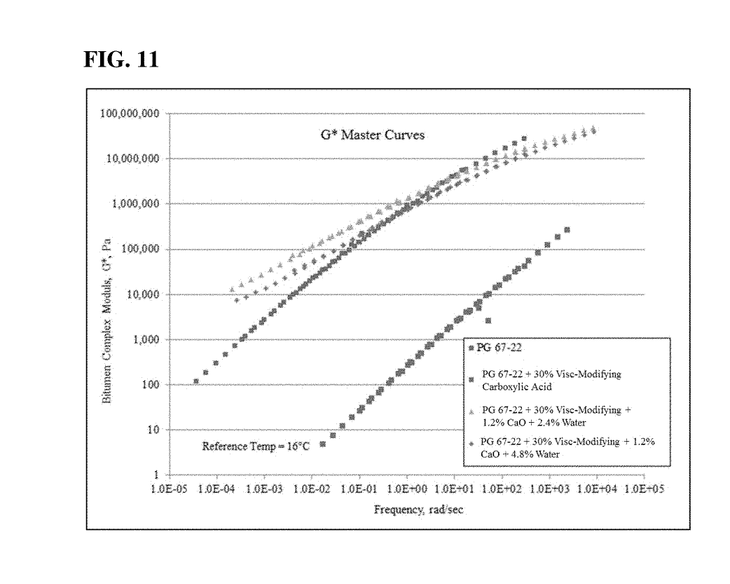

Following the experiment described in Example 3, a similar analysis was conducted using a PG 67-22 bitumen rather than the PG 52-34. FIG. 11 shows that a similar result is obtained.

### Example 10

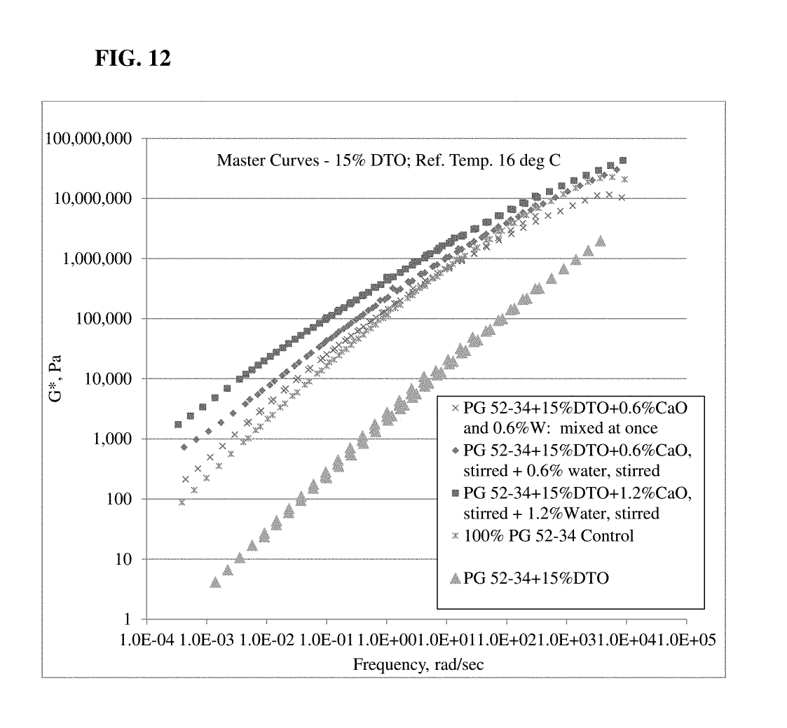

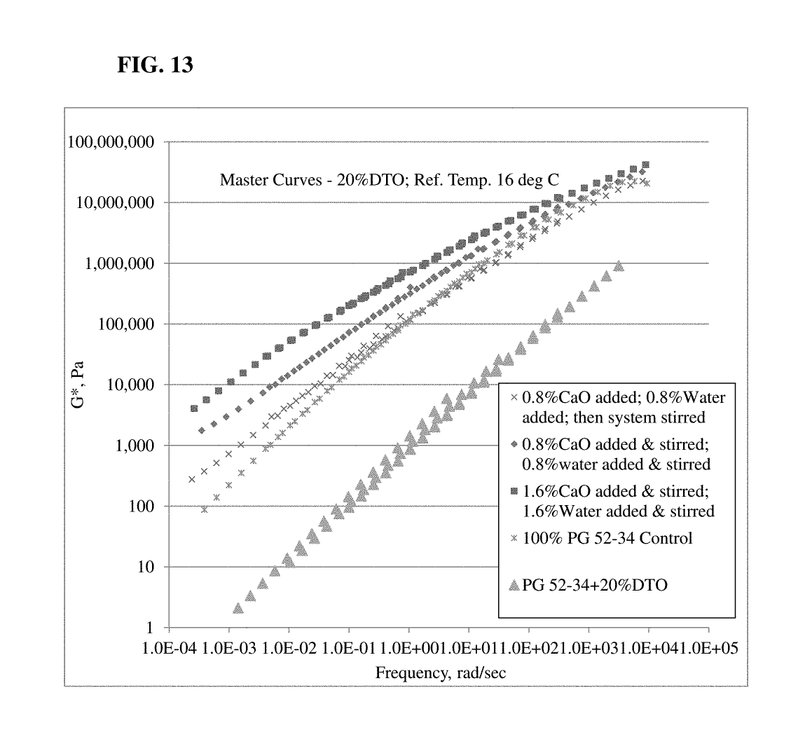

The order of addition of the acid-reactive metal salt and water is not of material import to to alter the rheological properties of the carboxylic acid-treated bitumen and restore the original rheological properties of the carboxylic acid-free bitumen. FIGS. 12 and 13 show two examples of this fact. PG 52-34 bitumen was treated with two levels of distilled tall oil fraction: 15% and 20% w/w PG 52-34 bitumen. The carboxylic acid-treated bitumen was then reacted in two different ways. In one of the two ways, the acid-reactive metal salt, in this example CaO, was added to the surface of the carboxylic acid-treated bitumen (at a temperature of 100-110° C.). Water was then added to the same surface of the carboxylic acid-treated bitumen (effectively on top of the CaO). Then this system was stirred by hand to disperse the CaO/water mixture and initiate the reaction with the carboxylic acid in the bitumen.

In the second of the two ways, the CaO was added to the surface of the carboxylic acid-treated bitumen (at a temperature of 100-110° C.). This was then stirred into the bitumen. Then water was added to the surface of the bitumen (which contained carboxylic acid and CaO); this was then stirred into bituminous milieu to alter the rheology. This same process was used for both the 15% and 20% carboxylic acid-treated PG 52-34.

FIG. 12 illustrates that the order of addition of the acid-reactive metal salt and water is not of material import to “trigger” the alteration in rheological properties of the carboxylic acid-treated bitumen and restore the original rheological properties of the carboxylic acid-free bitumen. PG 52-34 bitumen was treated with two levels of distilled tall oil fraction: 15% w/w PG 52-34 bitumen. The carboxylic acid-treated bitumen was then triggered in two different ways: 1) the acid-reactive metal salt, in this example CaO, was added to the surface of the carboxylic acid-treated bitumen (at a temperature of 100-110° C.); water was then added to the same surface of the carboxylic acid-treated bitumen (effectively on top of the CaO). Then this system was stirred by hand to disperse the CaO/water mixture to initiate the reaction with the carboxylic acid in the bitumen; 2) the CaO was added to the surface of the carboxylic acid-treated bitumen (at a temperature of 100-110° C.). This was then stirred into the bitumen. Then water was added to the surface of the bitumen (which contained carboxylic acid and CaO); this was then stirred into the bituminous milieu to alter the rheology of the final material.

FIG. 13 illustrates that the order of addition of the acid-reactive metal salt and water is not of material import to alter the rheological properties of the carboxylic acid-treated bitumen and restore the original rheological properties of the carboxylic acid-free bitumen. PG 52-34 bitumen was treated with two levels of distilled tall oil fraction: 20% w/w PG 52-34 bitumen. The carboxylic acid-treated bitumen was then reacted in two different ways: 1) the acid-reactive metal salt, in this example CaO, was added to the surface of the carboxylic acid-treated bitumen (at a temperature of 100-110° C.); water was then added to the same surface of the carboxylic acid-treated bitumen (effectively on top of the CaO). Then this system was stirred by hand to disperse the CaO/water mixture and to initiate the reaction with the carboxylic acid in the bitumen; 2) the CaO was added to the surface of the carboxylic acid-treated bitumen (at a temperature of 100-110° C.). This was then stirred into the bitumen. Then water was added to the surface of the bitumen (which contained carboxylic acid and CaO); this was then stirred into bituminous milieu to alter the rheology.

The results showed that the complex modulus master curves were not materially altered by the order of addition of the acid-reactive metal salt and water in the manner described in this experiment.

### Example 11

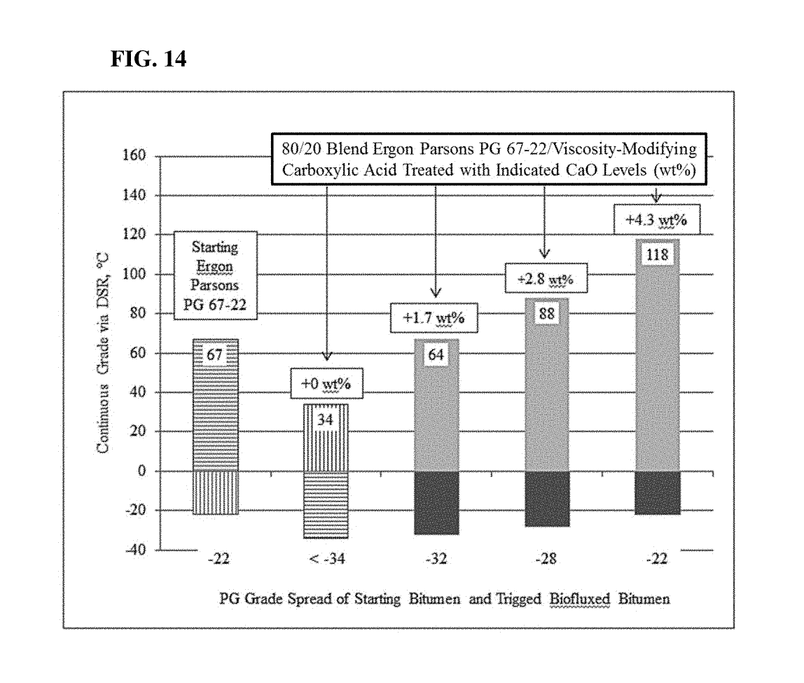

To demonstrate that bitumen technology described herein can be used as a cost-effective alternative to conventional bitumen grade modification techniques (such as PPA treatment or polymer modification), the following experiment was conducted (FIG. 14). 80 parts of a bitumen commonly available in the U.S.A. (described herein as Ergon's Parsons PG 67-22) was treated with 20 parts of a carboxylic acid of the present invention. The viscosity-modified bitumen was heated to between about 70 and 90° C. followed by treatment, with 0, 1.7, 2.8, and 4.3 wt % metal oxide (CaO). The metal oxide was stirred into the acid-treated, viscosity-modified bitumen by hand or with mixing equipment. An equivalent weight percentage of water was then mixed into the CaO-treated, carboxylic-acid modified bitumen for one minute. Then the resulting samples were placed in an oven for one hour at about 80 to 110° C. Using an Anton Paar Dynamic Shear Rheometer, the high and low critical PG grade temperatures of the bitumen samples were measured for the samples. These high and low critical temperatures are compared to those of the starting Ergon Parsons PG 67-22 bitumen. The unexpected effect of triggering treating the bitumen according to the teachings of this invention was to create a range of original (i.e., unaged by RTFO or PAV treatment) bitumen samples having very widely spread PG high and low critical temperatures. At 0% trigger, the PG grade was below the measurement capability (i.e., −34° C.) of the Cannon BBR unit used in these evaluations. At 1.7% CaO and water, the PG grade was PG 64-32. At 2.8% and 4.3% CaO/water, the PG grades were respectively PG 88-28 and PG 118-22 (see FIG. 14).

### Example 12

A bitumen commonly used in production of recycled asphalt mixtures in the state of New Mexico was used to study the technology disclosed herein. The original bitumen was PG 58-28 from Holly Frontier Refining. This PG 58-28 contained roughly 2% styrene-butadiene elastomeric polymer to modify it to a PG 64-28. The bitumen was treated with varying levels of a carboxylic acid mixture of monomeric, dimeric, and trimeric fatty acids and rosin acids)-along with a common bitumen extender called Hydrolene H90T. The viscosity-modifying carboxylic acid derivative is referred to by the Ingevity Corporation identifying code of PC-1862.

We doped this PG 58-28 with 2% SB polymer with four levels of H90T: 0, 1, 3, and 6% w/w polymer-modified binder. We also doped the H90T-treated, polymer-modified PG 58-28 with incremental levels of an Ingevity Corporation carboxylic acid derivative PC-1862. The PC-1862 levels were approximately 5 and 10% w/w of the polymer-modified PG 58-28. H90T and PC-1862 were added to the base polymer-modified PG 58-28 (heated to 150° C. in a sealed can) with stirring. After stirring in the appropriate levels of H90T and PC-1862, the treated bitumen samples were stored in a 150° C. oven for one hour prior to preparation for testing.

AASHTO T 313 “Determining the Flexural Creep Stiffness of Asphalt Binder Using the Bending Beam Rheometer (BBR)” was used to establish the temperatures at which the Creep Stiffnes, S, was equal to 300 MPa (43.5 psi) and at which the m-value was equal to 0.300. AASHTO PP 42 “Determination of Low-Temperature Performance Grade (PG) of Asphalt Binders” was used to determine the low-temperature grade of the binders in this study.

The binder formulations and results of property analyses of the binders before and after triggering are presented in Table V.

Analysis of the data shows many interesting and unexpected effects of the technology disclosed herein for altering bitumen rheology. First, the continuous high critical temperature at which the HFE300P residue has a G*/sin δ value equal to 1.0 kPa is 46.5° C. See the last row in Table II.

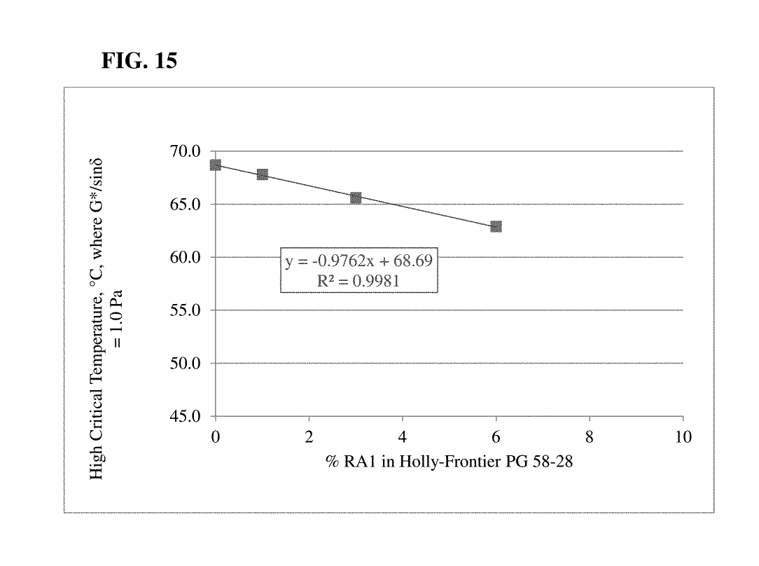

Second, a plot of the change in the high temperature continuous grade of the original bitumen samples shows a linear relationship with the dosage of H90T. FIG. 15 shows this result. Moreover, one can use the linear fit curve to estimate that 22.75% H90T would be required to yield a H90T-doped PG58-28 w/2% Stylink that has a critical high temperature grade of 46.5° C. (46.5=−0.9762*22.75+68.69).

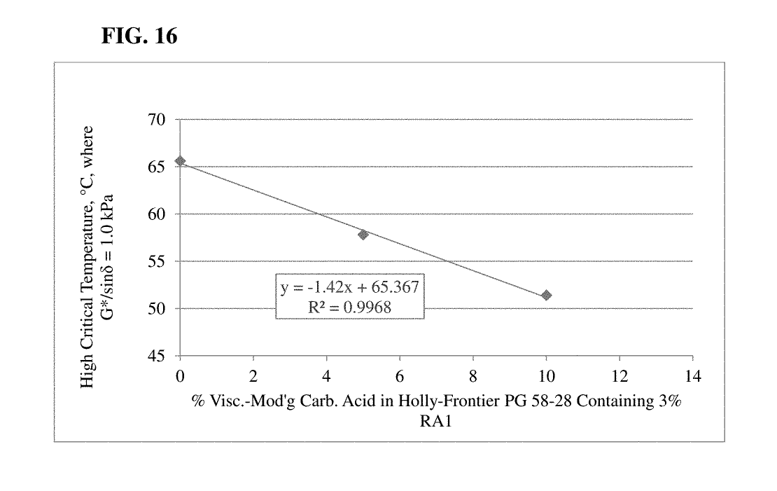

Third, a plot of the change in the high temperature continuous grade of the original PG 58-28 w/2% Stylink and 3% H90T shows a linear relationship with the % PC-1862 added. FIG. 16 shows this result. From analysis of the linear fit for the curve in FIG. 3, one can estimate that 13.5% PC-1862 must be added to the 3% H90T polymer modified PG 58-28 to lower high continuous temperature to 46.5° C.

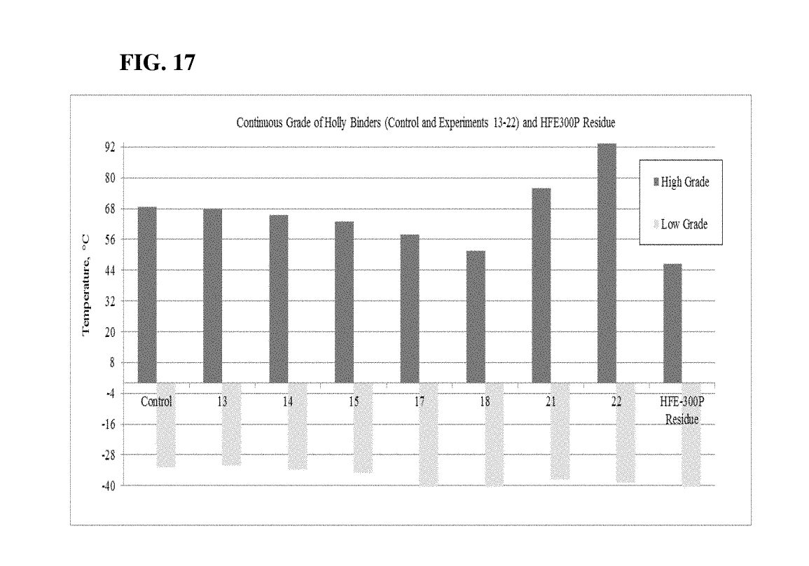

A graphic depiction of the novel effects of using the technology disclosed herein is given in FIG. 17.

Second, a plot of the change in the high temperature continuous grade of the original bitumen samples shows a linear relationship with the dosage of H90T. FIG. 15 shows this result. Moreover, one can use the linear fit curve to estimate that 22.75% H90T would be required to yield a H90T-doped PG58-28 w/2% Stylink that has a critical high temperature grade of 46.5° C. (46.5=−0.9762*22.75+68.69).

In the above work using the Holly Frontier PG 52-34 treated with varying levels of Hydrolene H90T and PC-1862 viscosity-modifying carboxylic acid derivative followed by reaction with the acid-reactive, metal salt, CaO, and the initiator, water, according to the technique of this invention, one can see the impact on other properties like cracking propensity, as measured by as measured by ΔT−critical=T_{S=300}−T_{m-value=0.3}.

Table V shows that the cracking propensity of all of the PG 58-28 treated binders was superior to that of the HFE300P residue. After PAV aging, the HFE300P residue had a T-critical value of −16.40. Whereas after PAV aging, all treated PG 58-28 samples exhibited T-critical values substantially less negative (i.e., more positive). When bitumen samples exhibit values of ΔT-critical that are less than around −4.0, it is considered more likely that they will undergo thermal cracking than bitumen samples that are more positive than −4.0. In other words, the more positive the ΔT-critical value, the more likely it is that that bitumen will resist cracking due to thermal stresses. The bitumen samples, treated according to the invention, exhibited ΔT-critical values more positive than that of HFE300P residue, which is the binder type used historically in New Mexico recycling applications.

Lastly, Table V shows that the technology disclosed in this invention significantly increased the stiffness of carboxylic acid-treated (viscosity-modified) PG 58-28 Containing 3% H90T. Experiments 21 and 22 in Table V show the results of reaction with CaO and water on the stiffness of the bitumen samples in Experiments 17 and 18 by treatment with 1.6% each of the triggering agent and water. The continuous high temperature grade changed from Experiment 18 (51.4° C.) to Experiment 22 (93.5° C.) by 42.1° C. as a result of triggering with 1.87% triggering agent. The low temperature continuous grade only rose by 7.4° C. (from −46.2 to −38.8° C.) as a result of triggering. Thus, the PG spread was increased, or in other words, the Useful Temperature Interval was expanded.

### Example 13

12.5-mm NMAS Nova Scotia granite was used for all of the mixtures described below in a study of the comparative behavior of mixtures treated according to this invention and a control, conventional hot mix asphalt. The dense-graded mixture had an optimum asphalt content of 4.6%, and used a performance-graded bitumen readily available in the U.S.A., Axeon PG 67-22. To prepare the acid-treated, viscosity-modified bitumen sample, 80 parts of the Axeon PG 67-22 was cut with 20 parts of PC-1862.

For the hot mix asphalt (HMA) mixture, the 12.5-mm NMAS Nova Scotia granite aggregate and PG 67-22 binder were both heated to 150° C. A small bucket mixer (components preheated to 150° C.) was used to make sufficient mixture for further molding and compaction into Hamburg test specimens. Mixing required about one minute in the bucket mixer. The loose HMA mixture was aged for two hours at 150° C. before being compacted to 62 mm.

The same aggregate and acid-treated, viscosity-modified binder were heated to 110° C. prior to mixing in the same bucket mixer. The mixing temperature ranged 95-100° C. during the roughly one minute of mixing. Even at this low temperature, there were no issues obtaining 100% (fully coated) aggregate in the mixture. These mixtures were conditioned for two hours at 100° C. before compacting to 62 mm height.

The mixtures treated according to this invention were prepared in the same manner as the above mixture. However, after the initial mixing to coat the aggregate surfaces with the acid-treated, viscosity-modified bitumen, 6.4% quicklime (CaO) w/w binder was added into the bucket and mixed for an additional minute. Next, 6.4% water w/w binder was added into the bucket and mixed for another minute. The temperature of the mix at this point was 85° C. There were no issues during the mixing process. The mixtures so produced were then conditioned for 15 minutes at 100° C. prior to compaction.

The three different compacted mixtures were evaluated according to standard practice on the Hamburg Loaded Wheel Tracking (HWT) device, following AASHTO T 324, “Hamburg Wheel-Track Testing of Compacted Hot Mix Asphalt.” This standardized test method requires immersion of test compacted specimens in a water bath of 50° C. while a steel wheel load of 150 pounds passes back and forth over the diametral planar surface of the specimens. The average air voids for each set are shown in Table VI. Although the air voids were slightly higher than desired, the samples were still tested since they were all comparable to each other.

TABLE VI

| | Average | |
|---|---|---|
| | Air Voids, | Standard |
| Mixture Type | % | Deviation |
| HMA | 8.1 | 0.2 |
| 80/20 Carboxylic Acid | 8.1 | 0.3 |
| 80/20 Carboxylic Acid + CaO | 8.5 | 0.1 |

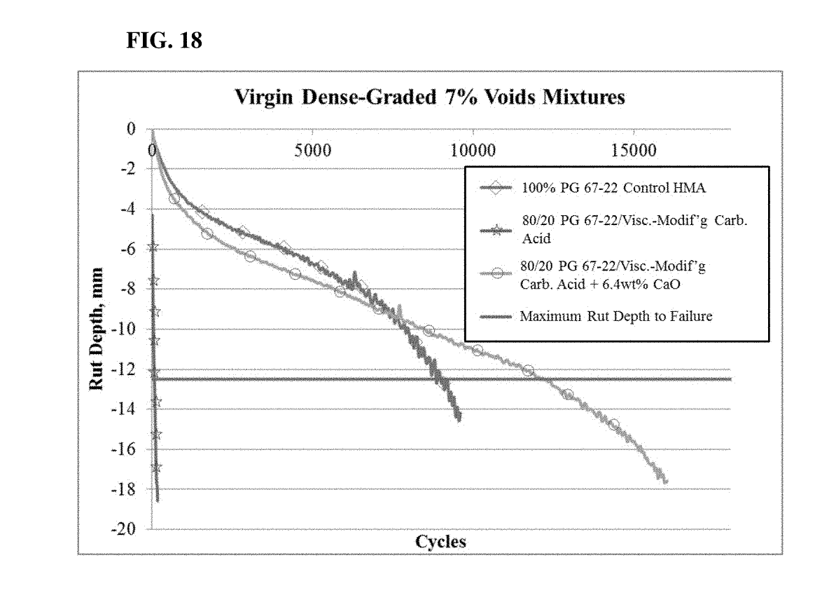

The Hamburg Loaded Wheel Tracking results are shown in the graph in FIG. 18. The compacted 80/20 “Carboxylic Acid” mixtures (red curve) failed immediately. These “80/20 Carboxylic Acid” mixtures were just too soft to withstand any kind of load. It is evident that once the technology of this disclosure was added, the mixture stiffened even more than the HMA control. The failure criterion for a PG 64-22 is 12.5 mm of rutting at 10,000 cycles. The HMA failed before it reached 10,000 cycles, whereas the “80/20 Carboxylic Acid+CaO” mixture went beyond 12,000 cycles.

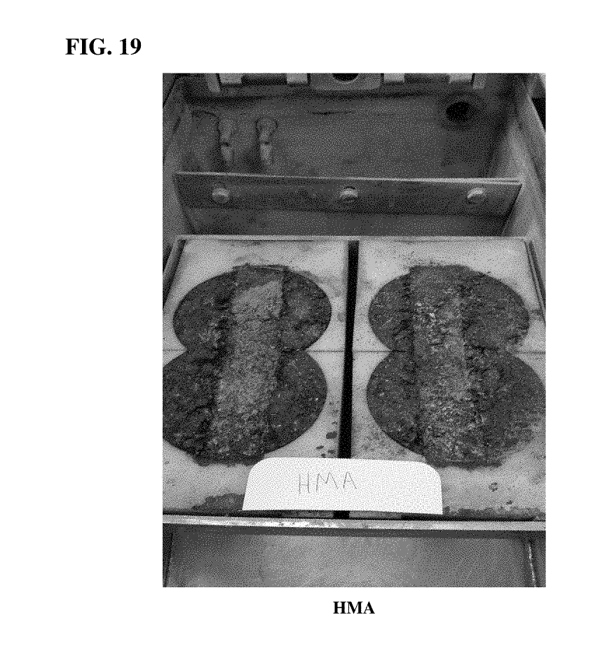

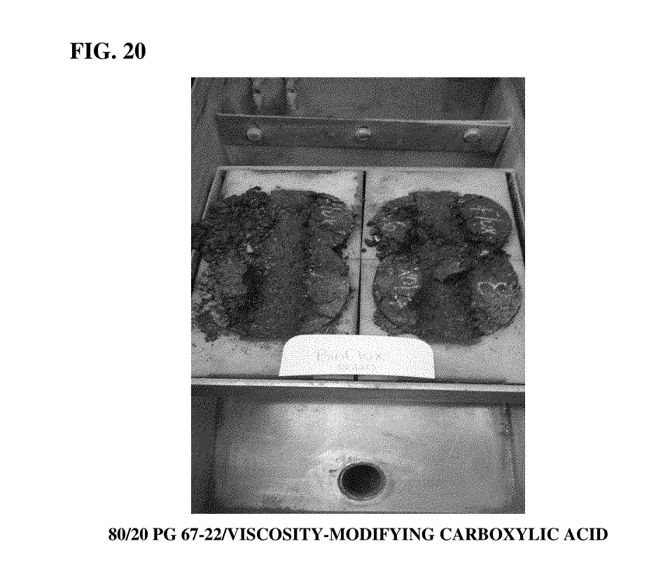

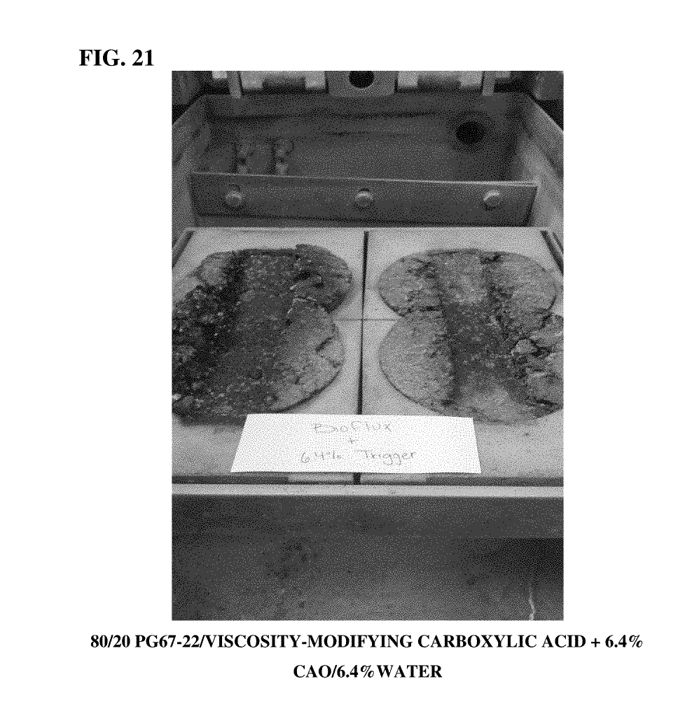

The difference in stripping inflection point (SIP) was also apparent between these mixtures. The SIP values are shown in Table VI. They are surprisingly high considering there was no adhesion promoter in these mixtures. You can visually see the stripping and rutting in the photos included in FIGS. 19-21.

TABLE VII

| | Stripping |
|---|---|
| | Inflection |
| | Point |
| Mix Type | (passes) |
| HMA | 7292 |
| Carboxylic Acid Viscosity Modifier Only | 0 |
| Carboxylic Acid Viscosity Modifier + CaO | 12,145 |

### Example 14

The technology disclosed herein can be used with bitumen emulsions. In the following example, a bitumen emulsion was treated with tall oil-based carboxylic acid derivative PC-1862 and then this carboxylic acid, viscosity-modified emulsion was used in the production of a dense-graded paving mixture based on Reclaimed Asphalt Pavement (RAP). This example is for a paving application wherein RAP was used rather than virgin aggregate, but these formulation ingredients are not meant to imply that the scope of this new technology is limited to RAP, to cationic emulsions like those described in this example, or to paving applications alone.

The formulations of the cationic emulsions utilized in this Experiment in recycling mixtures, treated according to the teachings of this invention, consisted of the an aqueous surfactant solution based on Ingevity Corporation's INDULIN™ W-5 at 1.0% active (w/w emulsion) and pH 2.0 and a PG 64-22 paving grade bitumen (from Ergon Inc.). Prior to milling, the Ergon PG 64-22 bitumen was diluted with an Ingevity carboxylic acid derivative, PC-1862; the ratio of bitumen-to-carboxylic acid derivative was 80:20. Standard lab emulsification formulation and process conditions were used. The temperature of the aqueous surfactant solution and the bitumen during milling were about 50° C. and 135° C., respectively. The laboratory colloid mill was a Charlotte G-5.

In these experiments, depending on the bitumen type, ratio of bitumen and carboxylic acid viscosity modifier, and metal oxide dosage, bitumen has been stiffened over two PG grades without significantly impacting the lower temperature grade.

RAP used in these mixtures had the gradation shown in Table VIII.

TABLE VIII

| Sieve Size | | Dry RAP |
|---|---|---|
| std. | metric | Gradations |
| 2″ | 50.0 | 100.0 |
| 1 ½″ | 37.5 | 100.0 |
| 1″ | 25.0 | 100.0 |
| ¾″ | 19.0 | 100.0 |
| ½″ | 12.5 | 90.0 |
| ⅜″ | 9.5 | 81.7 |
| #4 | 4.75 | 59.6 |
| #8 | 2.36 | 41.5 |
| #16 | 1.18 | 26.4 |
| #30 | 0.600 | 14.1 |
| #50 | 0.300 | 6.7 |
| #100 | 0.150 | 2.8 |
| #200 | 0.075 | 1.0 |
| −200 | −0.075 | |

The RAP used in this study contained about 10-20% bitumen-free stones. That is, a percentage of the RAP did not have a residual bitumen coating.

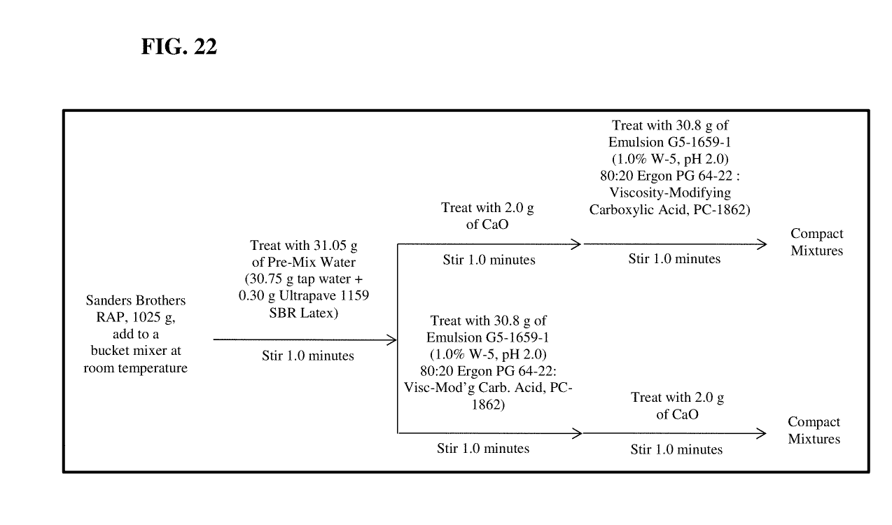

FIG. 22 shows the mixture preparation procedure used to manufacture the lab-made, lab-molded specimens discussed in this Example 14. FIG. 23 shows the Superpave gyratory compaction curves.

Marshall stability results point to the fact that the CCI reaction technology disclosed herein represents a viable approach to make high-strength emulsion-based 100% recycling mixtures. Table IX shows the average dry compressive strength (Marshall stability) of the carboxylic acid-treated emulsion mixture made with 1.0% Type I Portland cement (w/w RAP) was 1880 lb-f. By comparison, the average compressive strengths of the mixtures treated with the PC-1862 carboxylic acid viscosity modifier (Portland cement-free mixture) treated with 0.2% chemical CaO (w/w RAP) in two different addition sequences were 2010 to 2030 lb-f. The emulsion-based mixture, treated according to the teachings of this disclosure, developed higher strength than the mixture treated with 1.0% Type I Portland cement. Additionally, the average compressive strengths of the (0.2%) compacted specimens (prepared according to the invention) after saturating with water and conditioning at 60° C. for 24 hours, ranged from 1760 to 1765 lb-f. By contrast, the mixture containing 1.0% Type I Portland cement (w/w RAP) had an average water-conditioned strength of 1710 lb-f.

### Experiment 15

Table X shows a comparison of the effectiveness of different viscosity-modifying carboxylic acids when employed with the CCI reaction technique described in the present disclosure. Compared to DTO, which contains a mixture of tall oil fatty acids, rosin acids, dimer, trimer, and higher oligomer fatty acids, the Dimer TO alone gives a larger increase in bitumen Ring and Ball softening point at levels of CaO and water at 2.8 and 2.8 wt %, respectively. See Exp't Nos. 12 and 25 of Table X.

Also, Table X shows that the viscosity-modifying carboxylic acid derivative PC-1792, which is a fortified tall oil fatty acid, gave an even higher increase than the Dimer TO and the DTO. The softening point of the 35 wt % PC-1792-treated Axeon PG 67-22, reacted with 2.80 wt % each of CaO and water, was too stiff to pour into the softening point ring.

Table X also shows that MgO is an effective reactive metal salt for employment in the teachings of this invention to alter the rheological properties of carboxylic acid-treated bitumen. Aluminum oxide was not as effective reactive metal salt for the purposes of this invention.

Table XI shows similar results as those in Table X, but with Eurovia PG 52-54 bitumen.

TABLE XII demonstrated that the discovery disclosed herein is applicable to viscosity-modified carboxylic acid-treated bitumen in the presence of polyphosphoric acid (PPA), which is widely used in the bitumen industry as a bitumen modifier. That is, PPA does not increase stiffness beyond virgin bitumen (see Exp't Nos. 6 and 21) and PPA does not induce alteration of the rheology of carboxylic acid-treated bitumen without an acid-reactive metal salt and water (see Exp't Nos. 17 and 39). Furthermore, PPA did not affect the reaction of the carboxylic acid-treated bitumen. See Experiment Nos. 26, 37 and 40.

TABLE X

| | | | | | Acid/Reactive Metal Salt | | | | | | |
|---|---|---|---|---|---|---|---|---|---|---|---|
| | | | | | | % w/w | | Water | | Average | |
| | Axeon | Organic Acid | | | | Acid- | | % w/w | | Ring & Ball | |
| Exp't | PG 67-22 | Caboxylic | | mole | Metal | Modified | mole | Modified | mole | Softening | |
| No. | g | Acid | g | H⁺ | Salt | Bitumen | M²⁺ | Bitumen | water | Point, ° C. | Observation |
| 6 | 100 | none | 0 | 0.0000 | none | 0 | 0 | none | 0 | 50.4 | Virigin bitumen |
| 3 | 70 | DTO | 30 | 0.0840 | CaO | 1.20 | 0.0214 | 1.20 | 0.0666 | 61.4 | Modified bitumen is harder than |
| | | | | | | | | | | | virigin bitumen |
| 5 | 70 | DTO | 30 | 0.0840 | CaO | 1.20 | 0.0214 | 2.40 | 0.133 | 61.4 | Modified bitumen is harder than |
| | | | | | | | | | | | virigin bitumen |
| 4 | 70 | DTO | 30 | 0.0840 | CaO | 1.20 | 0.0214 | 4.80 | 0.266 | 54.8 | Water levels may be optimizable |
| 15 | 65 | DTO | 35 | 0.0980 | none | 0 | 0 | none | 0 | 32.1 | DTO lowers softening point below |
| | | | | | | | | | | | that of virigin bitumen |
| 12 | 65 | DTO | 35 | 0.0980 | CaO | 2.80 | 0.0499 | 2.80 | 0.155 | 60.9 | Higher Ring & Ball softening point |
| | | | | | | | | | | | than the virigin bitumen |
| 13 | 65 | DTO | 35 | 0.0980 | CaO | 4.20 | 0.0749 | 4.20 | 0.233 | 66.0 | Higher Ring & Ball softening point |
| | | | | | | | | | | | than the virigin bitumen |
| 11 | 65 | DTO | 35 | 0.0980 | MgO | 2.80 | 0.0695 | 2.80 | 0.155 | 42.6 | effect of MgO is less effective |
| | | | | | | | | | | | than CaO |
| 14 | 65 | DTO | 35 | 0.0980 | MgO | 4.20 | 0.104 | 4.20 | 0.233 | 49.1 | effect of MgO is less effective |
| | | | | | | | | | | | than CaO |
| 24 | 80 | DTO | 20 | 0.0560 | Al₂(OH)₃ | 2.4 | 0.0229 | none | 0 | not | Aluminum hydroxide does not |
| | | | | | | | | | | measurable | increase softening point to |
| | | | | | | | | | | | measurable level |
| 29 | 65 | DTO | 35 | 0.0980 | Al₂(OH)₃ | 2.4 | 0.0229 | 2.4 | 0.133 | not | Water does not initiate aluminum |
| | | | | | | | | | | measurable | hydroxide (as it does CaO) |
| 31 | 65 | DTO | 35 | 0.0980 | Al₂(OH)₃ | 4.8 | 0.0457 | 4.8 | 0.266 | 8.1 | Water does not initiate aluminum |
| | | | | | | | | | | | hydroxide (as it does CaO) |
| 19 | 65 | Dimer TO | 35 | 0.0620 | none | 0 | 0 | none | 0 | 23.4 | Dimer TO lowers softening point |
| | | | | | | | | | | | below that of virigin bitumen |
| 30 | 65 | Dimer TO | 35 | 0.0620 | CaO | 2.80 | 0.0499 | 0 | 0 | 25.8 | Without water, the CaO does not |
| | | | | | | | | | | | have the stiffening effect |
| 25 | 65 | Dimer TO | 35 | 0.0620 | CaO | 2.80 | 0.0499 | 2.80 | 0.155 | 77.2 | With water, the CaO stiffens the |
| | | | | | | | | | | | TO dimer-: bitumen |
| 20 | 65 | PC-1792 | 35 | 0.156 | none | 0 | 0 | none | 0 | not | PC-1792 TO softens virigin binder |
| | | | | | | | | | | measurable | too unmeasurable level |
| 32 | 65 | PC-1792 | 35 | 0.156 | CaO | 2.80 | 0.0499 | 0 | 0 | 8.6 | Without water, the CaO does not |
| | | | | | | | | | | | have the stiffening effect |
| 27 | 65 | PC-1792 | 35 | 0.156 | CaO | 2.80 | 0.0499 | 2.80 | 0.155 | too stiff | CaO + water stiffen the PC-1792 |
| | | | | | | | | | | to pour | TO bitumen to non-pourable level |

TABLE XI

| | | | | | Acid/Reactive Metal Salt | | | Water | | Average |
|---|---|---|---|---|---|---|---|---|---|---|
| | Eurovia | Organic Acid | | | | % w/w | | % w/w | | Ring & Ball |
| Exp't | PG 52-34 | Caboxylic | | mole | Metal | Acid-Modified | mole | Modified | mole | Softening |
| No. | g | Acid | g | H⁺ | Salt | Bitumen | M²⁺ | Bitumen | water | Point, ° C. |
| 16 | 100 | none | 0 | 0 | none | 0 | 0 | none | 0 | 37.7 |
| 7 | 85 | DTO | 15 | 0.0420 | CaO | 1.2 | 0.0214 | 1.2 | 0.067 | 50.1 |
| 8 | 80 | DTO | 20 | 0.0560 | CaO | 1.2 | 0.0214 | 1.2 | 0.067 | 54.4 |
| 41 | 80 | PC-1792 | 20 | 0.0891 | CaO | 2.13 | 0.0380 | 2.13 | 0.118 | 41.4 |
| 43 | 80 | PC-1792 | 20 | 0.0891 | CaO | 1.07 | 0.0191 | 2.13 | 0.118 | 26.1 |
| 44 | 80 | PC-1792 | 20 | 0.0891 | CaO | 0.53 | 0.0094 | 2.13 | 0.118 | 22.3 |
| 46 | 80 | PC-1792 | 20 | 0.0891 | CaO | 0.53 | 0.0094 | 0.53 | 0.029 | 23.3 |
| 45 | 80 | PC-1792 | 20 | 0.0891 | CaO | 1.07 | 0.0191 | 1.07 | 0.059 | 28.4 |
| 42 | 80 | PC-1792 | 20 | 0.0891 | MgO | 2.70 | 0.0670 | 2.7 | 0.150 | 45.2 |
| 1 | 85 | PC-1843 | 15 | 0.0210 | CaO | 0.6 | 0.0107 | 0.6 | 0.033 | not measurable |
| 2 | 85 | PC-1843 | 15 | 0.0210 | CaO | 0.6 | 0.0107 | 2.4 | 0.133 | 27.3 |
| 9 | 85 | PC-1843 | 15 | 0.0210 | CaO | 1.2 | 0.0214 | 1.2 | 0.067 | 24.1 |
| 10 | 85 | PC-1843 | 15 | 0.0210 | CaO | 1.2 | 0.0214 | 2.4 | 0.133 | 26.2 |

TABLE XII

| | | | | | | Acid/Reactive Metal Salt | | | | | | |
|---|---|---|---|---|---|---|---|---|---|---|---|---|
| | | | | | | | % w/w | | Water | | PPA | Average |
| | | | Organic Acid | | | | Acid- | | % w/w | | % w/w | Ring & Ball |
| Exp't | Bitumen | | Caboxylic | | mole | Metal | Modified | mole | Modified | mole | Bioefluted | Softening |
| No. | Type | g | Acid | g | H⁺ | Salt | Bitumen | M²⁺ | Bitumen | water | Bitumen | Point, ° C. |
| 6 | Axeon PG 67-22 | 100 | none | 0 | 0.0000 | none | 0 | 0 | none | 0 | 0 | 50.4 |
| 21 | Axeon PG 67-22 | 100 | none | 0 | 0.0000 | none | 0 | 0 | none | 0 | 0.50 | 50.3 |
| 37 | Axeon PG 67-22 | 80 | DTO | 20 | 0.0560 | CaO | 2.80 | 0.0499 | 2.80 | 0.155 | 0.50 | 61.3 |
| 17 | Axeon PG 67-22 | 65 | DTO | 35 | 0.0980 | none | 0 | 0 | none | 0 | 0.50 | not |
| | | | | | | | | | | | | measurable |
| 26 | Axeon PG 67-22 | 65 | DTO | 35 | 0.0980 | CaO | 2.80 | 0.0499 | 2.80 | 0.155 | 0.50 | 64.9 |
| 39 | PG 64-34 | 80 | DTO | 20 | 0.0560 | none | 0 | 0 | none | 0 | 0.5 | not |
| | | | | | | | | | | | | measurable |
| 33 | PG 64-34 | 80 | DTO | 20 | 0.0560 | CaO | 2.80 | 0.0499 | 2.80 | 0.155 | 0 | 63.5 |
| 40 | PG 64-34 | 80 | DTO | 20 | 0.0560 | CaO | 2.80 | 0.0499 | 2.80 | 0.155 | 0.5 | 62.1 |

### Example 16

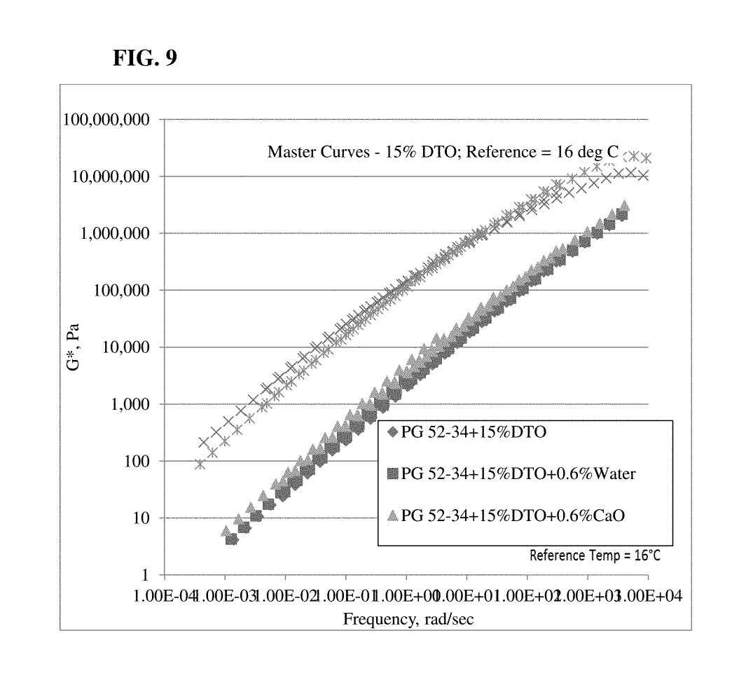

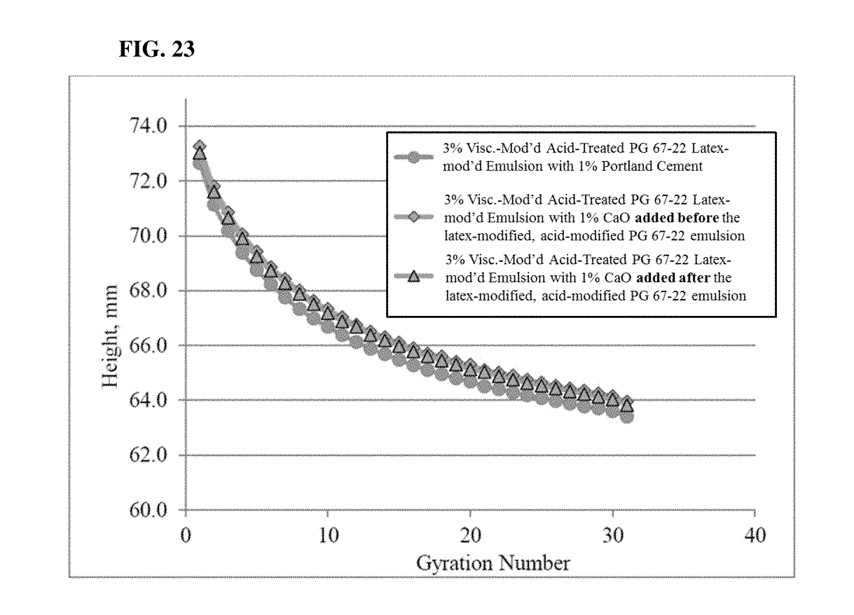

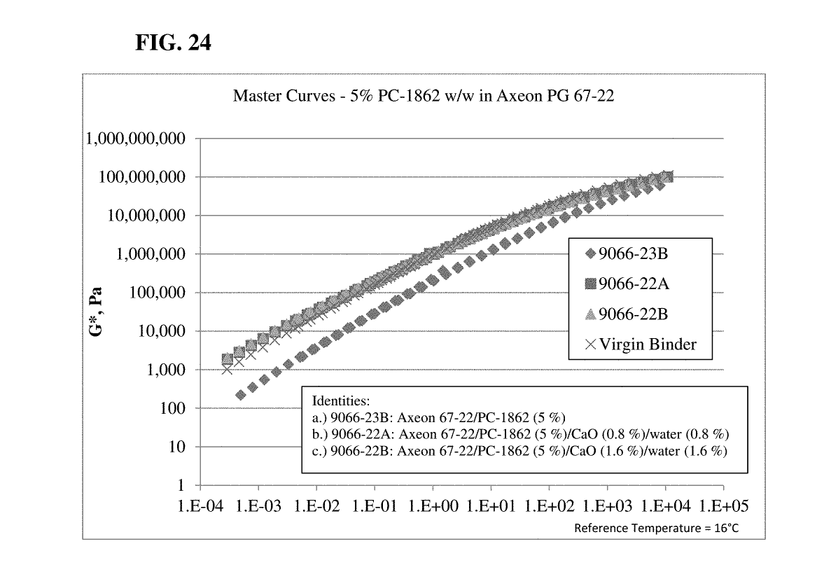

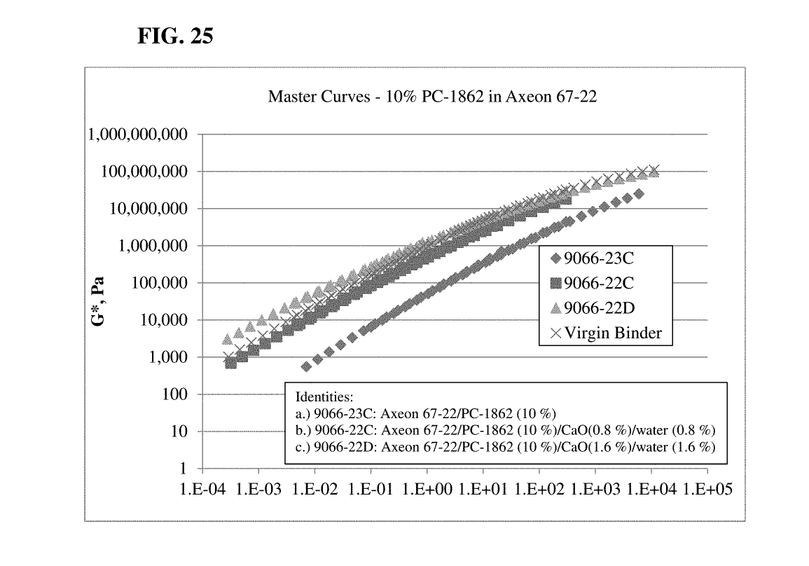

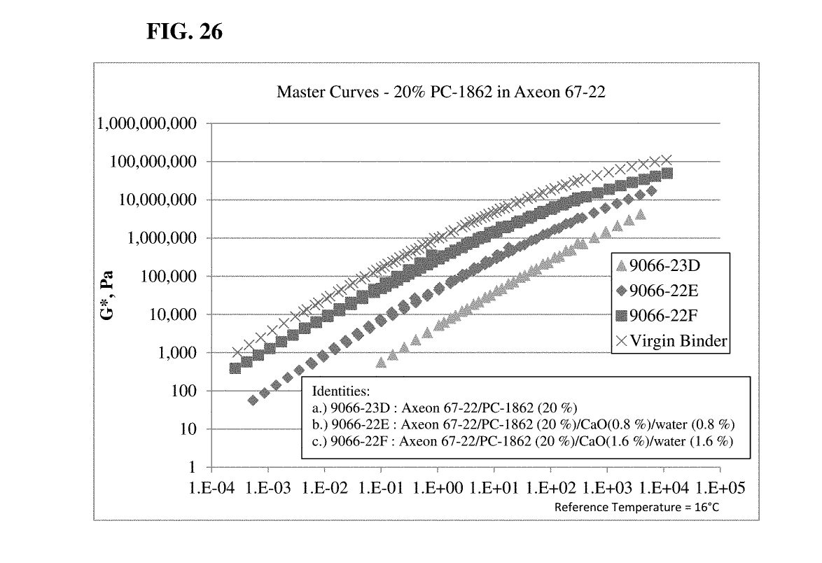

In a manner very similar to the results shown in Example 7, FIGS. 9-13, the technique disclosed herein is demonstrated with a different bitumen. FIGS. 24-26 illustrate how the master curves (graphs of the complex modulus, G*, versus frequency at a fixed temperature) reveal that the carboxylic acid viscosity modifier substantially softens the bitumen and the treatment with CaO and water technique restores the bitumen to its original moduli.

FIGS. 24-26 again summarize key feature of the technique disclosed in this application and the resulting benefits, described in the background, which one can envision as a result of being able to precisely control (i.e., reduce) bitumen viscosity (for complete easily, at low temperature/low energy, some transport, spreading, mixing, spraying, hand-working, and compacting activity common to the wide variety of production and construction applications existing currently in the bitumen-related industries) and then restore the viscosity to a higher level with an economical and sustainable methodology like the technique disclosed herein.

### Example 17

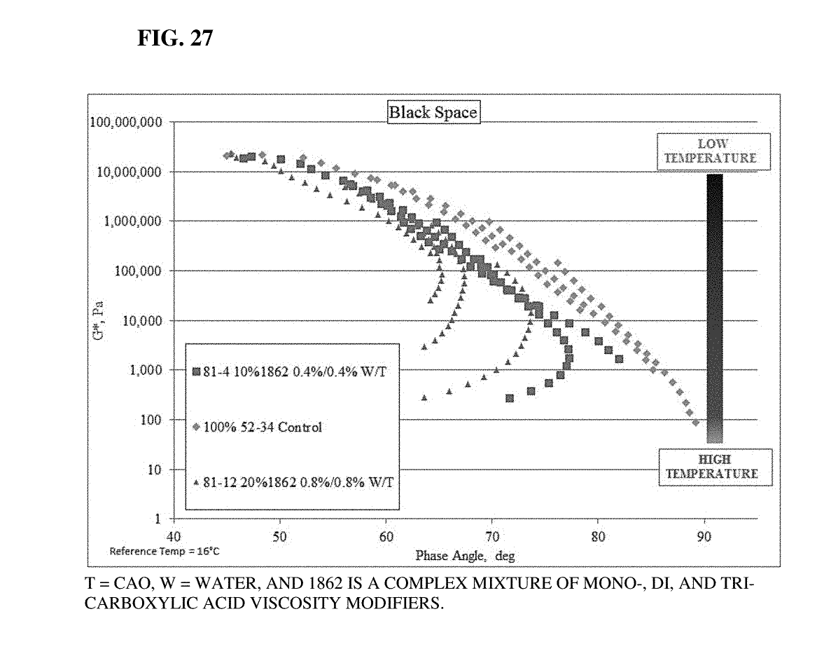

In this example, a black space plot (FIG. 27) of three bitumen samples is shown wherein the change in complex moduli, G*, over the range of 1 to 10⁷ Pa, is plotted as a function of the phase angle, δ. Among other things, black space plots show the degree of elastic behavior in a sample for a fixed complex modulus, G*. Elastic behavior is reflected in the phase angle: the lower the phase angle, the more elastic character a material has. Conversely, the higher the phase angle, the more viscous character a material has. A phase angle of 0° indicates a purely elastic material. Conversely, a phase angle of 90° indicates a purely viscous material.

In this example, one of the black space curves is derived from measurement of δ and G* for a control bitumen. This control bitumen is untreated, unmodified PG 52-34 bitumen, a common paving grade bitumen, especially in northern climes. In the graph, the blue diamonds are the data for δ and G* samples for this control, unmodified, PG 52-34 bitumen.

Another curve, shown in FIG. 27 is derived from measurement of G* and δ for a sample of the same control bitumen, which has been diluted homogeneously with 10% (w/w bitumen) of a viscosity-modifying carboxylic acid followed by treatment under agitation with 0.4% CaO and 0.4% water (each w/w of bitumen). In the graph of FIG. 27, the data for δ and G* of this sample are noted by the red squares.

A third curve in FIG. 27 is derived from measurement of G* and δ for a sample of the same control bitumen, which has been diluted homogeneously with 20% (w/w bitumen) the viscosity-modifying carboxylic acid followed by treatment under agitation with 0.8% CaO and 0.8% water (each w/w of bitumen). In the graph of FIG. 27, the data for δ and G* of this sample are noted by the purple triangles.

If one examines the plots of each sample, one can see that, with increasing levels of carboxylic acid and with increasing trigger levels of CaO, the treated bitumen samples become increasingly elastic in behavior. For example, if one looks at a fixed G* of 1000 Pa, one can see that the phase angle, δ, of the control bitumen is about 85°. At the same G* of 1000 Pa, the phase angle of the carboxylic acid-treated bitumen treated with 0.4% each of CaO and water, has dropped to about 78°. This indicates that at this complex modulus value, 1000 Pa, the carboxylic acid-treated binder is not more elastic as one skilled in the art would expect to occur from dilution with a very fluid material like the carboxylic acid used in this example. Rather, by treating with the 0.4% CaO and 0.4% water, the bitumen adopts a more elastic character at this modulus level of 1000 Pa. In hot climate conditions, a pavement made with the 10% (w/w control bitumen) viscosity-modifying carboxylic acid and treated with 0.4% CaO and 0.4% water (w/w control bitumen), is less likely to form wheel ruts on a road.

It is also noteworthy that, at high G* values, the phase angle of the 10% carboxylic acid-treated, CaO/water-treated bitumen (red squares) is the same as the control PG 52-28 bitumen. Thus, at very low temperatures, the 10% carboxylic-acid-treated, CaO/water-treated bitumen will show at least the same thermal cracking resistance as the control PG 52-28 bitumen. (We showed in other Examples in this disclosure, that ΔT_{critical} values indicate the carboxylic acid-treated, CaO-treated, water-initiated bitumen actually will show better long-term crack resistance. ΔT_{critical} values were not measured on the samples in this Example.)

A similar, but more pronounced effect is observed in FIG. 27 for the bitumen diluted with 20% carboxylic acid (by weight of the bitumen) and subsequently treated with 0.8% CaO and 0.8% water (both by weight of the bitumen).

This Example shows another wholly unexpected benefit of the technology disclosed herein. The treatment yields a bitumen with characteristics of bitumen modified with elastomeric polymers, like SB, SBS, and many others.

### Example 18

FIG. 28 illustrates how a mineral aggregate material, in this case reclaimed asphalt pavement (RAP), is coated with an aqueous emulsion comprising 60% of a complex mixture of saturated and unsaturated carboxylic acids as the dispersed phase. As such, the technology disclosed herein may also be used to effectuate stiffening of aggregate mixtures without first blending together bitumen and the carboxylic acid or carboxylic acid derivative or combination thereof.

As an example, 1000 grams of recycled asphalt pavement RAP) were treated by hand mixing in a bucket mixer with 3.1% (w/w RAP) of an emulsion of a carboxylic acid blend comprising tall oil fatty acids, tall oil dimer acids, tall oil trimer acids, and rosin acids. The content of the carboxylic acid mixture was 64.7% w/w of the total emulsion. The dispersed phase carboxylic acid blend was stabilized by use of 1.0 wt % INDULIN W-5 emulsifier w/w total emulsion.

The RAP thusly coated was treated with mixing to an effective amount of CaO and water (0.314% CaO w/w RAP), followed by compaction using 30 gyrations on a Superpave Gyratory Compactor. The compacted specimen was allowed to stand at room temperature for two days followed by conditioning in a 40° C. forced draft oven for 2.0 hours and then tested for compressive strength (also known as Marshall stability). The compressive strength of the compacted, cured, and conditioned specimen was 4600 lb-f (or 292 psi based on 4600 lb divided by the surface area (15.75 square inches) of the specimen). This example shows that the technology may be used without first dissolving the carboxylic acid component in bitumen, but rather, merely using them directly. See FIG. 28.

### Example 19

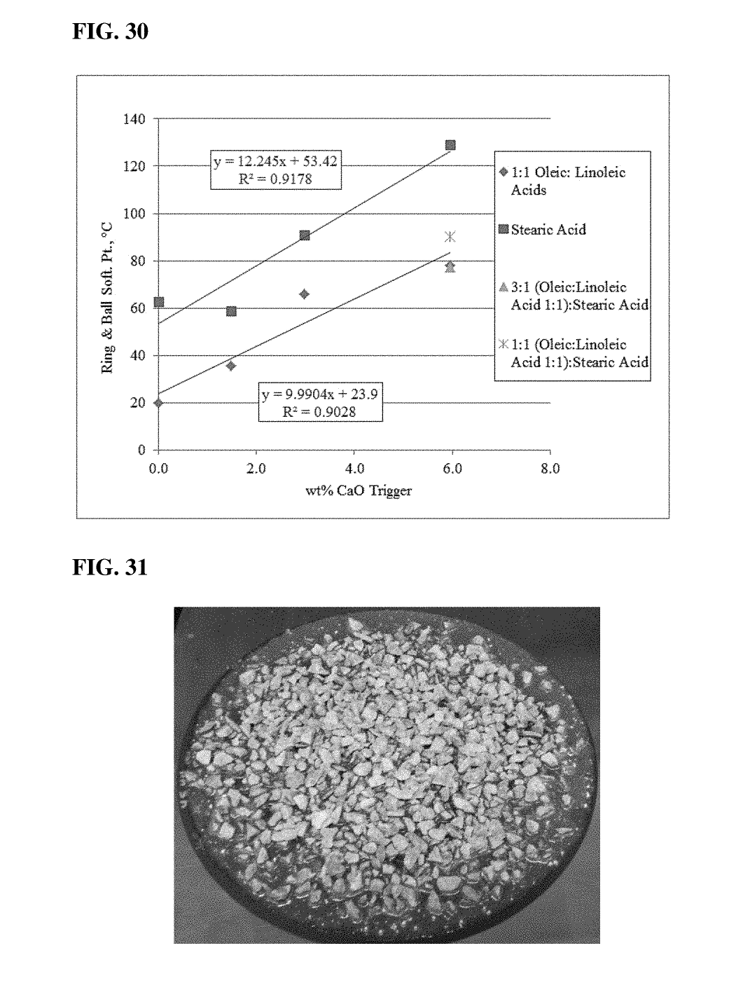

Another unexpected feature of this technology relates to the modification and manipulation of the bitumen rheology as manifested in measurements such as the complex modulus master curves, PG grades, and softening points. With an effective choice of two or more carboxylic fatty acid derivatives, the technology disclosed herein allows the end user to lower the stiffness of a treated bitumen (manifest, for example, by a decrease in the low-temperature PG grade and softening point of the bitumen). Then, with application of the disclosed reaction involving addition of a reactive metal salt, like CaO and others, the bitumen stiffness can be increased to levels exceeding that of the starting bitumen, which contained no fatty acids and had not been treated with the acid-reactive metal salt chemicals. In this example, a PG 64-22 bitumen sample with roughly 30 wt % of a roughly 1:1 blend of oleic acid and linoleic acids in one case and 30 wt % of a stearic acid in another. The 1:1 blend of oleic acid and linoleic acid reduce the bitumen softening point to such a low level that it exceeds the detection capabilities of a Herzog HRB 754 automated ring & ball softening point apparatus. The softening point of the 30 wt % stearic acid-treated bitumen is 62.6° C. Upon mixing 130 g bitumen (treated with 30 wt % of the 1:1 oleic acid:linoleic acid blend and heated to 70° C.) with 7.75 g water followed by 1.49 g CaO (about 0.32 molar equivalents per carboxylic acid group), followed in turn by equilibrating the resulting bitumen in a 70° C. for one hour to pour softening point rings, the softening point increased to 35.7° C. Upon mixing 130 g bitumen (treated with 30 wt % of the 1:1 oleic acid:linoleic acid blend and heated to 70° C.) with 7.75 g of water followed by 2.98 g CaO (about 0.63 molar equivalents per carboxylic acid group) and oven 70° C. oven equilibration for one hour to pour softening point rings, the softening point increased to 66.1° C. Addition of 7.75 g of water followed by 5.96 g CaO (about 25% molar excess per carboxylic acid group) increased the softening point to 78.0° C. Upon mixing 130 g bitumen (treated with 30 wt % stearic acid and heated to 90° C.) with the same ratios of water and quicklime, the softening points increased but to a greater extent. FIG. 29 shows the results. When blends of the same bitumen (a western US PG 58-28) were made using 3:1 and 1:1 w/w blends of the 1:1 oleic acid: linoleic acid w/w blend and stearic acid and treated as above, the softening effect of the resulting blend-treated bitumen samples were very low and non-measurable on the automated Herzog softening point instrument, but estimated by the operator to be very close to lab temperature (about 19-20° C.). But, upon reaction, the increased stiffening effect of the stearic acid salts became more pronounced, because of the presence of the harder starting carboxylic acid, stearic acid. Other high-softening point fatty acids such as, but not limited to, rosin acids dimerized rosin acids, fortified rosin acids, and rosin acid derivatives, fortified rosin esters (as the adduct described in U.S. Pat. No. 5,021,538 by Crews, E.), fortified C5 resins, fortified limonene, dicyclopentadiene, and other hydrocarbon resins, acrylic resins, styrene-acrylic polymers, and styrene-maleic polymers, have the same effect. Similar effects were seen when triggering bitumen cut with a number of other fatty acids blends such as, but not limited to, blends comprising tall oil fatty acid and rosin acid and blends comprising tall oil fatty acid and dimerized fatty acids. The triggered bitumen blend with a 3:1 ratio had a softening point of 77.4° C. This is estimated to be at least a 57° C. increase above the un-triggered bitumen, which was too soft to prepare for the ring and ball test. (Sample of the untreated bitumen in the test rings could not be lifted without sagging at room temperature). The bitumen, treated according to the disclosure herein, with a 1:1 ratio had a softening point of 90.3° C., up from the softening point of 33° C. for the starting, unmodified bitumen. The blending of the unsaturated C-18 fatty acids with the saturated, stearic acid resulted in a fluid bitumen sample, which could be altered via the technique of this invention to a softening point above that of the unsaturated C-18 fatty acid-doped bitumen alone, but below the very high softening point of the stearic acid-treated bitumen. FIG. 29 also shows in tabular format the results for softening points of these bitumen blends of 3:1 and 1:1 oleic acid/linoleic acid (1:1): stearic acid materials. An additional benefit of the inclusion of stearic acid in the compositions of this disclosure is the known lubricating effect of calcium stearates as lubricants in industry such as, but not limited to, the food, papermaking, and wax production (crayon) industries. FIG. 30 shows the results in graphical format.

### Example 20

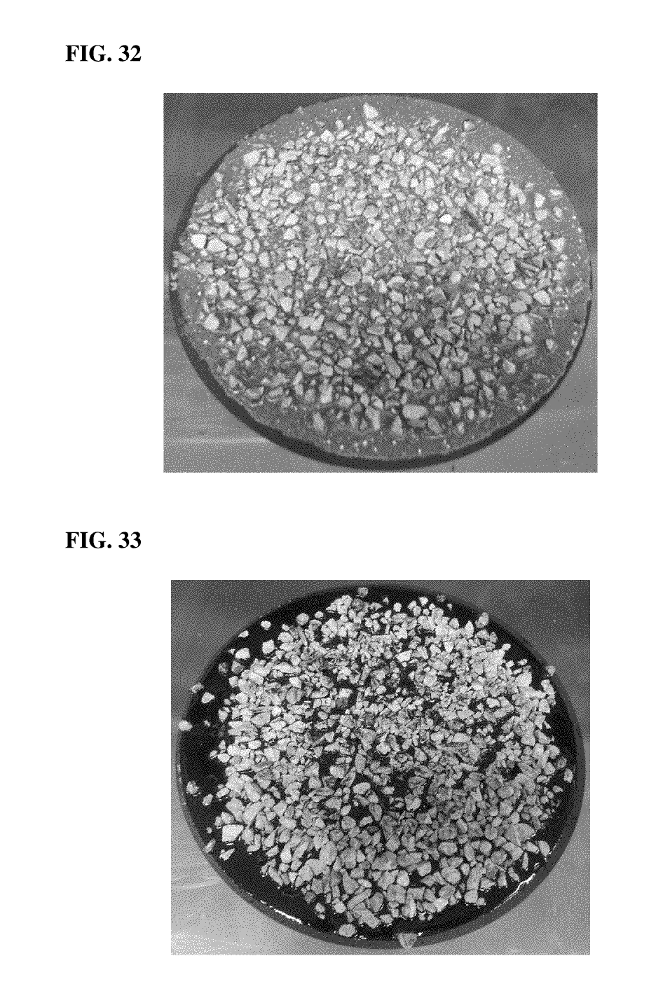

According to the teachings of this inventions, fatty acids and fatty acid mixtures mixtures such as, but not limited to, C10-C30 fatty acids from natural and synthetic sources, dimer-, trimer-, and higher order polymerized carboxylic acids, tall oil pitch, rosin acids, fortified fatty acids (i.e., reacted with conjugated carboxylic acid derivatives like acrylic acid, maleic anhydride, and fumaric acid, to name a few ene-ophiles and diene-ophiles used to fortify fatty acids via ene and Diels Alder reactions), synthetic polymeric carboxylic acids species (like acrylic acid polymers, polyacrylates, and styrene acrylic polymers and their derivatives to name a few), and combinations thereof may be used, with or without first blending into a hydrocarbon like bitumen, waxes, petroleum distillates, natural and synthetic esters, phenolic resins, ink oils to produce a water-impermeabilizing, adhesive paving, roofing, or underlayment composition by reacting with (a) a water and (b) a reactive metal salt (in any order of (a) and (b) or adding a slurry of (a) and (b) or by just adding (b) and using in situ generated water from a zeolite, hydrate, or dehydration reaction), wherein the metal salt comprises materials such as, but not limited to, calcium oxide, magnesium oxide, and zinc oxide. 175 grams of a blend of fatty acids, rosin acids, dimer fatty acids, and trimer fatty acids was treated with 30 grams of water followed by stirring by hand for 1 minute at room temperature. The resulting substance was colorized by adding 0.30 grams of a Green organic dye. The resulting colorized substance was treated with 17.5 grams of calcium oxide following by hand mixing with a spatula. After five minutes hand stirring, the temperature of the mixture had increased to about 50° C. The mixture was cast into a sweep test mold used in to test the aggregate retention of chip seals as described in ASTM D7000 Sweep Test. Aggregate was placed on the cast film of reacted, dyed, carboxylic acid mixture, again as prescribed by ASTM D7000. FIG. 31 shows the finished specimen prior to testing for aggregate retention. Sweep test results showed very good chip retention, with a sweep number of 11.6%. FIG. 32 shows the specimen after the sweep test was conducted. The sweep test results could be improved even further than 11.6% with adjustment of the formulation conditions (fatty acid composition and quantity, water content, and reactive metal oxide type and quantity).

### Example 21

As noted in Example 20, the technology taught in this invention may be used for producing water-impermeable, adhesive films (for use in paving, roofing, underlayment, and other adhesive/binding applications) with carboxylic acids alone or carboxylic acid compositions dispersed in an organic medium like bitumen and the resulting dispersion may be used neat of in the form of an emulsion. 60 grams of a blend of fatty acid blend comprising palmitic, stearic, oleic, and linoleic acids with about 1% rosin acids were dispersed in 200 grams of a PG 58-28 bitumen. The resulting bituminous mixture was a fluid, low-viscosity liquid at room temperature. The fluid, low-viscosity liquid bituminous mixture was treated with roughly 9 grams of CaO followed by hand stirring for one minute. The resulting CaO-treated, fluid, low-viscosity liquid bituminous mixture was treated with roughly 9 grams of water with stirring at room temperature for one minute. The resulting mixture was cast as a film following the method prescribed in ASTM D7000 Sweep Test for chip seals. Chips were applied and the resulting lab-made chip seal sample was tested according to ASTM D7000 Sweep Test. The sweep test result was 16%, a passing performance measure. FIG. 33 shows the specimen after completing the sweep test.

### Example 22

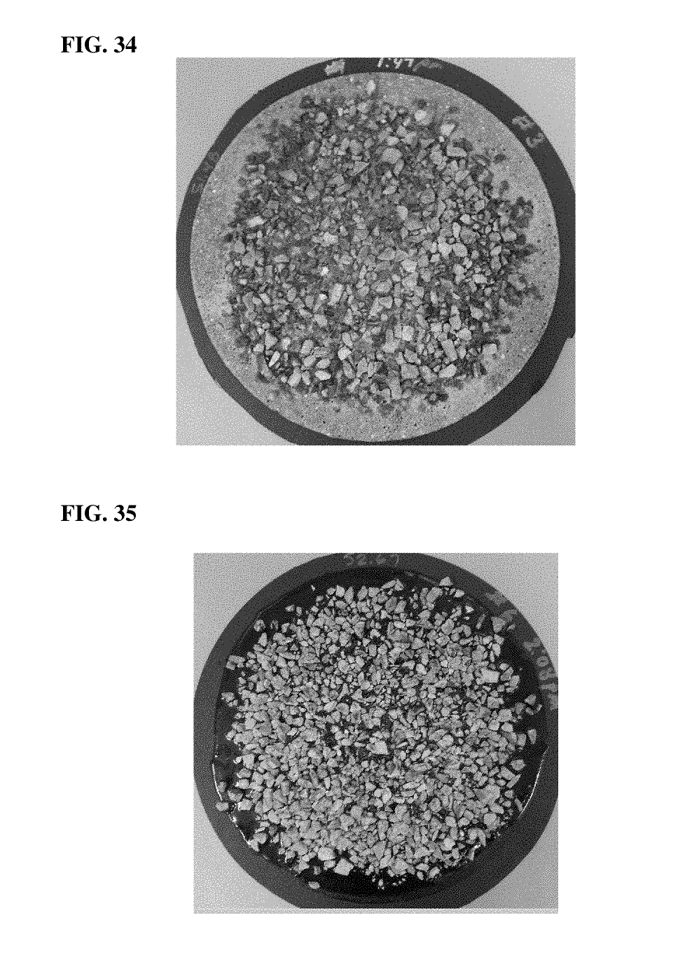

Another chip seal was made following Example 20. In this case, however, the binder comprised 175 grams of a blend of fatty acids, rosin acids, dimer fatty acids, and trimer fatty acids, 21.35 grams of a radial SBS polymer (LCY 3144), and 41.4 g of an SBS dispersant (tall oil morpholine amide, see “COMPOSITE POLYMER MATERIALS FOR MODIFICATION OF ADHESIVE COMPOSITIONS AND ASSOCIATED METHODS OF MANUFACTURE,” U.S. provisional application Ser. No. 62/012,973 filed on Jun. 17, 2014) which was treated with 30 grams of water followed by stirring by hand for 1 minute at room temperature and then treated with 27.5 grams of CaO followed by hand stirring for about 5-6 minutes, at which time the binder was cast for production of a sweep test specimen following ASTM D7000. The triggered, bitumen-free binder containing 9% w/w total binder gave a sweep result of 6.0% (well below the specification of 20% maximum loss). FIG. 34 shows the chip seal specimen after sweep testing.

### Example 23

Following the chip seal evaluation of Example 22, a similar chip seal was prepared in this example, according to the teachings of this disclosure, except that the binder was bitumen-based. 140 g of PG 58-28 bitumen were treated 35 grams of a blend comprising tall oil fatty acids, rosin acids, and dimer and trimer fatty acids followed by treatment with 21.35 grams of a radial styrene-butadiene-styrene (SBS) polymer (LCY 3144), and 41.4 g of an SBS dispersant, tall oil morpholine amide. This bitumen was treated with approximately 5.5 g of CaO and 7.0 g of water. After stirring for approximately 5 minutes, the chip seal sweep test specimen was prepared. The sweep test was conducted according to ASTM D7000. The chip loss was 8.0%. FIG. 35 shows the specimen after conducting the sweep test.

### Example 24

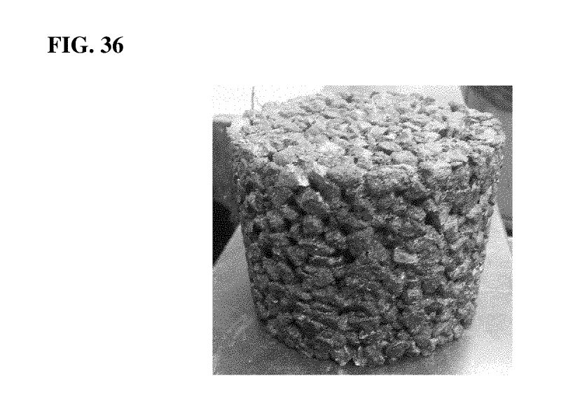

Open-graded friction courses can also be prepared using technology disclosed in this invention. Following a method similar to that used in Examples 20 and 21, 175 grams of a carboxylic acid blend comprising 175 grams of a blend of fatty acids, rosin acids, dimer fatty acids, and trimer fatty acids was treated with 30 grams of water followed by stirring by hand for 1 minute at room temperature. To this material was added at room temperature 0.3 g of iron oxide pigment followed by stirring for 1 minute at room temperature. To this red-colored material was added at room temperature with stirring 17.5 g of calcium oxide. The metal-treated material was stirred constantly by hand for 7 minutes. This material was added to a bucket mixer containing 1000 grams of 4.75-mm single-size reclaimed asphalt pavement (RAP), which had been pre-treated with 1.5 wt % water. The resulting mixture was stirred for one minute and then added to the mold of a Superpave gyratory compactor and compacted at room temperature for 30 gyrations. The resulting, reddish-colored, open-graded RAP mixture was removed from the mold and allowed to stand at room temperature for approximately 60 hours. The specimen was then heated for 2 hours in a forced draft oven at 40° C. After thermal equilibration to 40° C., the Marshall stability of the compacted mixture was measured. The resulting compressive strength was 71.4 psi (1320 lb-force/specimen surface area=71.4 psi). As one skilled in the art knows, this is a high strength value for an open-graded recycling mixture; in many state agency specifications for dense-graded recycled mixtures, the minimum lb-force is 1250. Further, one skilled in the art knows bitumen-based open-graded recycled mixtures (free of pozzolanic materials like Portland cement) are lower in Marshall stability than a dense-graded bitumen-based recycled mixture because there is more stone-on-stone contact in a dense-graded mixture, the fact of which increases the cohesion of the dense-graded mixture compared to the open-graded mixture, which has less stone-on-stone contact. FIG. 36 shows the compacted specimen prior to measurement of its compressive strength.

### Example 25

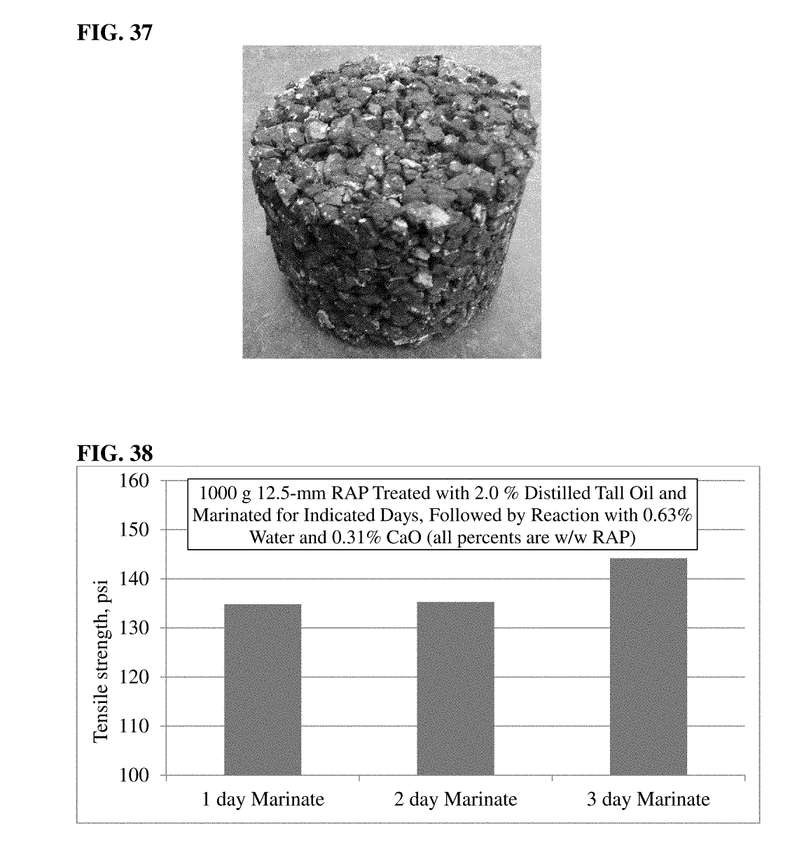

Following the method used in Example 23, using the same open-graded RAP aggregate, a mixture, prepared according to the teachings of this disclosure, was made using titanium dioxide dispersed in the binder composition. The binder composition of this example was made in the following way. To 1000 grams of room-temperature, 4.75-mm, single-sized, open-graded RAP were added in a bucket at room temperature mixer 15 grams of pre-mix water followed by one minute of mixing. To the wet RAP were added with continued agitation in the bucket mixer 40 grams of a binder comprising 20 grams of a blend of oleic acid, linoleic acid, dimerized fatty acids, trimerized fatty acids, and rosin acids and 20 grams of a TiO₂ dispersion in an acrylic resin/silicone polymer blend. TiO₂ is used in solid matrices to remove NOₓ and other pollutants from the air. To aid dispersion of the white pigment, the so-comprised TiO₂-containing binder was stirred by hand at room temperature for 5 minutes prior to addition to the bucket mixer. After bucket-mixing the thusly-treated RAP for one minute at room temperature, the triggered mixture was compacted in a Pine gyratory compactor with 30 gyrations at room temperature. The resulting compacted mixture was removed from the compaction mold and stored overnight. The compacted mixture was then equilibrated at 40° C. for two hours in a forced draft oven. The Marshall stability was then measured. The compressive strength was 82.6 psi (1490 lb-force). FIG. 37 shows the compacted specimen containing TiO₂ after measuring the Marshall stability.

### Example 26

A desirable processing step in certain applications is the ability to treat a material in multiple steps. In example 18, the 12.5-mm dense-grade RAP was treated in consecutive steps with the carboxylic acid-based binder (bitumen-free) in the form of an emulsion followed by triggering with a combination of calcium oxide and water. The possibility of sequential treatment using the technology described herein is demonstrated in this example. 1000 g of the same RAP was treated with 2.0 wt % of the binder, which comprised the same carboxylic acid compositions as the binder in example 18, but it was not emulsified in this example. The resulting mix was set aside for 24, 48, and 72 hours on the benchtop at ambient conditions. Storage of aggregate materials like RAP after treatment in a stockpile is a desirable process step for some manufacturers of paving mixtures for reasons that are well known to those skilled in the art. Stockpile storage of treated aggregate materials is called “marination” in the paving industry. After 24 hours, the thusly-treated, “marinated” RAP was then reacted with CaO and water initiator to stiffen by mixing with it in a bucket mixer at ambient temperatures 0.314 wt % CaO and 0.63 wt % water. The mixing time in the bucket mixer was 1 minute. The resulting mixture was compacted at room temperature in a gyratory compactor at 30 gyrations. The compacted mixture was immediately placed in a forced-draft oven for 2 hours at 40° C. After equilibrating to the 40° C. test temperature, the Marshall stability of the compacted specimen was tested. FIG. 38 shows the compressive strengths (in psi values) for the specimens treated in the above fashion and allowed to marinate. The strengths values are far above the specification minima (1250 lb-f) for RAP mixtures that is common in many transportation authorities in the United States and overseas.

### Example 27

Other examples can show the effects on the rheology of a PG 52-28 bitumen treated with the technology disclosed herein. The table of Example 27 shows that that the acid reactive metal salt alone does not change the properties of a control PG 52-28 bitumen. Experiments 4, 5, and 9 are noteworthy. Addition of 10 wt % Ingevity carboxylic acid viscosity modifier drops the PG grade of the treated bitumen to a PG 40-34. But, addition of the coupler followed by initiation of the reaction leads to a rebound in the PG grade to a PG 58-34. A similar effect is seen in Experiment 7. Upon treatment of the carboxylic acid-treated bitumen with 2.4 wt % CaO (Experiment 9), the final PG grade after initiation of the CCI Reaction was PG 59.8-36.1. In summary, Experiments 5, 9, and 7, show the PG 52-28 neat bitumen was converted to a PG 58-34, with the Useful Temperature Interval (UTI) increasing from 85.6° C. (Control) to 94.6, 95.1, and 95.9° C., respectively, for Experiments 5, 9, and 7. Noteworthy also is the fact that these rheological changes were achieved under low-temperature conditions with only hand stifling.

| PG 52-28 Exp't No. | 1 | 8 | 3 | 4 | 5 | 9 | 7 |
|---|---|---|---|---|---|---|---|
| Ingevity Carboxylic | 0 | 0 | 5 | 10 | 10 | 10 | 15 |
| Acid, wt % | | | | | | | |
| CaO, wt % | 0 | 2.4 | 0.8 | 0 | 1.6 | 2.4 | 2.4 |
| High Failure Temp., | 54.0 | 54.1 | 54.4 | 42 | 58 | 58.8 | 59.8 |
| ° C. | | | | | | | |
| High Temp Phase | 88.4 | 87 | 85.4 | 88.7 | 84.7 | 82.8 | 82.5 |
| Angle, ° | | | | | | | |
| Intermed. Temp. | 14.1 | 14.3 | 12.4 | 5.2 | 11 | 10.4 | 9.5 |
| Grade, ° C. | | | | | | | |
| T_{S} = 300, ° C. | −31.6 | −31.6 | −34.1 | −33.4 | −36.7 | −36.3 | −42.1 |
| Tₘ = 0.300, ° C. | −33 | −32.2 | −34.7 | −35.1 | −36.6 | −36.8 | −36.1 |
| ΔT-critical, ° C. | 1.4 | 0.6 | 0.6 | 1.7 | −0.1 | 0.5 | −6 |
| Low Failure Temp., | −31.6 | −31.6 | −34.1 | −39.4 | −36.6 | −36.3 | −36.1 |
| ° C. | | | | | | | |
| PG Grades (without | 52-28 | 52-28 | 52-34 | 40-34 | 58-34 | 58-34 | 58-34 |
| RTFO) | | | | | | | |
| UTI | 85.6 | 85.7 | 88.5 | 81.4 | 94.6 | 95.1 | 95.9 |

### Example 28

Other examples exist show the effect of applying the technology disclosed herein on the reliable and predictable alteration of the PG spread (UTI) of a bitumen. In the first table of Example 28, the formulation of the carboxylic acid viscosity modifier and the acid reactive metal salt are shown. The equation following the table is the linear regression algorithm which links the formulation ingredients with the high PG failure temperature. The table also shows how the UTI of bitumen modified according to the disclosure herein can be increased. See, for example, Experiment 7 in the table. The high PG failure temperature is 90.97° C. In the table of Example 29, one can see that the low PG failure temperature of the bitumen treated according to the teachings of this invention is −28.3° C. The UTI of the starting bitumen was 68.8+25.5=94.3° C. The UTI of the bitumen modified according to this invention (in Experiment 7) is 90.97+28.3=119.27° C.

### Example 29

The same system discussed in Example 28 was evaluated for low PG failure temperature in Example 29. Again, the formulation of acid-based viscosity modifies and acid-reactive metal oxide correlate with high precision to the final low PG failure temperature of the bitumen treated according to the technology disclosed herein. Additionally, the predictive equation derived from the linear regression analysis of the data shown follows the table for Example 29.

### Example 30

Compacted dense-graded aggregate paving mixtures were made using the formulations discussed in Examples 28 and 29. These dense-graded paving mixtures were subjected to deformation testing using the Hamburg Loaded Wheel Tracker (HLWT). The number of cycles in the HLWT to reach a rut depth of 6 mm correlated precisely with the formulation of acid-based viscosity modifier and acid-reactive metal oxide. The table shows the HLWT results. The Equation following the table is the predictive linear regression algorithm correlating the formulation ingredients and the cycles to 6-mm rut depth.

| | | | | HWI Cycles |
|---|---|---|---|---|
| Exp't | Ingevity Cutter | | Coupler | to 6 mm |
| No. | #1, wt % | #2, wt % | wt % | Rut Depth |
| 14 | 4.43 | 0.65 | 2.44 | 1600 |
| 2 | 4.43 | 0.65 | 3.65 | 4560 |
| 9 | 4.43 | 0.65 | 3.65 | 4560 |
| 5 | 9.46 | 1.39 | 5.18 | 11580 |
| 11 | 9.46 | 1.39 | 5.18 | 11580 |
| 10 | 9.46 | 1.39 | 7.79 | 12990 |
| 16 | 3.85 | 0.81 | 2.44 | 4965 |
| 18 | 3.85 | 0.81 | 2.44 | 4965 |
| 8 | 3.85 | 0.81 | 3.65 | 10740 |
| 7 | 8.22 | 1.73 | 7.79 | 18220 |
| 3 | 3.27 | 0.96 | 2.44 | 3780 |
| 15 | 3.27 | 0.96 | 3.65 | 5070 |
| 4 | 6.98 | 2.05 | 7.79 | 16380 |
| 17 | 6.98 | 2.05 | 7.79 | 16380 |
| Control | 0 | 0 | 0 | 13200 |

HLWT Cycles to 6 mm Rut Depth = −2909.9 + 130.81 * wt % Ingevity Acid Modifier 1 + 4278.7 * wt % Ingevity Acid Modifier 2 + 1331.06 * wt % CaO

### Example 31

Resins can also be modified using the teachings of this invention. 50 grams of a rosin-phenolic resin, Jonrez RP-315 was treated with 50 grams of a blend of 98% carboxylic acid and 2% ethyl hexyl phosphate ester. The phosphate ester is a blend of mono-, bis-, and tris-esters. As such it is an acidic phosphate ester. The 50:50 blend was treated with two molar equivalents of CaO and 0.8 weight percent water at 90° C. Upon hand stirring, an exothermic reaction ensued within one minute. The softening point of the 50:50 blend of rosin-phenolic resin treated with a combined carboxylic acid/acid phosphate ester viscosity-modifying agent and reacted with CaO was too high to melt at 150° C. The softening point of the untreated 50:50 blend was 52° C.

### Example 32

A blend of 25 parts Dynasol 1205 and 75 parts of 98% tall oil carboxylic acid derivative and 2% ethyl hexyl phosphate acid ester was fluid at room temperature. Upon treatment of 100 g of the 25:75 blend with two molar equivalents of CaO and 1.0 g of water to initiate the reaction described herein, the resulting polymer composite had a softening point exceeding 150° C.

### Example 33

The chemical methodology disclosed in this invention can be used to improve the the deformation-resistance properties of polymer-modified bitumen. A PG 67-22 bitumen was treated with varying levels of Dynasol 1205, a linear SBS tri-block polymer, a blend of viscosity-modifying carboxylic acids and acidic phosphate esters, and calcium oxide. The formulations of six compositions comprising these formulation ingredients are shown in the table. Amounts of the formulation ingredients are reported in the table in percentages by weight of the bitumen. The samples were heated to 120° C. at which point glycerol was added in a catalytic amount equal to the percent of CaO multiplied by 0.16. The temperature was increased to 150° C. where the samples were held with stirring at 300 rpm for 1.0 hours. The control sample, Experiment Number 1, was not treated with either the acid viscosity modifier package or with the coupling agent, CaO. The results in the table show the Jnr values (the non-recoverable creep compliance) of the samples, treated according to the technique disclosed herein, were improved compared to the control (Exp't No. 1). The lower the Jnr at an applied stress of 3.2 kPa, the more resiliently a bitumen will behave. That is, when stressed, it will recover the bulk of the strain will be recovered. Thus also, the measured percent recovery values (at 3.2 kPa) are higher for the samples which were treated according to the technique of this invention. The % Recovery at 3.2 kPa for the control (Exp't 1 was only 9.6%), indicating that 90.4% of the strain applied to the specimen was not recovered. The percent recovery for samples in Experiments 2-6 all surpassed that of the control sample. Additionally, range out of specification for samples 2-6 was less than that of the control, with the sample in Experiment 4 being a mere 2.5% points out of specification for a Jnr value of 0.117.

### Example 34

The chemical methodology disclosed herein also is useful in rubber-modified bitumen materials. Composites were made in the laboratory comprising three components: Viscosity-Modifying Carboxylic Acid (VMCA), #40-mesh Ground Tire Rubber, and a linear or radial SBS polymer. The lab-made composites were produced using a high shear, lab-scale mixing apparatus. All composites were added to bitumen and stirred at 300 rpm under nitrogen at 150° C. for 1.0 hours. In Experiment Number 1, no initiator was added, neither water nor glycerol. In Experiment Number 2, water was added dropwise into the vortex of the stirred polymer- and rubber-modified bituminous composition. The amount of water initiator was equal to 0.3 times the mass of CaO metal oxide. In Experiment Number 3, glycerol was added dropwise into the vortex of the stirred polymer- and rubber-modified bituminous composition. The amount of glycerol initiator was equal to 0.16 times the mass of the CaO metal oxide. After 1.0 hours at 150° C., the samples were evaluated for modulus using a Dynamic Shear Rheometer. As the table shows the use of the water initiator and the glycerol initiator were superior to the use of no initiator, in that the high PG failure temperatures (temperatures where G*/sin δ=1.0 kPa) increased when water and glycerol were used as initiators. Similar results are seen in Experiments 4 and 5. In Experiment Number 8, the Dynasol 4318 SBS triblock polymer was first dispersed in the viscosity-modifying carboxylic acid (VMCA 2), which was a blend of mono- and dicarboxylic acids, at a ratio of 42:58 SBS to VMCA 2. No GTR was used in the composite.

| | Bitumen Control | | | | | | | |
|---|---|---|---|---|---|---|---|---|
| | PG 64-22 | | | | | PG 67-22 | | |
| | Experiment Number | | | | | | | |
| | 1 | 2 | 3 | 4 | 5 | 6 | 7 | 8 |
| Composite Code | 12A | 12A | 12A | 12B | 12B | 13A | 13A | 16B |
| % Polymer-GTR-carboxylic Acid Composite | 12 | 12 | 12 | 11.9 | 1.9 | 12 | 12 | 7.2 |
| Wt. fraction Viscosity-Modifying Carb. Acid (VMCA) | 0.25 | 0.25 | 0.25 | 0.25 | 0.25 | 0.25 | 0.25 | 0.58 |
| in Composite | | | | | | | | |
| Wt. fraction #40 Ground Tire Rubber in Composite | 0.50 | 0.50 | 0.50 | 0.50 | 0.50 | 0.50 | 0.50 | 0 |
| Type Polymer in Composite | LCY3520 | LCY3520 | LCY3520 | D243 | D243 | Dyn4318 | Dyn4318 | Dyn4318 |
| Wt. fraction Polymer in Composite | 0.25 | 0.25 | 0.25 | 0.25 | 0.25 | 0.25 | 0.25 | 0.42 |
| % VMCA w/w Bitumen | 3 | 3 | 3 | 3 | 3 | 3 | 3 | 4.2 |
| Type Viscosity-Modifying Carboxylic Acid | VMCA 1 | VMCA 1 | VMCA 1 | VMCA 1 | VMCA 1 | VMCA 2 | VMCA 2 | VMCA 2 |
| Mol. Equiv. of CaO | 3 | 3 | 3 | 3 | 3 | 3 | 3 | 2 |
| Catalyst Type | No | H2O | Glycerol | No | H2O | No | Glycerol | Glycerol |
| % Initiator w/w CaO | 0 | 30 | 16 | 0 | 30 | 0 | 16 | — |
| G*/sinδ, kPa, at 70° C. | — | — | — | 2.15 | 6.61 | — | — | — |
| G*/sinδ, kPa, at 76° C. | 3.54 | 4.38 | 9.00 | 1.20 | 3.79 | 3.44 | 6.8 | 1.97 |
| G*/sinδ, kPa, at 82° C. | 1.96 | 2.48 | 5.26 | 0.69 | 2.17 | 1.89 | 3.94 | 1.04 |
| High PG Failure Temp., ° C., G*/sinδ = 1.0 kPa | 88.9 | 92.1 | 100.5 | 72.0 | 84.5 | 88.8 | 97.4 | 82.4 |
| Phase angle, δ, at G*/sinδ = 1.0 kPa | 71.6 | 67.8 | 57.9 | 76.4 | 70 | 72.1 | 62.7 | 78 |

### Example 35

A common specification for the physical properties of roofing asphalts is their displaying a ring and ball softening point of 100° C. or more. The technology disclosed in this invention allows easy conversion of conventional, low-softening point bitumen to roofing bitumen. The table shows the conversion of two bitumen samples, a PG 58-28 and a PG 64-22, to bitumen having softening points over 100° C. by use of the technique of the present invention. (The PG 58-28 and PG 64-22 bitumen samples have softening points less than 55° C.) For many decades the only path to bitumen suitable for roofing applications (i.e., having a 100° C. softening point) was through an energy intensive process call blowing. This invention provides a simple, one-pot method for converting a low softening point bitumen to a bitumen with a 100° C. ring and ball softening point.

| | | Viscosity- | | Acid- | | | | |
|---|---|---|---|---|---|---|---|---|
| | | Modifying | | Reactive | | | | Final Product |
| Bitumen | | Acid | | Metal Salt | | Initiator | | Ring & Ball |
| Type | g | Type | g | Type | g | Type | g | Softening Point, ° C. |
| PG 64-22 | 60 | VMA 1^{a} | 40 | CaO | 6.28 | Water | 2.1 | 68.6 |
| PG 64-22 | 60 | VMA 1 | 40 | CaO | 12.56 | Water | 4.1 | 100.2 |
| PG 64-22 | 50 | VMA 1 | 50 | CaO | 17.8 | Water | 5.9 | 128.0 |
| PG 58-28 | 50 | VMA 1 | 50 | CaO | 15.7 | Water | 5.2 | 101.2 |
| PG 64-22 | 60 | VMA 2^{b} | 40 | CaO | 14.24 | Water | 4.7 | 97.0 |
| PG 64-22 | 60 | VMA 2 | 40 | CaO | 7.12 | Water | 2.3 | 78.0 |

^{a}VMA 1 is a blend of tall oil-derived mono-, di-, and tricarboxylic acids and rosin acid
^{b}VMA 2 is a blend of maleated tall oil fatty acid and an acidic alkyl phosphate ester (ethyl hexyl phosphate)

Thus one skilled in the art is taught by this disclosure (this Example and others herein), that both a polymer-containing or functionally polymer-free bitumen may be induced to behave as an elastomeric bitumen, by applying the technology disclosed herein, even though the bitumen is essentially unmodified by any of the common synthetic or naturally-derived elastomeric or plastomeric polymers used in the asphalt industry to improve the rheological properties of the bitumen (as regards field performance issues such as rutting and cracking).

As described herein, in certain aspects the description provides a viscosity-modified composition comprising an organic acid, water, and an effective amount of an acid-reactive metal salt to thereby increase the viscosity or hardness of the composition while simultaneously improving the low temperature, thermal stress resistance properties.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

1. A composition comprising:
a. at least one of a bituminous material, resinous material, polymeric material or a combination thereof;
b. an acidic viscosity modifier; and
c. an acid-reactive metal salt to yield a mixture having an initial viscosity, wherein upon the exposure to at least one of water, an alcohol, or heat, the viscosity of the composition increases as compared to the initial viscosity.

2. The composition of claim 1, wherein upon exposure to at least one of water, an alcohol, or heat, the amount of an acid-reactive metal salt is sufficient to decrease the low temperature failure or increase the high temperature failure or both as compared to the at least one of bituminous material, resinous material, polymeric material or a combination thereof, alone.

3. The composition of claim 1, wherein upon the exposure to at least one of water, an alcohol, or heat, the Useful Temperature Interval (UTI) of the composition is expanded by at least 3° C. as compared to the UTI of the at least one of bituminous material, resinous material, polymeric material or a combination thereof, alone.

4. The composition of claim 3, wherein the UTI of the composition is expanded by at least 6° C. as compared to the UTI of the at least one of bituminous material, resinous material, polymeric material or a combination thereof, alone.

5. The composition of claim 4, wherein the UTI of the composition is expanded by at least 12° C. as compared to the UTI of the at least one of bituminous material, resinous material, polymeric material or a combination thereof, alone.

6. The composition of claim 5, wherein the UTI of the composition is expanded by at least 18° C. as compared to the UTI of the at least one of bituminous material, resinous material, polymeric material or a combination thereof, alone.

7. The composition of claim 1, wherein upon exposure to at least one of water, an alcohol or heat at least one of viscosity, stiffness or hardness is increased in the composition as compared to the at least one of bituminous material, resinous material, polymeric material or a combination thereof, alone.

8. The composition of claim 2, wherein the low-temperature failure is low-temperature cracking properties of the composition.

9. The composition of claim 2, wherein the high-temperature failure is high-temperature deformation properties of the composition.

10. The composition of claim 1, wherein the acidic viscosity modifier comprises an organic acid.

11. The composition of claim 10, wherein the acidic viscosity modifier comprises at least one of a mono-, di-, tri- or poly-carboxylic acid, a fatty acid, rosin acid, dimer fatty acid, trimer fatty acid, fortified fatty acid, an organo-phosphoric acid, organo-phosphonic acid, ester or polyester of carboxylic acids, phosphoric acid, phosphonic acid, or a combination thereof.

12. The composition of claim 11, wherein the fatty acid comprises a C10-C30 fatty acid.

13. The composition of claim 12, where in the fatty acid comprises a tall oil fatty acid.

14. The composition of claim 11, wherein the fatty acid comprises a unsaturated fatty acid modified by ene or Diels-Alder reaction with eneophiles and dieneophiles,

15. The composition of claim 11, wherein the fatty acid is at least one of an acrylic acid, alkyl acrylic acid, ester or amide of acrylic acid, ester of alkylated acrylic acid, maleic acid, maleic acid ester, maleic anhydride, alkylated maleic anhydride, fumaric acid, alkylated fumaric acid, adipic acid, succinic acid, citric acid, 2,6-naphthenic carboxylic acid, terephthalic acid, an ester or amide derivatives thereof or a combination thereof.

16. The composition of claim 11, wherein the acidic viscosity modifier is at least one of a mono-, di-, tri- or polycarboxylic acid, a dimerized, trimerized, or polymerized fatty acid or a combination thereof.

17. The composition of claim 11, wherein the rosin acid is a tall oil rosin acid.

18. The composition of claim 17, wherein the rosin acid is modified by ene or Diels-Alder reaction with ene-ophiles and diene-ophiles, such as acrylic acid, alkyl acrylic acid, esters or amides of acrylic acid, esters of alkylated acrylic acid, maleic acid, maleic acid esters, maleic anhydride, alkylated maleic anhydride, fumaric acid and alkylated fumaric acid and ester and amide derivatives thereof.

19. The composition of claim 11, wherein the fatty acid is a partial ester of the fatty acid.

20. The composition of claim 11, wherein the mono- or poly-carboxylic acid is a long-chain mono- or polycarboxylic acid.

21. The composition of claim 20, wherein the long-chain mono- or polycarboxylic acid is natural or synthetic.

22. The composition of claim 21, wherein the long-chain, mono- or poly-carboxylic acid has a low volatility at temperatures in the range of 25° C. to 150° C.

23. The composition of claim 1, wherein the acid-reactive metal salt is an alkali metal oxide, alkali earth metal oxide, transition metal oxide, or post-transition metalloid oxide.

24. The composition of claim 23, wherein the acid-reactive metal salt is at least one of magnesium oxide (MgO), calcium oxide (CaO), or quicklime.

25. The composition of claim 23, wherein the acid-reactive metal salt is from the family of transition metal oxides, or zinc oxide (ZnO).

26. The composition of claim 23, wherein the acid-reactive metal salt is from the family of post-transition metal oxides, or aluminum oxide (Al₂O₃).

27. The composition of claim 1, wherein the composition further comprises at least one of aggregate, aggregate-containing mineral, reclaimed asphalt pavement (RAP), recycled asphalt roofing shingles (RAS), reclaimed Portland cement concrete or a combination thereof.

28. The composition of claim 1, wherein the bituminous material comprises a bitumen emulsion, bitumen dispersion or combination thereof.

29. The composition of claim 28, wherein the bitumen is modified with at least one of polyphosphoric acid, polymeric plastomers and elastomers, ground tire rubber, and cellulosic fibers.

30. The composition of claim 28, wherein the bitumen emulsion is a water-based emulsion.

31. The composition of claim 30, wherein the bitumen emulsion comprises long-chain mono- or poly-carboxylic acid.

32. The composition of claim 1, wherein the alcohol is glycerol.

33. The composition of claim 32, wherein the mixture is at a temperature of ≧100° C.

34. The composition of claim 33, wherein the mixture is at a temperature of ≧120° C.

35. The composition of claim 34, wherein the mixture is heated to a temperature of ≧about 150° C.

36. The composition of claim 35, wherein the mixture is heated to a temperature of about 150° C.

37. A bituminous composition comprising:
a. at least one of a bitumen, bitumen emulsion, bitumen dispersion or combination thereof;
b. an acidic viscosity modifier; and
c. an acid-reactive metal salt, wherein upon the addition of at least one of water, alcohol, heat or a combination thereof, the Useful Temperature Interval (UTI) of the composition is expanded by at least 3° C. as compared to the UTI of the at least one of bitumen, bitumen emulsion or bitumen dispersion or a combination thereof, alone.

38. The bituminous composition of claim 37, wherein the UTI of the composition is expanded by at least 6° C. as compared to the UTI of the at least one of bituminous material, resinous material, polymeric material or a combination thereof, alone.

39. The bituminous composition of claim 38, wherein the UTI of the composition is expanded by at least 12° C. as compared to the UTI of the at least one of bituminous material, resinous material, polymeric material or a combination thereof, alone.

40. The bituminous composition of claim 39, wherein the UTI of the composition is expanded by at least 18° C. as compared to the UTI of the at least one of bituminous material, resinous material, polymeric material or a combination thereof, alone.

41. The bituminous composition of claim 37, wherein upon exposure to at least one of water, an alcohol or heat, at least one of viscosity, stiffness or hardness is increased in the composition as compared to the at least one of a bitumen, bitumen emulsion, bitumen dispersion or combination thereof, alone.

42. The bituminous composition of claim 37, wherein the composition further comprises at least one of aggregate, aggregate-containing mineral, reclaimed asphalt pavement (RAP), recycled asphalt roofing shingles (RAS), reclaimed Portland cement concrete or a combination thereof.

43. The bituminous composition of claim 37, wherein the acidic viscosity modifier comprises at least one of a mono-, di-, tri- or poly-carboxylic acid, a fatty acid, rosin acid, dimer fatty acid, trimer fatty acid, fortified fatty acid, an organo-phosphoric acid, organo-phosphonic acid, ester or polyester of carboxylic acids, phosphoric acid, phosphonic acid, or a combination thereof.

44. The bituminous composition of claim 43, wherein the fatty acid comprises a C10-C30 fatty acid.

45. The bituminous composition of claim 43, where in the fatty acid comprises a tall oil fatty acid.

46. The bituminous composition of claim 43, wherein the fatty acid comprises a unsaturated fatty acid modified by ene or Diels-Alder reaction with eneophiles and dieneophiles,

47. The bituminous composition of claim 43, wherein the fatty acid is at least one of an acrylic acid, alkyl acrylic acid, ester or amide of acrylic acid, ester of alkylated acrylic acid, maleic acid, maleic acid ester, maleic anhydride, alkylated maleic anhydride, fumaric acid, alkylated fumaric acid, an ester or amide derivative thereof or a combination thereof.

48. The bituminous composition of claim 43, wherein the acidic viscosity modifier is at least one of a mono-, di-, tri- or polycarboxylic acid, a dimerized, trimerized, or polymerized fatty acid or a combination thereof.

49. The bituminous composition of claim 43, wherein the rosin acid is a tall oil rosin acid.

50. The bituminous composition of claim 49, wherein the rosin acid is modified by ene or Diels-Alder reaction with ene-ophiles and diene-ophiles, such as acrylic acid, alkyl acrylic acid, esters or amides of acrylic acid, esters of alkylated acrylic acid, maleic acid, maleic acid esters, maleic anhydride, alkylated maleic anhydride, fumaric acid and alkylated fumaric acid and ester and amide derivatives thereof.

51. The bituminous composition of claim 43, wherein the fatty acid is a partial ester of the fatty acid.

52. The bituminous composition of claim 43, wherein the mono- or poly-carboxylic acid is a long-chain mono- or polycarboxylic acid.

53. The bituminous composition of claim 52, wherein the long-chain mono- or polycarboxylic acid is natural or synthetic.

54. The bituminous composition of claim 37, wherein the acid-reactive metal salt is an alkali metal oxide, alkali earth metal oxide, transition metal oxide, or post-transition metalloid oxide.

55. The bituminous composition of claim 54, wherein the acid-reactive metal salt is at least one of magnesium oxide (MgO), calcium oxide (CaO), or quicklime.

56. The bituminous composition of claim 54, wherein the acid-reactive metal salt is from the family of transition metal oxides, or zinc oxide (ZnO).

57. The bituminous composition of claim 54, wherein the acid-reactive metal salt is from the family of post-transition metal oxides, or aluminum oxide (Al₂O₃).

58. The bituminous composition of claim 37, wherein the alcohol is glycerol.

59. The bituminous composition of claim 58, wherein the mixture is at a temperature of ≧100° C.

60. The bituminous composition of claim 59, wherein the mixture is at a temperature of ≧120° C.

61. The bituminous composition of claim 60, wherein the mixture is heated to a temperature of ≧about 150° C.

62. The bituminous composition of claim 61, wherein the mixture is heated to a temperature of about 150° C.

63. A method of making a composition with tunable rheological properties comprising the steps of:
a. preparing an admixture comprising:
i. at least one of a bituminous material, resinous material, polymeric material or a combination thereof;
ii. an acidic viscosity modifier;
iii. an acid-reactive metal salt; and
b. adding to the admixture in (a) at least one of water, an alcohol, or heat, wherein the process results in an increase in viscosity of the composition as compared to the admixture in (a).

64. A method of making a bituminous composition with tunable rheological properties comprising the steps of:
a. preparing an admixture comprising:
i. at least one of a bitumen, bitumen emulsion, bitumen dispersion or combination thereof;
ii. an acidic viscosity modifier;
iii. an acid-reactive metal salt; and
b. adding to the admixture in (a) at least one of water, an alcohol, or heat, wherein the process results in an increase in viscosity of the composition as compared to the admixture in (a).

65. The method of claim 64, wherein the composition further comprises at least one of aggregate, aggregate-containing mineral, reclaimed asphalt pavement (RAP), recycled asphalt roofing shingles (RAS), reclaimed Portland cement concrete or a combination thereof.

66. The method of claim 65, wherein the aggregate, aggregate-containing mineral, reclaimed asphalt pavement (RAP), recycled asphalt roofing shingles (RAS), reclaimed Portland cement concrete or a combination thereof, is at least partially pre-coated with at least one of (a), (b) or a combination thereof.

67. The method of claim 64, wherein the acid-reactive metal salt is CaO.

68. A method of making a paving composition comprising:
a. providing a mineral aggregate material;
b. pre-coating the mineral aggregate material with carboxylic acid-containing bitumen;
c. preparing a slurry comprising at least one of water, an alcohol or both, and an acid-reactive metal salt; and
d. admixing the pre-coated aggregate with the slurry, wherein the slurry triggers hardening of the bitumen-aggregate composition.

69. A method for making a paving composition comprising:
a. providing a mineral aggregate;
b. pre-coating the mineral aggregate with an effective amount of an acid-reactive metal salt;
c. admixing the acid-reactive metal salt-treated mineral aggregate with at least one of water, alcohol or a combination thereof, and carboxylic acid-treated bitumen, wherein the composition demonstrates an increase in viscosity or hardness relative to the untreated carboxylic acid-treated bitumen.

70. A method for making a paving composition comprising:
a. providing a mineral aggregate;
b. pre-coating the mineral aggregate with an acid-reactive metal salt;
c. admixing acid-reactive metal salt-treated mineral aggregate with water, and a bitumen comprising at least one of a mono-, di-, polycarboxylic acid or blend thereof, either neat or in the form of an emulsion;
d. spreading said carboxylic acid-treated aggregate composition onto a surface; and
e. compacting said carboxylic acid-treated aggregate composition to give a durable pavement layer.

71. A method of making a paving composition comprising:
a. providing a mineral aggregate material;
b. pre-coating aggregate with a carboxylic acid-containing bitumen;
c. mixing the pre-coated aggregate mixture with an acid-reactive metal oxide; and
d. mixing the acid-reactive metal oxide treated, pre-coated aggregate mixture with water, wherein the treatment of the acid-reactive metal oxide and water triggers hardening of the bitumen-aggregate composition.

72. A method of making a paving composition comprising:
a. providing a mineral aggregate material;
b. pre-coating aggregate with carboxylic acid-containing bitumen; and
c. mixing the pre-coated aggregate mixture with water followed by an effective amount of an acid-reactive metal salt, wherein the treatment with water and metal salt triggers hardening of the bitumen-aggregate composition.

73. A method of making a paving composition comprising:
a. providing a mineral aggregate material;
b. pre-coating aggregate with carboxylic acid-containing bitumen into which has been dispersed an acid-reactive metal salt; and
c. mixing the pre-coated aggregate mixture with water, wherein the addition of water triggers a hardening interaction between the acid-reactive salt and the carboxylic acid of the bitumen-aggregate composition.

74. The method of claim 73, wherein the carboxylic acid is neat or in the form of an emulsion.

75. The method of claim 73, wherein acid-reactive metal salt is a metal oxide.

76. The method of claim 73, wherein the metal oxide is CaO.

77. The method of claim 73, wherein the carboxylic acid is at least one of a mono-, di-, tri- or polycarboxylic acid, a dimerized, trimerized, or polymerized fatty acid or a combination thereof.

78. The method of claim 73, wherein the bitumen is in the form of water-based emulsion.

79. The method of claim 73, wherein the mineral aggregate material has a gradation ranging from particle diameters of less than 0.075 mm to 76.2 mm.

80. A method of making a paving composition comprising:
a. providing a fibrous solid material;
b. pre-coating the fiber with a carboxylic acid-containing bitumen;
c. preparing a slurry comprising water and CaO; and
d. admixing the pre-coated fibrous material with the water and CaO slurry, wherein the water-CaO slurry triggers hardening of the bitumen-fiber composition.

81. A method of making a paving composition comprising:
a. providing a fibrous solid material;
b. pre-coating the fibrous material with a carboxylic acid-containing bitumen;
c. mixing the pre-coated aggregate mixture with CaO; and
d. mixing the CaO-treated, pre-coated aggregate mixture with water, wherein the treatment of CaO and water triggers hardening of the bitumen-aggregate composition.

82. A method of making a sprayable coating composition to impermeabilize a surface, the method comprising mixing a carboxylic acid-bearing substance and an effective amount of an acid-reactive salt aqueous slurry, wherein the composition is sprayable.

83. The method of claim 82, wherein the sprayable coating is covered with mineral aggregate material.

84. The method of claim 82, wherein the sprayable coating is a tack (bond) coat, a roofing membrane, a water-barrier, or impermeabilization membrane.

85. A method of impermeabilizing a surface, the method comprising mixing a carboxylic acid-treated hydrocarbon material and an effective amount of an acid-reactive salt aqueous slurry, and spray-applying said mixture onto the surface.

86. The method of claim 85 wherein the hydrocarbon material is a natural material selected from the group consisting of rosin esters, phenolic resins, tall oil pitch, beeswax, natural fatty acids, synthetic fatty acids, and mono-, di-, and triglycerides.

87. The method of claim 85, wherein the hydrocarbon material is a synthetic material selected from the group consisting of petroleum distillates, bitumen, aromatic oils, and asphalt flux.

88. The method of claim 85, wherein the mixture comprises a mineral aggregate material.

89. The method of claim 85 wherein the mixture is applied as a pavement chip seal, a roofing membrane, an aggregate-coated water barrier, or an aggregate-coated impermeabilization membrane.

90. A composition comprising:
a. at least one of a polymeric material;
b. an acidic viscosity modifier; and
c. an acid-reactive metal salt to yield a composition having an initial viscosity, wherein upon the exposure to at least one of water, an alcohol, or heat, the viscosity of the composition increases as compared to the initial viscosity.

91. The composition of claim 90, wherein the polymeric material is at least one of acrylate ester polymer, styrene polymer, polyarylene-polyalkylene block polymer, styrene-butadiene-styrene block polymer (SBS), styrene ethylene butylene styrene block copolymer (SEBS), styrene-butadiene rubber (SBR), styrene-block-isobutylene-block-styrene) (SIBS), latex polymer or a combination thereof.

92. A method preparing a polymeric CCI composition comprising:
a. preparing an admixture comprising:
i. a polymeric material;
ii. an acidic viscosity modifier;
iii. an acid-reactive metal salt; and
b. adding to the admixture in (a) at least one of water, an alcohol, or heat, wherein the process results in an increase in viscosity of the composition as compared to the admixture in (a).

93. The method of claim 92, wherein the polymeric material is at least one of acrylate ester polymer, styrene polymer, polyarylene-polyalkylene block polymer, styrene-butadiene-styrene block polymer (SBS), styrene ethylene butylene styrene block copolymer (SEBS), styrene-butadiene rubber (SBR), styrene-block-isobutylene-block-styrene) (SIBS), latex polymer or a combination thereof.
